(19) United States
(12) Patent Application Publication
(10) Pub. No.: US 2026/0035185 A1
(43) Pub. Date: Feb. 5, 2026

(54) FEED ASSEMBLIES AND METHODS

(71) Applicant: Altria Client Services LLC, Richmond, VA (US)

(72) Inventors: Isaac J. MCGILL, Richmond, VA (US); Sean P. SUNDBERG, Richmond, VA (US); Charles DENDY, Ruther Glen, VA (US); Jarrod W. CHALKLEY, Mechanicsville, VA (US); Kathryn DILL, Richmond, VA (US); Robert POWELL, Midlothian, VA (US)

(73) Assignee: Altria Client Services LLC, Richmond, VA (US)

(21) Appl. No.: 19/276,611

(22) Filed: Jul. 22, 2025

Related U.S. Application Data
(60) Provisional application No. 63/677,052, filed on Jul. 30, 2024.

(51) Int. Cl. B65G 43/08; B65G 15/44; B65G 41/00; B65G 47/19

(52) U.S. Cl. CPC B65G 43/08; B65G 15/44; B65G 41/007; B65G 47/19; B65G 2201/04

(57) ABSTRACT

A feed assembly includes a conveyor assembly and a supply assembly. The conveyor assembly includes a conveyor belt apparatus, a conveyor frame, and conveyor rollers enabling movement of the conveyor assembly over a support surface. The supply assembly includes a supply apparatus configured to discharge a material through a discharge port, a supply frame, and supply rollers enabling movement of the supply assembly over the support surface. The conveyor assembly is movable to align a front end of the conveyor belt apparatus with an intake port of an external structure, and the supply assembly is movable in relation to the conveyor assembly to vertically overlap the discharge port over a rear end of the conveyor belt apparatus, to enable the conveyor assembly to convey material discharged from the discharge port to the intake port based on operation of the supply apparatus and the conveyor belt apparatus.

### CROSS-REFERENCE TO RELATED APPLICATIONS

This application claims priority to and the benefit of U.S. Provisional Patent Application No. 63/677,052 filed in the United States Patent and Trademark Office on Jul. 30, 2024, the entire contents of which are incorporated herein by reference.

### BACKGROUND

### Field

The present inventive concepts relate to feed assemblies, systems including feed assemblies, and methods of operating feed assemblies and/or systems including the feed assemblies.

### Description of Related Art

In manufacturing material products, including for example units of material, for example plant material products (e.g., oral products), manufacturing machines may be used to prepare product articles containing one or more units of a material. For example, a manufacturing machine may process a material (e.g., portioning, compressing, and/or dispensing separate amounts of the material) to form one or more units of material. The manufacturing machine may further package the one or more units of material to form one or more packaged products, including for example one or more pouches containing one or more units of material.

### SUMMARY

Example embodiments relate to feed assemblies, systems including feed assemblies, and methods of operating feed assemblies and/or systems including the feed assemblies.

According to some example embodiments, a feed assembly may include a conveyor assembly and a supply assembly. The conveyor assembly may include a conveyor belt apparatus, a conveyor frame, and one or more conveyor rollers. The conveyor belt apparatus may include a conveyor belt, a conveyor driver, and one or more driven rollers coupled to the conveyor driver, the conveyor belt extending over at least a portion of the one or more driven rollers. The conveyor frame may be coupled to the conveyor belt apparatus. The one or more conveyor rollers may be coupled to an underside of the conveyor frame. The one or more conveyor rollers may be configured to at least partially support the conveyor frame and the conveyor belt apparatus on a support surface. The supply assembly may include a supply apparatus, a supply frame, and one or more supply rollers. The supply apparatus may include a static bin, a supply driver, a driven member at a bottom end of the static bin and coupled to the supply driver, and a discharge structure coupled to the bottom end of the static bin and defining a discharge port. The supply frame may be coupled to the supply apparatus. The one or more supply rollers may be coupled to an underside of the supply frame. The one or more supply rollers may be configured to at least partially support the supply frame and the supply apparatus on the support surface. The supply frame may at least partially define an internal slot vertically overlapping the discharge port. The internal slot may have defined inner surface dimensions complementary to outer surface dimensions of at least a rear portion of the conveyor assembly that includes the rear end of the conveyor belt apparatus.

The supply apparatus may include a live bottom bin, such that the driven member includes a vibratory baffle at the bottom end of the static bin and mechanically coupled to the supply driver and the discharge structure includes a funnel connected to the bottom end of the static bin.

The one or more conveyor rollers may include a conveyor caster wheel pivotably coupled to the conveyor frame, and the one or more supply rollers may include a supply caster wheel pivotably coupled to the supply frame.

At least one caster wheel of the conveyor caster wheel or the supply caster wheel may be a locking caster wheel.

At least one assembly of the conveyor assembly or the supply assembly may include a locking device configured to at least partially inhibit movement of the at least one assembly in relation to the support surface.

A rear end of the conveyor belt apparatus may be at a first level, a front end of the conveyor belt apparatus may be at a second level that is above the first level, and the conveyor belt apparatus may include an inclined conveyor section extending at least partially vertically between the first level and the second level.

The conveyor belt apparatus may include a lower conveyor section extending horizontally from a lower end of the inclined conveyor section to the rear end of the conveyor belt apparatus at the first level and an upper conveyor section extending horizontally from an upper end of the inclined conveyor section to the front end of the conveyor belt apparatus at the second level.

The conveyor assembly may include a level sensor device configured to generate sensor data indicating a level of material at the lower end of the inclined conveyor section.

The conveyor assembly may include an inclined catch ramp vertically underneath the inclined conveyor section and one or more lower tray shelves configured to support one or more catch trays vertically underneath a lower end of the inclined catch ramp.

The conveyor belt may include a set of cleats extending transversely across at least a portion of a width of the conveyor belt. The set of cleats may partition the conveyor belt along a length direction of the conveyor belt into a plurality of conveyor sections.

The conveyor assembly may include one or more locating members configured to at least partially position the conveyor assembly in relation to an external structure based on engaging a surface of the external structure, such that the front end of the conveyor belt apparatus is at least partially located at a particular position in relation to the external structure.

The conveyor frame may be configured to engage a set of external locating brackets of the external structure to align the front end of the conveyor belt apparatus along a lateral direction in relation to the external structure, the lateral direction perpendicular to the longitudinal axis of the conveyor assembly.

An assembly of the conveyor assembly or the supply assembly may include one or more locating members configured to engage a frame of another assembly of the conveyor assembly or the supply assembly to align the discharge port of the supply apparatus to vertically overlap the conveyor belt at a rear conveyor section of the conveyor belt apparatus.

The conveyor assembly may include an electrical distribution assembly. The electrical distribution assembly may include a first electrical junction box including a first electrical connector port and a first electrical conduit coupling the first electrical connector port with the conveyor driver.

The electrical distribution assembly may include a second electrical junction box including a second electrical connector port and a second electrical conduit coupling the first electrical connector port with the second electrical connector port. The first electrical conduit and the second electrical conduit may be coupled to separate, respective electrical connectors of the first electrical connector port. The supply assembly may include a supply electrical connector coupled with the supply driver. The supply electrical connector may be configured to connect with the second electrical connector port of the second electrical junction box.

The first electrical junction box and the second electrical junction box may be coupled to the conveyor frame at opposite ends of the conveyor frame along the longitudinal axis of the conveyor assembly.

At least one frame of the conveyor frame or the supply frame may include a floor lock configured to engage the support surface to hold the at least one frame in place in relation to the support surface.

The conveyor assembly may include a conveyor chute coupled to at least one of the conveyor belt apparatus or the conveyor frame at the front end of the conveyor assembly.

The conveyor assembly may include one or more tray shelves configured to support one or more catch trays vertically underneath at least a portion of the conveyor belt apparatus.

According to some example embodiments, a manufacturing system for processing a material may include the feed assembly, wherein the supply apparatus is configured to store the material in the static bin. The manufacturing system may include a manufacturing machine having an intake port and a dispenser configured to form one or more discrete units of the material based on processing one or more amounts of the material received through the intake port and a controller electrically coupled to at least the feed assembly. The controller may be electrically coupled to the conveyor driver and the supply driver. The controller may be configured to control a supply of the material from the feed assembly and through the intake port based on controlling the conveyor belt apparatus based on controlling the conveyor driver, and controlling the supply apparatus based on controlling the supply driver.

A rear end of the conveyor belt apparatus may be at a first level and a front end of the conveyor belt apparatus may be at a second level that is above the first level. The conveyor belt apparatus may include an inclined conveyor section extending at least partially vertically between the first level and the second level, a lower conveyor section extending horizontally from a lower end of the inclined conveyor section to the rear end of the conveyor belt apparatus at the first level, and an upper conveyor section extending horizontally from an upper end of the inclined conveyor section to the front end of the conveyor belt apparatus at the second level. The conveyor assembly may include a level sensor device configured to generate sensor data indicating a level of material at the lower end of the inclined conveyor section. The controller may be configured to independently control at least one of the conveyor belt apparatus or the supply apparatus based on processing the sensor data to cause the level of material to be within a particular range of level values.

The controller may be configured to process the sensor data generated by the level sensor device to determine a value of the level of the material, execute a control loop to generate one or more output values indicating a target level of the material, based on a process variable that is the determined value of the level of the material and a setpoint that is a stored level setpoint value, and control the at least one of the conveyor driver or the supply driver based on the one or more output values to control the level of the material.

The controller may be configured to control the at least one of the conveyor driver or the supply driver such that the level of the material is caused to be equal to or smaller than a threshold value.

The manufacturing machine may include a machine electrical connector electrically coupled to a power supply. The conveyor assembly may include an electrical distribution assembly. The electrical distribution assembly may include a first electrical junction box including a first electrical connector port and a first electrical conduit coupling the first electrical connector port with the conveyor driver. The machine electrical connector may be connected to the first electrical connector port to electrically couple the conveyor driver to the power supply through at least the first electrical conduit, the first electrical connector port, and the machine electrical connector.

The electrical distribution assembly may further include a second electrical junction box including a second electrical connector port and a second electrical conduit coupling the first electrical connector port with the second electrical connector port, the first electrical conduit and the second electrical conduit coupled to separate, respective electrical connectors of the first electrical connector port. The supply assembly may include a supply electrical connector coupled with the supply driver, the supply electrical connector connected with the second electrical connector port of the second electrical junction box. The machine electrical connector may be connected to the first electrical connector port to electrically couple the conveyor driver to the power supply through at least the first electrical conduit, the first electrical connector port, and the machine electrical connector and electrically couple the supply driver to the power supply through at least the supply electrical connector, the second electrical connector port, the second electrical conduit, the first electrical connector port, and the machine electrical connector.

According to some example embodiments, a method for operating the feed assembly may include movably positioning the conveyor assembly over a support surface in relation to a manufacturing machine to align the front end of the conveyor belt apparatus with an intake port of the manufacturing machine and movably positioning the supply assembly over the support surface in relation to the conveyor assembly to vertically overlap the discharge port of the supply apparatus with the conveyor belt at a rear conveyor section of the conveyor belt apparatus.

At least one assembly of the conveyor assembly or the supply assembly may include a locking device, and the method may further include operating the locking device of the at least one assembly to at least partially inhibit movement of the at least one assembly in relation to the manufacturing machine.

The manufacturing machine may include a machine electrical connector electrically coupled to a power supply. The conveyor assembly may include an electrical distribution assembly including a first electrical junction box including a first electrical connector port and a first electrical conduit coupling the first electrical connector port with the conveyor driver. The method may further include connecting the machine electrical connector to the first electrical connector port to electrically couple the conveyor driver to the power supply through at least the first electrical conduit, the first electrical connector port, and the machine electrical connector.

The electrical distribution assembly may include a second electrical junction box including a second electrical connector port and a second electrical conduit coupling the first electrical connector port with the second electrical connector port. The first electrical conduit and the second electrical conduit may be coupled to separate, respective electrical connectors of the first electrical connector port. The supply assembly may include a supply electrical connector coupled with the supply driver. The method may include connecting the supply electrical connector with the second electrical connector port of the second electrical junction box to electrically couple the supply assembly to the first electrical connector port of the first electrical junction box through the second electrical conduit.

The method may include operating the supply driver and the conveyor driver to cause a material to be discharged from the supply apparatus onto the conveyor belt at the rear conveyor section of the conveyor belt apparatus and to be moved from the rear conveyor section to the front end of the conveyor belt apparatus and to be further discharged from the conveyor belt apparatus at the front end into the manufacturing machine through the intake port. The method may include operating the manufacturing machine to process the material to form one or more discrete units of the material.

A rear end of the conveyor belt apparatus may be at a first level and a front end of the conveyor belt apparatus may be at a second level that is above the first level. The conveyor belt apparatus may include an inclined conveyor section extending at least partially vertically between the first level and the second level, a lower conveyor section extending horizontally from a lower end of the inclined conveyor section to the rear end of the conveyor belt apparatus at the first level, and an upper conveyor section extending horizontally from an upper end of the inclined conveyor section to the front end of the conveyor belt apparatus at the second level. The conveyor assembly may include a level sensor device configured to generate sensor data indicating a level of material at the lower end of the inclined conveyor section. The method may include independently controlling at least one of the conveyor belt apparatus or the supply apparatus based on processing the sensor data to cause the level of material to be within a particular range of level values.

The independently controlling may include processing the sensor data generated by the level sensor device to determine a value of the level of the material, executing a control loop to generate an output value indicating a target level of the material, based on a process variable that is the determined value of the level of the material and a setpoint that is a stored level setpoint value, and controlling the at least one of the conveyor driver or the supply driver based on the output value to control the level of the material.

According to some example embodiments, a feed assembly may include a conveyor assembly and a supply assembly. The conveyor assembly may include a conveyor belt apparatus, a conveyor frame, and one or more conveyor rollers. The conveyor belt apparatus may extend from a rear end of the conveyor belt apparatus to a front end of the conveyor belt apparatus. The conveyor belt apparatus may include a rear conveyor section adjacent to the rear end. The conveyor frame may be configured to at least partially structurally support the conveyor belt apparatus. The one or more conveyor rollers may be coupled to the conveyor frame. The one or more conveyor rollers may be configured to enable movement of the conveyor assembly over a support surface. The supply assembly may include a supply apparatus configured to discharge a material through a discharge port, a supply frame configured to at least partially structurally support a load of the supply apparatus, and one or more supply rollers coupled to the supply frame, the one or more supply rollers configured to enable movement of the supply assembly over the support surface. The conveyor assembly may be configured to be movably positioned to align the front end of the conveyor belt apparatus with an intake port of an external structure, and the supply assembly is configured to be movably positioned in relation to the conveyor assembly to vertically overlap the discharge port of the supply apparatus over a rear conveyor section of the conveyor belt apparatus, to enable the conveyor assembly to convey material discharged from the discharge port of the supply apparatus to the intake port of the external structure based on operation of the supply apparatus to discharge the material to the rear conveyor section of the conveyor belt apparatus and operation of the conveyor belt apparatus to convey the material from the rear conveyor section of the conveyor belt apparatus to the front end of the conveyor belt apparatus.

The supply apparatus may include a live bottom bin.

The one or more conveyor rollers may include a conveyor caster wheel pivotably coupled to the conveyor frame, and the one or more supply rollers may include a supply caster wheel pivotably coupled to the supply frame.

At least one caster wheel of the conveyor caster wheel or the supply caster wheel may be a locking caster wheel.

At least one assembly of the conveyor assembly or the supply assembly may include a locking device configured to at least partially inhibit movement of the at least one assembly in relation to the support surface.

The rear end of the conveyor belt apparatus may be at a first level and the front end of the conveyor belt apparatus may be at a second level that is above the first level. The conveyor belt apparatus may include an inclined conveyor section extending at least partially vertically between the first level and the second level.

The conveyor belt apparatus may be configured to move the material from the rear end of the conveyor belt apparatus to a lower end of the inclined conveyor section along a lower conveyor section at the first level, move the material from the first level to the second level along the inclined conveyor section, and move the material from an upper end of the inclined conveyor section to the front end of the conveyor belt apparatus along an upper conveyor section at the second level.

The conveyor assembly may include a level sensor device configured to generate sensor data indicating a level of material at the lower end of the inclined conveyor section.

The conveyor assembly may include an inclined catch ramp configured to catch fallen material falling below at least a portion of the conveyor belt apparatus and direct the fallen material to follow an inclined path downward towards one or more lower tray shelves.

The conveyor belt apparatus may include a conveyor belt having a set of cleats extending transversely across at least a portion of a width of the conveyor belt, the set of cleats partitioning the conveyor belt along a length direction of the conveyor belt into a plurality of conveyor sections.

The conveyor assembly may include one or more locating members configured to at least partially position the conveyor assembly in relation to the external structure based on engaging a surface of the external structure, such that the front end of the conveyor belt apparatus is at least partially located at a particular position in relation to the external structure.

The conveyor frame is configured to engage a set of external locating brackets of the external structure to align the front end of the conveyor belt apparatus along a lateral direction in relation to the external structure, the lateral direction perpendicular to a longitudinal axis of the conveyor assembly.

An assembly of the conveyor assembly or the supply assembly may include one or more locating members configured to engage a frame of another assembly of the conveyor assembly or the supply assembly to align the discharge port of the supply apparatus to vertically overlap the rear conveyor section of the conveyor belt apparatus.

The conveyor assembly may include an electrical distribution assembly. The electrical distribution assembly may include a first electrical junction box including a first electrical connector port configured to be electrically coupled to a conveyor driver of the conveyor belt apparatus. The electrical distribution assembly may be configured to electrically couple the conveyor driver to an external power supply based on connecting the first electrical connector port with an external electrical connector that is electrically coupled with the external power supply.

The electrical distribution assembly may include a second electrical junction box including a second electrical connector port. The first electrical connector port may include electrical connectors configured to be electrically coupled to separate, respective ones of the conveyor driver and the second electrical connector port, such that the conveyor driver and the second electrical connector port are electrically coupled to the first electrical connector port in parallel. The supply assembly may include a supply electrical connector coupled with a supply driver of the supply apparatus. The supply electrical connector may be configured to connect with the second electrical connector port of the second electrical junction box to electrically couple the supply assembly to the external power supply through the second electrical connector port and the first electrical connector port, based on the first electrical connector port connecting with the external electrical connector.

The first electrical junction box and the second electrical junction box may be coupled to the conveyor frame at opposite ends of the conveyor frame along a longitudinal axis of the conveyor assembly.

At least one frame of the conveyor frame or the supply frame may include a floor lock configured to engage the support surface to hold the at least one frame in place in relation to the support surface.

The conveyor assembly may include a conveyor chute configured to direct material conveyed from the front end of the conveyor belt apparatus along an inclined discharge path.

The conveyor assembly may include one or more tray shelves configured to support one or more catch trays vertically underneath at least a portion of the conveyor belt apparatus to configure the conveyor assembly to catch material falling below the conveyor belt apparatus.

According to some example embodiments, a manufacturing system for processing a material may include the feed assembly, wherein the supply apparatus is configured to store material in a static bin, a manufacturing machine having an intake port and a dispenser configured to form one or more discrete units of the material based on processing one or more amounts of the material received through the intake port, and a controller electrically coupled to at least the feed assembly. The controller may be electrically coupled to a conveyor driver of the conveyor belt apparatus and a supply driver of the supply apparatus. The controller may be configured to control a supply of the material from the feed assembly and through the intake port based on controlling the conveyor belt apparatus based on controlling the conveyor driver, and controlling the supply apparatus based on controlling the supply driver.

The rear end may be at a first level and the front end may be at a second level that is above the first level. The conveyor belt apparatus may include an inclined conveyor section extending at least partially vertically between the first level and the second level, a lower conveyor section extending horizontally from a lower end of the inclined conveyor section to the rear conveyor section of the conveyor belt apparatus at the first level, and an upper conveyor section extending horizontally from an upper end of the inclined conveyor section to the front end of the conveyor belt apparatus at the second level. The conveyor assembly may include a level sensor device configured to generate sensor data indicating a level of material at the lower end of the inclined conveyor section. The controller may be configured to independently control at least one of the conveyor belt apparatus or the supply apparatus based on processing the sensor data to cause the level of material to be within a particular range of level values.

The controller may be configured to process the sensor data generated by the level sensor device to determine a value of the level of the material, execute a control loop to generate an output value indicating a target level of the material, based on a process variable that is the determined value of the level of the material and a setpoint that is a stored level setpoint value, and control the at least one of the conveyor driver or the supply driver based on the output value to control the level of the material.

The controller may be configured to control the at least one of the conveyor driver or the supply driver such that the level of the material is caused to be equal to or smaller than a threshold value.

The manufacturing machine may include a machine electrical connector electrically coupled to a power supply. The conveyor assembly may include an electrical distribution assembly, the electrical distribution assembly including a first electrical junction box including a first electrical connector port configured to be electrically coupled to the conveyor driver. The machine electrical connector may be connected to the first electrical connector port to electrically couple the conveyor driver to the power supply through at least the first electrical connector port and the machine electrical connector.

The electrical distribution assembly may include a second electrical junction box including a second electrical connector port. The first electrical connector port may include electrical connectors configured to be electrically coupled to separate, respective ones of the conveyor driver and the second electrical connector port, such that the conveyor driver and the second electrical connector port are electrically coupled in parallel with the first electrical connector port. The supply assembly may include a supply electrical connector coupled with the supply driver, the supply electrical connector connected with the second electrical connector port of the second electrical junction box. The machine electrical connector may be connected to the first electrical connector port to electrically couple the conveyor driver to the power supply through at least the first electrical connector port and the machine electrical connector and electrically couple the supply driver to the power supply through at least the supply electrical connector, the second electrical connector port, the first electrical connector port, and the machine electrical connector.

According to some example embodiments, a method for operating the feed assembly may include movably positioning the conveyor assembly over a support surface in relation to a manufacturing machine to align the front end of the conveyor belt apparatus with an intake port of the manufacturing machine and movably positioning the supply assembly over the support surface in relation to the conveyor assembly to vertically overlap the discharge port of the supply apparatus with the rear conveyor section of the conveyor belt apparatus.

At least one assembly of the conveyor assembly or the supply assembly may include a locking device. The method may include operating the locking device of the at least one assembly to at least partially inhibit movement of the at least one assembly in relation to the manufacturing machine.

The manufacturing machine may include a machine electrical connector electrically coupled to a power supply. The conveyor assembly may include an electrical distribution assembly, the electrical distribution assembly including a first electrical junction box including a first electrical connector port configured to be electrically coupled to a conveyor driver of the conveyor belt apparatus. The method may include connecting the machine electrical connector to the first electrical connector port to electrically couple the conveyor driver to the power supply through at least the first electrical connector port and the machine electrical connector.

The electrical distribution assembly may include a second electrical junction box including a second electrical connector port. The first electrical connector port may include electrical connectors configured to be electrically coupled to separate, respective ones of the conveyor driver and the second electrical connector port, such that the conveyor driver and the second electrical connector port are electrically coupled in parallel with the first electrical connector port. The supply assembly may include a supply electrical connector coupled with a supply driver of the supply apparatus, the supply electrical connector connected with the second electrical connector port of the second electrical junction box. The method may include connecting the supply electrical connector with the second electrical connector port of the second electrical junction box to electrically couple the supply assembly to the first electrical connector port of the first electrical junction box.

The method may include operating the supply apparatus and the conveyor belt apparatus to cause material to be discharged from the supply apparatus onto the rear conveyor section of the conveyor belt apparatus and to be moved from the rear conveyor section to the front end of the conveyor belt apparatus and to be further discharged from the conveyor belt apparatus at the front end into the manufacturing machine through the intake port. The method may include operating the manufacturing machine to process the material to form one or more discrete units of the material.

The rear end is at a first level and the front end is at a second level that is above the first level. The conveyor belt apparatus may include an inclined conveyor section extending at least partially vertically between the first level and the second level, a lower conveyor section extending horizontally from a lower end of the inclined conveyor section to the rear end of the conveyor belt apparatus at the first level, and an upper conveyor section extending horizontally from an upper end of the inclined conveyor section to the front end of the conveyor belt apparatus at the second level. The conveyor assembly may include a level sensor device configured to generate sensor data indicating a level of material at the lower end of the inclined conveyor section. The method may include independently controlling at least one of the conveyor belt apparatus or the supply apparatus based on processing the sensor data to cause the level of material to be within a particular range of level values.

The independently controlling may include processing the sensor data generated by the level sensor device to determine a value of the level of the material, executing a control loop to generate an output value indicating a target level of the material, based on a process variable that is the determined value of the level of the material and a setpoint that is a stored level setpoint value, and controlling the at least one of the conveyor belt apparatus or the supply apparatus based on the output value to control the level of the material.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated. The patent or application file contains at least one drawing executed in color. Copies of this patent or patent application publication with color drawing(s) will be provided by the Office upon request and payment of the necessary fee.

FIG. 1 is a perspective view of a manufacturing system including a manufacturing machine and a feed assembly, according to some example embodiments.

FIGS. 2A and 2B are cross-sectional views of the manufacturing system of FIG. 1 along cross-sectional view line II-II′ in FIG. 1, according to some example embodiments.

FIGS. 3A, 3B, 3C, 3D, 3E, 3F, and 3G are views of a feed assembly, including a conveyor assembly and a supply assembly, according to some example embodiments.

FIGS. 4A, 4B, 4C, 4D, 4E, 4F, 4G, and 4H are views of a conveyor assembly, according to some example embodiments.

FIGS. 5A, 5B, 5C, 5D, and 5E are views of a supply assembly, according to some example embodiments.

FIGS. 6A, 6B, 6C, 6D, 6E, and 6F are images of a feed assembly and a manufacturing machine, according to some example embodiments.

FIGS. 7A and 7B are images of a supply assembly, according to some example embodiments.

FIG. 8 is a flowchart of a method of configuring a manufacturing system, according to some example embodiments.

FIG. 9 is a flowchart of a control method, according to some example embodiments.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements, and/or groups thereof.

Example embodiments are described herein with reference to cross-sectional illustrations that are schematic illustrations of example embodiments. As such, variations from the shapes of the illustrations are to be expected. Thus, example embodiments should not be construed as limited to the shapes of regions illustrated herein but are to include deviations and variations in shapes.

It will be understood that when an element such as a layer, film, region, or substrate is referred to as being “on” another element, it may be directly on the other element or intervening elements may also be present. In contrast, when an element is referred to as being “directly on” another element, there are no intervening elements present. It will further be understood that when an element is referred to as being “on” another element, it may be above or beneath or adjacent (e.g., horizontally adjacent) to the other element.

It will be understood that elements and/or properties thereof (e.g., structures, surfaces, directions, or the like), which may be referred to as being “perpendicular,” “parallel,” “coplanar,” or the like with regard to other elements and/or properties thereof (e.g., structures, surfaces, directions, or the like) may be “perpendicular,” “parallel,” “coplanar,” or the like or may be “substantially perpendicular,” “substantially parallel,” “substantially coplanar,” respectively, with regard to the other elements and/or properties thereof.

Elements and/or properties thereof (e.g., structures, surfaces, directions, or the like) that are “substantially perpendicular” with regard to other elements and/or properties thereof will be understood to be “perpendicular” with regard to the other elements and/or properties thereof within manufacturing tolerances and/or material tolerances and/or have a deviation in magnitude and/or angle from “perpendicular,” or the like with regard to the other elements and/or properties thereof that is equal to or less than 10% (e.g., a. tolerance of ±10%).

Elements and/or properties thereof (e.g., structures, surfaces, directions, or the like) that are “substantially parallel” with regard to other elements and/or properties thereof will be understood to be “parallel” with regard to the other elements and/or properties thereof within manufacturing tolerances and/or material tolerances and/or have a deviation in magnitude and/or angle from “parallel,” or the like with regard to the other elements and/or properties thereof that is equal to or less than 10% (e.g., a. tolerance of ±10%).

Elements and/or properties thereof (e.g., structures, surfaces, directions, or the like) that are “substantially coplanar” with regard to other elements and/or properties thereof will be understood to be “coplanar” with regard to the other elements and/or properties thereof within manufacturing tolerances and/or material tolerances and/or have a deviation in magnitude and/or angle from “coplanar,” or the like with regard to the other elements and/or properties thereof that is equal to or less than 10% (e.g., a. tolerance of ±10%)).

It will be understood that elements and/or properties thereof may be recited herein as being “the same” or “equal” as other elements, and it will be further understood that elements and/or properties thereof recited herein as being “identical” to, “the same” as, or “equal” to other elements may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to and/or the same or substantially the same as other elements and/or properties thereof may be structurally the same or substantially the same, functionally the same or substantially the same, and/or compositionally the same or substantially the same.

It will be understood that elements and/or properties thereof described herein as being “substantially” the same and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., +10%) around the stated elements and/or properties thereof.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

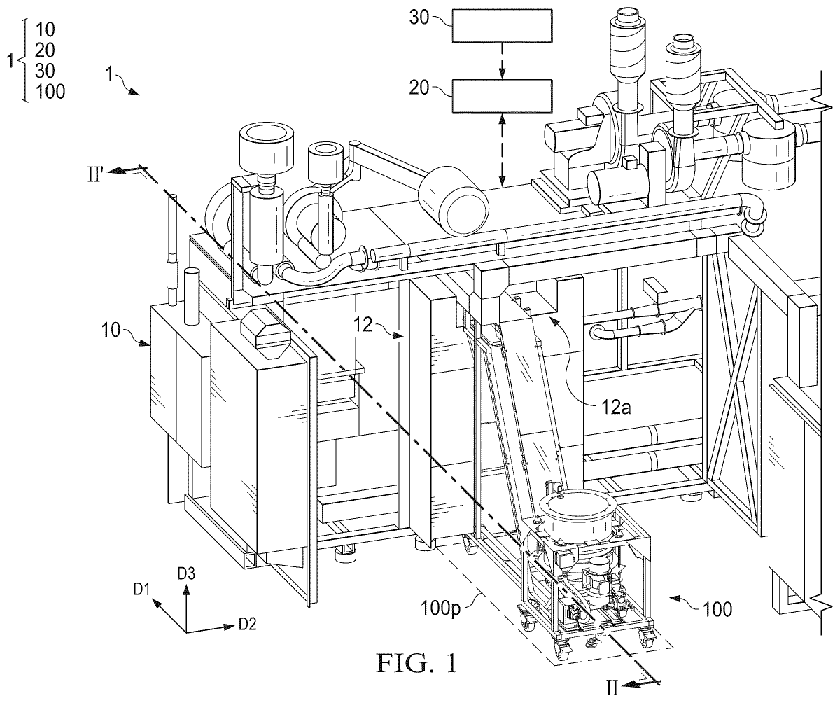

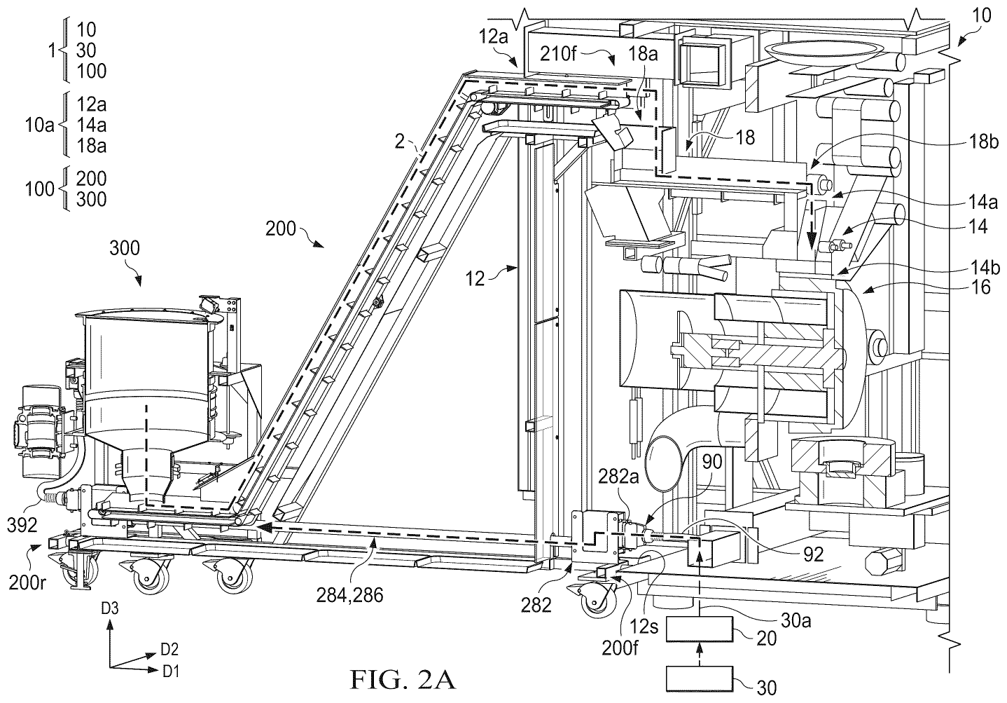

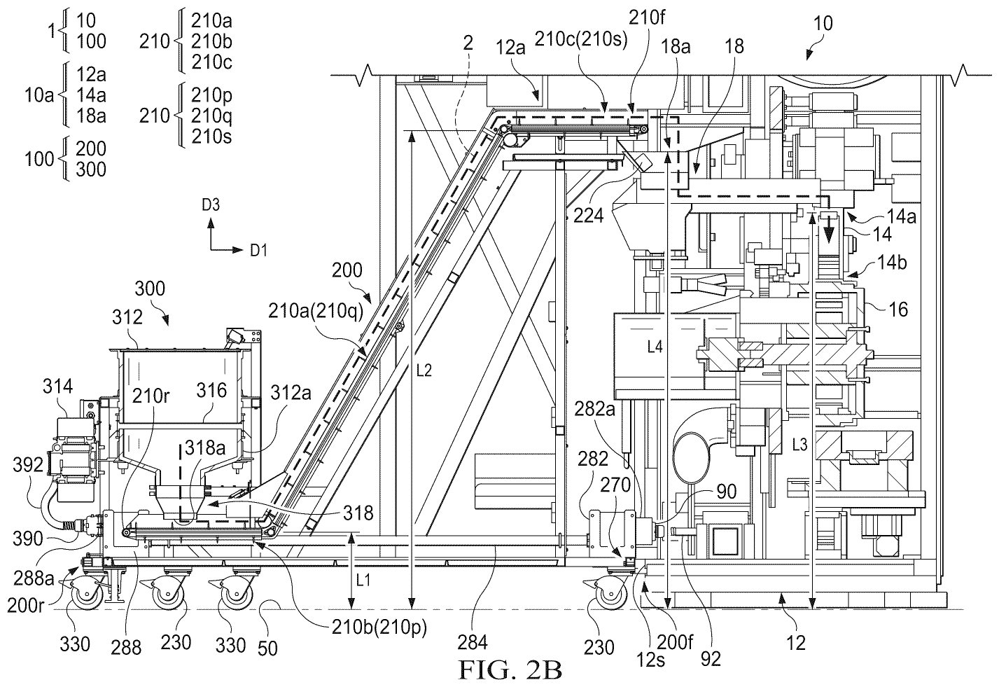

FIG. 1 is a perspective view of a manufacturing system including a manufacturing machine and a feed assembly, according to some example embodiments. FIGS. 2A and 2B are cross-sectional views of the manufacturing system of FIG. 1 along cross-sectional view line II-II′ in FIG. 1, according to some example embodiments.

Referring to at least FIGS. 1, 2A, and 2B, in some example embodiments, a manufacturing system 1 may include a manufacturing machine 10 that is configured to form a material (e.g., a granular material) into discrete units (e.g., formed pieces, specific amounts and/or volumes, etc.) of such material which may be packaged into one or more packages (e.g., one or more pouched products) of such material. As described herein, the material may be a granular material. Such a material may be, for example, a filler material. As described herein, a package, or packaged product, may include contain a unit (e.g., an amount) of a material (e.g., filler material) within a pouch comprising webs of elastic layer material that are sealed together.

As described herein, the manufacturing machine 10 may include a housing structure 12 at least partially structurally supporting and/or enclosing portions of the manufacturing machine 10. The manufacturing machine 10 may include a dispenser 14 (also referred to herein as a simple dispenser), a packaging device 16, a vibratory pan feeder 18, any combination thereof, or the like, which may be at least partially enclosed and/or structurally supported by the housing structure 12.

The dispenser 14 may be configured to process a received material 2 (e.g., bulk material) to dispense (e.g., form, portion, etc.) one or more units (e.g., pieces, articles, etc.) of the material. For example, the dispenser 14 may be configured to receive a material 2 through a dispenser intake port 14a at a top end thereof and dispense one or more portions (e.g., amounts, volumes, etc.) of the material 2 through a dispenser discharge port 14b at a bottom end thereof that is open to the packaging device 16 under the bottom end. The dispenser 14 may be configured to enable separate portions of the material 2 received through the dispenser intake port 14a to fall from the dispenser discharge port 14b into the packaging device 16 underneath the open bottom end of the dispenser 14. The packaging device 16 may be configured to package the one or more discrete units of the material 2 received from the dispenser discharge port 14b into one or more packages (e.g., one or more packaged products). For example, the packaging device 16 may include a rotating drum that is configured to rotate one or more containers under the dispenser discharge port 14b at the bottom end of the dispenser 14 to be filled by separate portions (“units”) of material from the dispenser 14 and to be enclosed with packaging material that may be segmented to form one or more packages of material. It will be understood that example embodiments are not limited to such example embodiments of a dispenser 14 and/or packaging device 16. In some example embodiments, the manufacturing machine 10 may omit at least the packaging device 16 and thus may form and provide one or more units (e.g., formed pieces) of material based on the dispenser 14 processing material received from a feed assembly.

As further shown, the manufacturing machine 10 may include a vibratory pan feeder 18 which may be configured (e.g., based on being mechanically coupled to a driver) to vibrate and to move a material 2 received onto the vibratory pan feeder 18, via an intake port 18a thereof, towards the dispenser intake port 14a of the dispenser 14 via a discharge end 18b of the vibratory pan feeder 18. As shown, the discharge end 18b of the vibratory pan feeder 18 may at least partially overlap the dispenser intake port 14a in the third direction D3, so that material 2 discharged from the vibratory pan feeder 18 via the discharge end 18b may fall under gravity in the third direction D3 through the dispenser intake port 14a and into the dispenser 14. The vibratory pan feeder 18 may be controlled (e.g., based on controlling a driver to control an intensity and/or frequency of vibration of a vibratory pan of the vibratory pan feeder 18) to control a rate at which material 2 (e.g., bulk material) received onto the vibratory pan feeder 18 via the intake port 18a is supplied into the dispenser 14 via the discharge end 18b and the dispenser intake port 14a. The vibratory pan feeder 18 may thereby control a depth (“head”) of material 2 within the dispenser 14 (e.g., a head pressure of material in a hopper of the dispenser 14). The vibratory pan feeder 18 may be configured to vibrate to meter out a flow of material 2 received through the intake port 18a into the dispenser 14, in order to mitigate variations in the rate of flow of material 2 into the dispenser 14.

In some example embodiments, the housing structure 12 defines an intake port 12a through which material 2 (e.g., bulk material) may be received into an interior of the manufacturing machine 10 that is at least partially defined by the housing structure 12 from an external feed assembly and directed to the dispenser 14. The housing structure 12 may at least partially define the intake port 12a as an opening through which material may be supplied into the interior of the manufacturing machine 10. In some example embodiments, at least one of the housing intake port 12a, the vibratory pan feeder intake port 18a, or the dispenser intake port 14a may be referred to as, and/or may define, an intake port 10a of the manufacturing machine 10 that is configured to receive material 2 from an external source (e.g., the feed assembly 100).

In some example embodiments, the density, volume, and/or mass of units (e.g., pieces, volumes, amounts, indexes, etc.) of material dispensed by the dispenser 14 to the packaging device 16 may be based on a level (“depth”) of material in the dispenser 14 above the dispenser discharge port 14b (e.g., in a hopper of the dispenser 14). The level of material in the dispenser 14 may be based on a rate at which material is supplied into the dispenser 14 through the dispenser intake port 14a. For example, an excessive depth of material in the dispenser 14, due to an excessive rate of supply of material 2 into the manufacturing machine 10, may result in excessive density of the formed (e.g., dispensed) one or more units of material, constriction of material flow out of the dispenser 14 due to ratholing, bridging, etc., or the like. In another example, insufficient depth of material above the dispenser discharge port 14b in the dispenser 14, due to insufficient rate of supply of material into the dispenser 14, may result in undesirably low density, volume, and/or mass of the one or more units of material formed and/or dispensed by the dispenser. In some example embodiments, the flow rate of material into the manufacturing machine 10 may be controlled in order to control the depth of material in the dispenser 14 to be within a certain range. Such a range of depth (level) of material in the dispenser 14 may correspond to an acceptable range of density of the formed one or more units of material, to reduce or minimize the likelihood of flow constrictions in the dispenser 14, or the like.

The manufacturing system 1 may include a controller 20 and a power supply 30. The power supply 30 may be any known power supply, including for example a connection to AC mains power, an AC/DC power adaptor and power supply device, any combination thereof, or the like. The controller 20 may be electrically coupled to the manufacturing machine 10, the feed assembly 100, or any combination thereof. As used, here, “electrically coupled” and “communicatively coupled” may be used interchangeably. The power supply 30 may be electrically coupled to the manufacturing machine 10, the feed assembly 100, the controller 20, or any combination thereof to provide electrical power to the manufacturing machine 10. In some example embodiments, the power supply 30 may be electrically coupled to the manufacturing machine 10 through the controller 20, where the controller 20 may be configured to selectively control the supply of electrical power 30a to at least the manufacturing machine 10, but example embodiments are not limited thereto. In some example embodiments, the power supply 30 may be electrically coupled to the feed assembly 100 through the manufacturing machine 10 (to which the power supply 30 may be electrically coupled through the controller 20), but example embodiments are not limited thereto. In some example embodiments, controller 20 may be electrically coupled to the feed assembly 100 through the manufacturing machine 10, but example embodiments are not limited thereto. The controller 20 may be configured to selectively control the supply of electrical power 30a from the power supply 30 to the manufacturing machine 10, the feed assembly 100, or any combination thereof.

The controller 20 may include a memory that may be configured to store a program of instructions, and the controller 20 may include a processor which may be configured to execute the program of instructions, for example to adjust operation of one or more portions of the manufacturing machine 10, the feed assembly 100, or the like. In some example embodiments, the controller 20 is configured to control one or more portions of the manufacturing machine 10, the feed assembly 100, or any combination thereof in order to control a determined depth (e.g., level) of a material at one or more locations in the feed assembly 100 and/or the manufacturing machine 10. In some example embodiments, the controller 20 is configured to control one or more drivers, servoactuators, motors, or the like in any of the elements, stations, assemblies, or the like of the manufacturing machine 10 and/or the feed assembly 100 in order to control the operation of any portion of the manufacturing machine 10 and/or the feed assembly 100.

The controller 20 according to some example embodiments may be implemented using hardware, or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

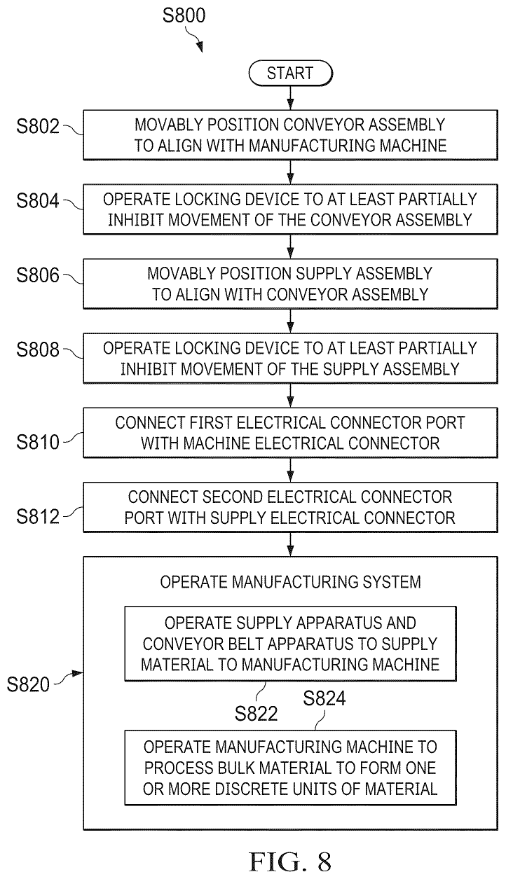

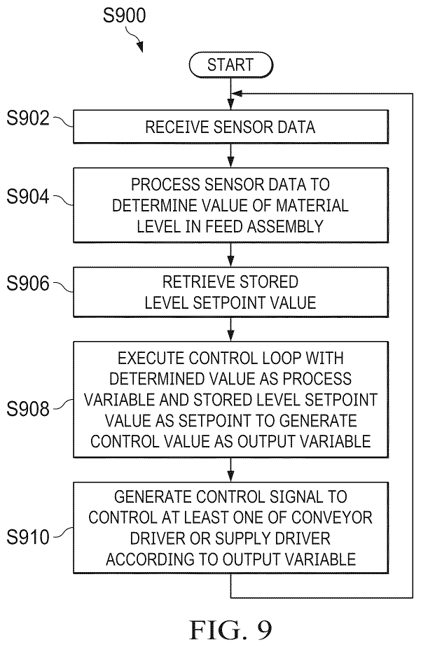

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code (also referred to herein as a program of instructions) by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto (e.g., any of the methods according to any of the example embodiments, including the example embodiments as described with reference to FIG. 8 and/or FIG. 9), thereby transforming the processor into a special purpose processor.

In some example embodiments, the controller 20 may include one or more switches, circuits, switchgear, any combination thereof, or the like that may be controlled to control the supply of electrical power 30a to one or more elements (e.g., drivers) of the manufacturing system 1. Then controller 20 may be configured to execute a program of instructions to control the supply of electrical power 30a from the power supply 30 to various devices (e.g., drivers) to control the flow of material through the feed assembly 100 and/or manufacturing machine 10.

In some example embodiments, the feed assembly 100 is configured to supply (“feed”) the material 2 into the manufacturing machine 10 via an intake port 10a of the manufacturing machine 10 (e.g., at least one of intake ports 12a, 18a, or 14a) so that the material 2 may be supplied to the dispenser 14 directly or via one or more intermediate devices such as the vibratory pan feeder 18. The feed assembly 100 includes a supply assembly 300 that is configured to store a bulk amount of the material 2 in a supply apparatus 310 and is further configured to controllably discharge one or more amounts of the material 2 from the supply apparatus 310, and the feed assembly further includes a conveyor assembly 200 that is configured to controllably convey (“move”) the discharged one or more amounts of the material 2 to the manufacturing machine 10 via a conveyor belt apparatus 210 and to discharge the conveyed material 2 from the conveyor belt apparatus 210 at a front end 210f of the conveyor belt apparatus 210. The front end 210f of the conveyor belt apparatus 210 may be referred to interchangeably as a discharge of the conveyor belt apparatus 210, a discharge end of the conveyor belt apparatus 210, or the like.

As shown, the feed assembly 100 is located at a particular position 100p on a support surface 50 in relation to the manufacturing machine 10 such that the front end 210f of the conveyor belt apparatus 210 is aligned with an intake port 10a of the manufacturing machine 10 which may be the vibratory pan feeder intake port 18a, such alignment including the front end 210f at least partially overlapping the intake port 18a in the third direction D3, such that material 2 discharged from the front end 210f of the conveyor belt apparatus 210 may fall under gravity in the third direction D3 through the intake port 18a into the vibratory pan feeder 18 to be further conveyed by the vibratory pan feeder 18 to the dispenser 14.

As further shown, the feed assembly 100 may be aligned with the manufacturing machine 10 based on being located at the particular position 100p such that at least a front conveyor section 210s of the conveyor belt apparatus 210 that includes the front end 210f is aligned with (e.g., at least partially overlaps) the housing intake port 12a in a first direction D1 and may at least partially protrude through the housing intake port 12a in the first direction to be aligned (e.g., at least partially overlap in the third direction D3) with the vibratory pan feeder intake port 18a (which may be referred to as an intake port 10a of the manufacturing machine 10). The feed assembly 100 may be aligned with the manufacturing machine 10 based on being located at the particular position 100p such that a longitudinal axis 200x of at least the conveyor assembly 200 and/or a longitudinal axis 210x of the conveyor belt apparatus 210 is parallel with the first direction D1 that may extend parallel to a central axis of the housing intake port 12a.

As shown, the first direction D1 may extend in parallel with the support surface 50 upon which the feed assembly 100 and/or the manufacturing machine 10 is supported (e.g., upon which the feed assembly 100 and/or the manufacturing machine 10 rests) and may extend in parallel with a central axis of the housing intake port 12a of the manufacturing machine, and/or may extend perpendicularly to an outer surface 12s of the housing structure 12 that may be engaged (contacted) by the conveyor assembly 200 as described herein. The first direction D1 may be referred to herein interchangeably as a longitudinal direction, a longitudinal horizontal direction, a length direction, or the like. The second direction D2 may extend perpendicular to the first direction D1 and may further extend in parallel with the support surface 50. The second direction D2 may be referred to herein interchangeably as a lateral direction, a lateral horizontal direction, a width direction, or the like. The third direction D3 may extend perpendicular to both the first direction D1 and the second direction D2 and may further extend perpendicular to the support surface 50. The third direction D3 may be referred to herein interchangeably as a vertical direction.

As described herein, a material, bulk material, or the like may include a granular material. A granular material may include a “filler material.” A “filler material” may include particulate matter comprising particles. The filler material may be a powder-like substance that may flow freely when shaken or tilted. In some example embodiments, the filler material may have a particle size (e.g., particle diameter) between about 0.1 μm to about 500 μm. In some example embodiments, the filler material may have a particle size (e.g., particle diameter) between about 0.1 μm to about 200 μm. In some example embodiments, the filler material may have a particle size between about 0.5 mm to about 1 mm, about 0.25 mm to about 0.5 mm, about 125 μm to about 250 μm, about 60 μm to about 125 μm, about 4 μm to about 60 μm, about 1 μm to about 4 μm, any combination thereof, or the like.

In some example embodiments, the filler material may have an average particle size of about 50 μm. In some example embodiments, the filler material may have an average particle size of about 200 μm. In some example embodiments, the filler material may have an average particle size of about 400 μm.

The filler material may partially or entirely comprise particles having a maximum diameter that is between about 0.1 μm to about 1 μm. The filler material may partially or entirely comprise particles having a maximum diameter that is equal to or greater than 1 μm.

The filler material may contain and/or partially or completely comprise at least one substance. In some example embodiments, the at least one substance is a consumer product.

In some example embodiments, the at least one substance and/or the consumer product is an inert powder material. In some example embodiments, the filler material may contain and/or partially or completely comprise a substance that is microcrystalline cellulose (MCC).

In some example embodiments, the at least one substance and/or the consumer product includes (e.g., partially or completely comprises) an oral product.

In some example embodiments, the oral product is an oral tobacco product, an oral non-tobacco product, an oral cannabis product, or any combination thereof. The oral product may be in a form of loose material (e.g., loose cellulosic material), shaped material (e.g., plugs or twists), pouched material, tablets, lozenges, chews, gums, films, any other oral product, or any combination thereof.

The oral product may include chewing tobacco, snus, moist snuff tobacco, dry snuff tobacco, other smokeless tobacco and non-tobacco products for oral consumption, or any combination thereof.

Where the oral product is an oral tobacco product including smokeless tobacco product, the smokeless tobacco product may include tobacco that is whole, shredded, cut, granulated, reconstituted, cured, aged, fermented, pasteurized, or otherwise processed. Tobacco may be present as whole or portions of leaves, flowers, roots, stems, extracts (e.g., nicotine), or any combination thereof.

In some example embodiments, the oral product includes a tobacco extract, such as a tobacco-derived nicotine extract, and/or synthetic nicotine. The oral product may include nicotine alone or in combination with a carrier (e.g., white snus), such as a cellulosic material. The carrier may be a non-tobacco material (e.g., microcrystalline cellulose) or a tobacco material (e.g., tobacco fibers having reduced or eliminated nicotine content, which may be referred to as “exhausted tobacco plant tissue or fibers”). In some example embodiments, the exhausted tobacco plant tissue or fibers can be treated to remove at least 25%, 40%, 50%, 60%, 70%, 75%, 80%, 85%, 90%, or 95% of the nicotine. For example, the tobacco plant tissue can be washed with water or another solvent to remove the nicotine.

In other example embodiments, the oral product may include cannabis, such as cannabis plant tissue and/or cannabis extracts. In some example embodiments, the cannabis material includes leaf and/or flower material from one or more species of cannabis plants and/or extracts from the one or more species of cannabis plants. The one or more species of cannabis plants may include Cannabis sativa, Cannabis indica, and/or Cannabis ruderalis. In some example embodiments, the cannabis may be in the form of fibers. In some example embodiments, the cannabis may include a cannabinoid, a terpene, and/or a flavonoid. In some example embodiments, the cannabis material may be a cannabis-derived cannabis material, such as a cannabis-derived cannabinoid, a cannabis-derived terpene, and/or a cannabis-derived flavonoid.

The oral product (e.g., the oral tobacco product, the oral non-tobacco product, or the oral cannabis product) may have various ranges of moisture. In some example embodiments, the oral product is a dry oral product having a moisture content ranging from 5% by weight to 10% by weight. In some example embodiments, the oral product has a medium moisture content, such as a moisture content ranging from 20% by weight to 35% by weight. In some example embodiments, the oral product is a wet oral product having a moisture content ranging from 40% by weight to 55% by weight.

In some example embodiments, oral product may further include one or more elements such as a mouth-stable polymer, a mouth-soluble polymer, a sweetener (e.g., a synthetic sweetener and/or a natural sweetener), an energizing agent, a soothing agent, a focusing agent, a plasticizer, mouth-soluble fibers, an alkaloid, a mineral, a vitamin, a dietary supplement, a nutraceutical, a coloring agent, an amino acid, a chemesthetic agent, an antioxidant, a food-grade emulsifier, a pH modifier, a botanical, a tooth-whitening agent, a therapeutic agent, a processing aid, a stearate, a wax, a stabilizer, a disintegrating agent, a lubricant, a preservative, a filler, a flavorant, flavor masking agents, a bitterness receptor site blocker, a receptor site enhancers, other additives, or any combination thereof.

In some example embodiments, the filler material may contain any product or substance. For example, the filler material may contain confectionary products, food products, medicines, or any other product.

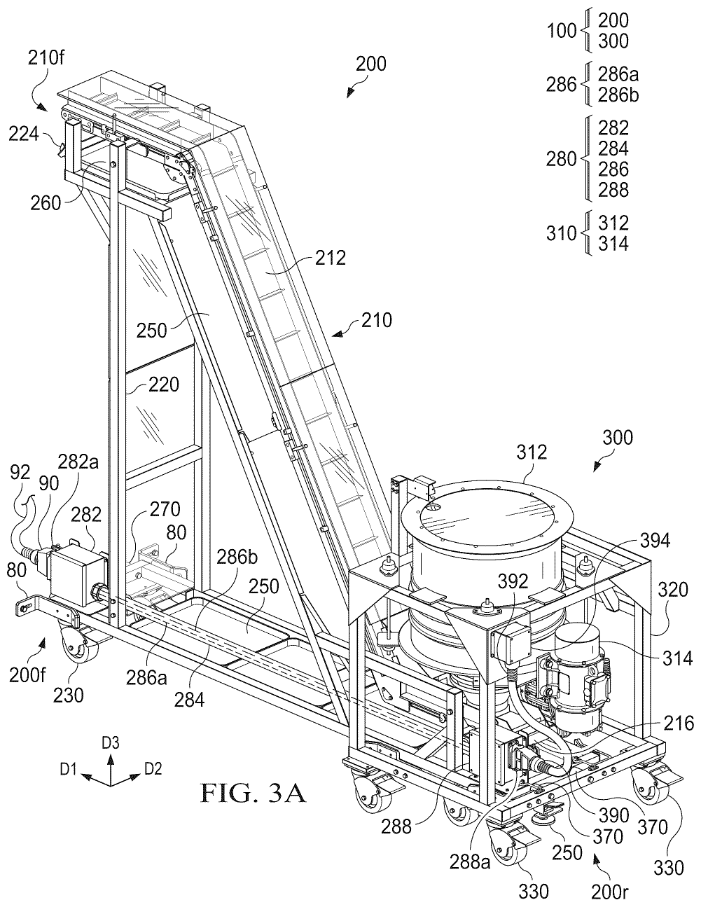

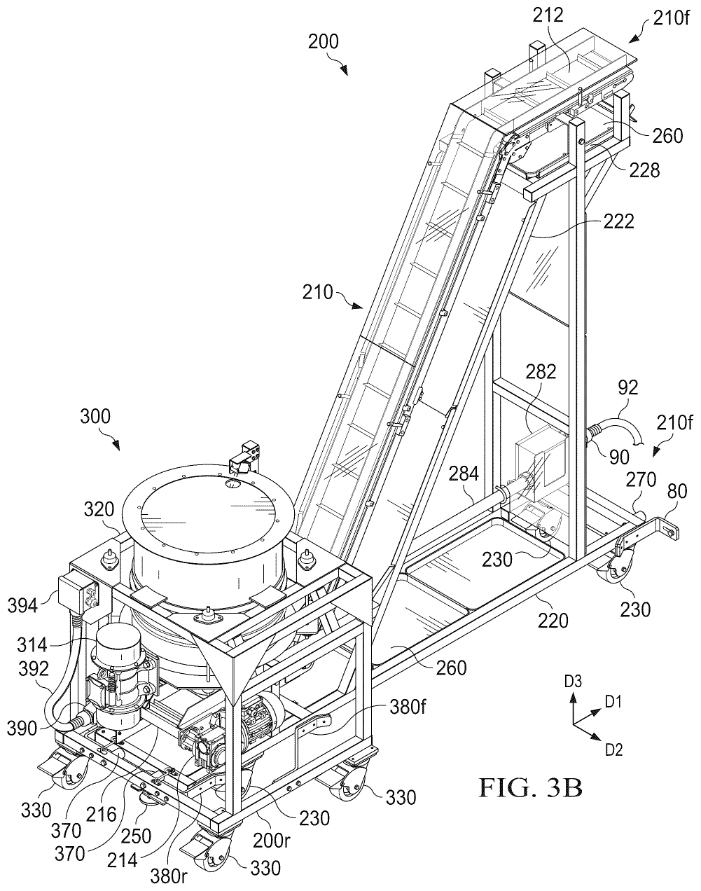

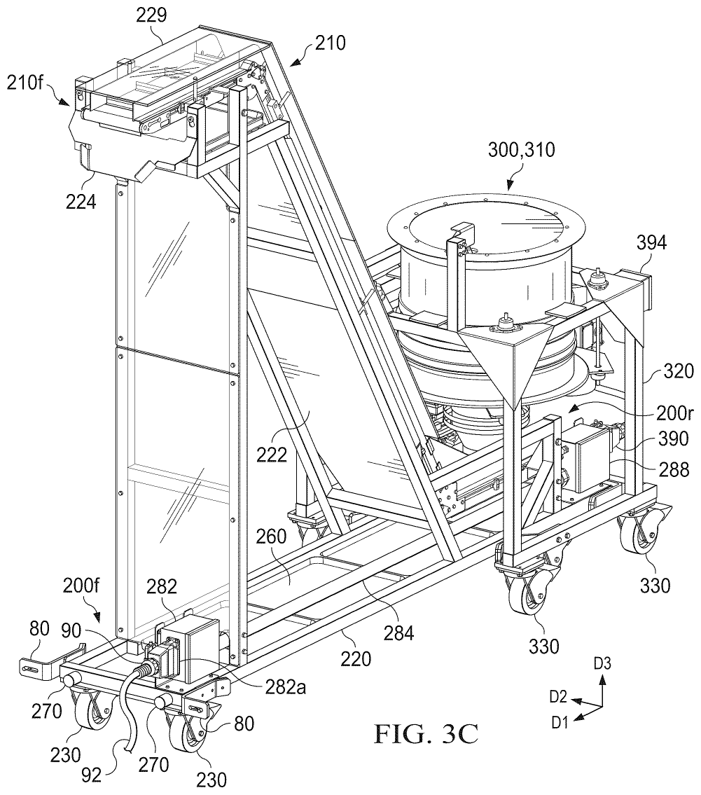

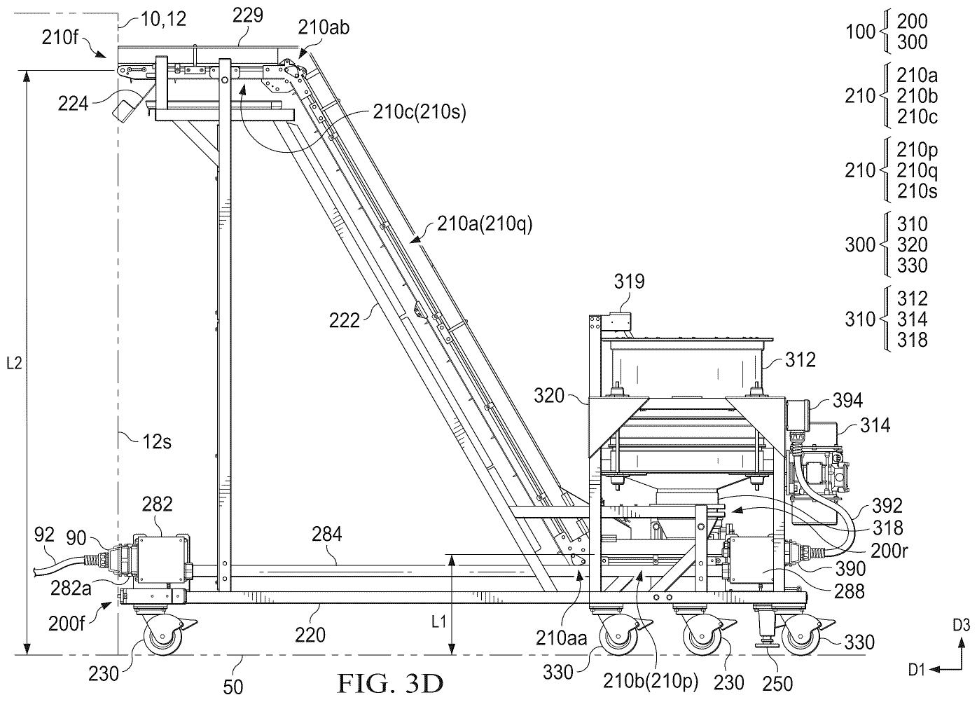

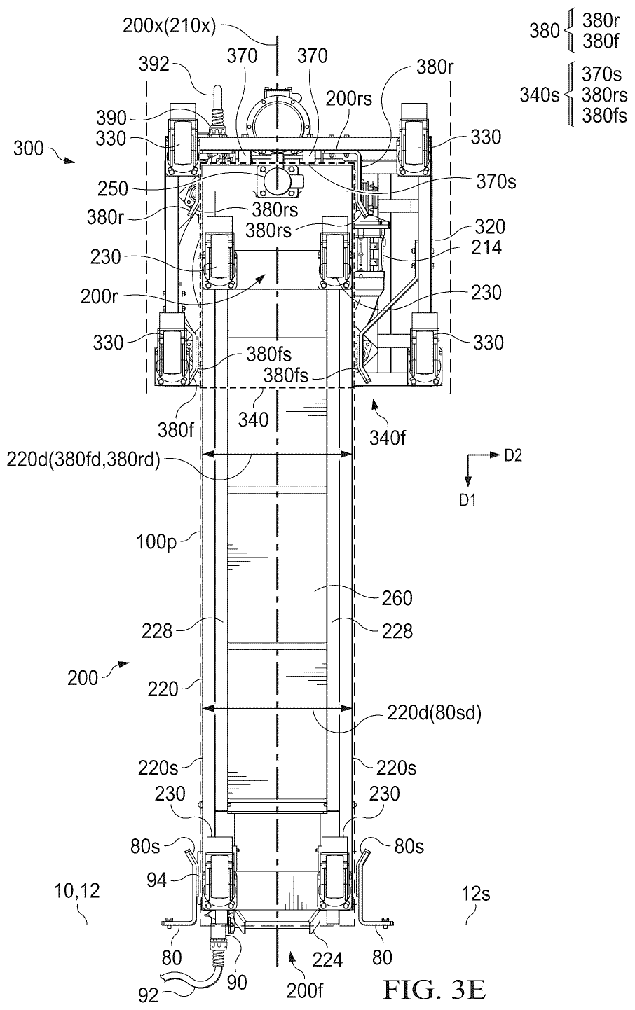

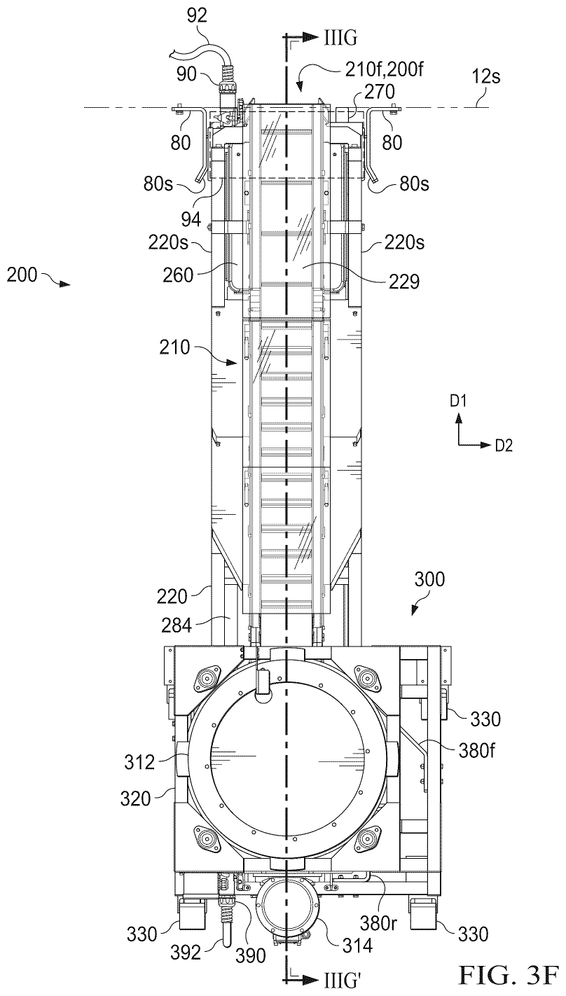

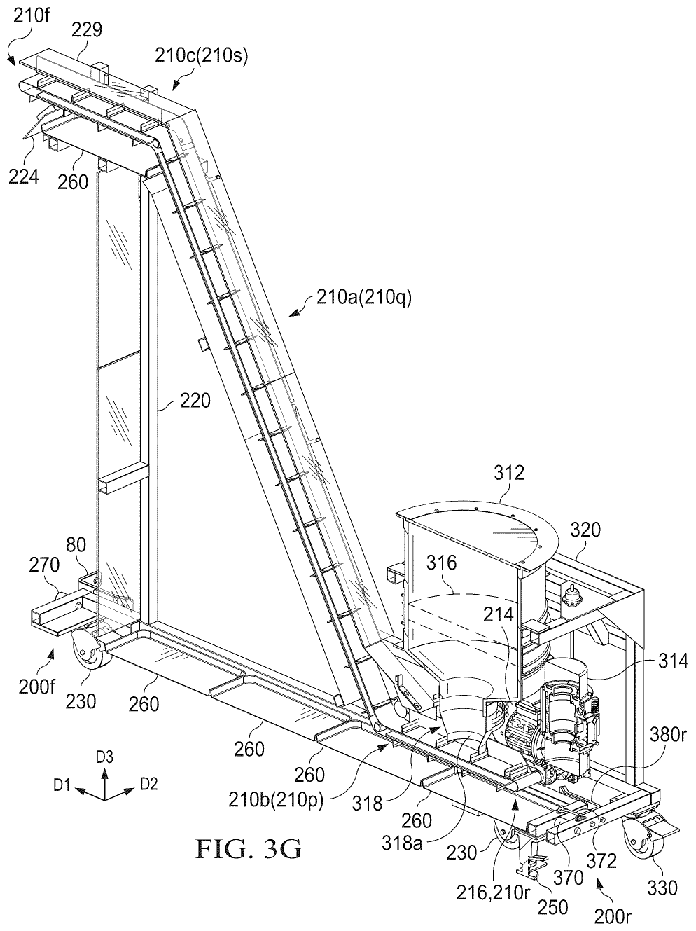

FIGS. 3A, 3B, 3C, 3D, 3E, 3F, and 3G are views of a feed assembly 100, including a conveyor assembly 200 and a supply assembly 300, according to some example embodiments. FIG. 3A is a top, left, rear perspective view of a feed assembly 100, according to some example embodiments. FIG. 3B is a top, right, rear perspective view of the feed assembly 100 of FIG. 3A, according to some example embodiments. FIG. 3C is a top, left, front perspective view of the feed assembly 100 of FIG. 3A, according to some example embodiments. FIG. 3D is a side elevation view of the feed assembly 100 of FIG. 3A, according to some example embodiments. FIG. 3E is a bottom plan view of the feed assembly 100 of FIG. 3A, according to some example embodiments. FIG. 3F is a top plan view of the feed assembly 100 of FIG. 3A, according to some example embodiments. FIG. 3G is a top, left, rear cross-sectional perspective view of the feed assembly 100 along cross-sectional view line IIIG-IIIG′ of FIG. 3F, according to some example embodiments. The feed assembly 100 shown in FIGS. 3A to 3G may be the same as the feed assembly 100 of the manufacturing system 1 as shown in FIG. 1 and FIGS. 2A and 2B, but example embodiments are not limited thereto.

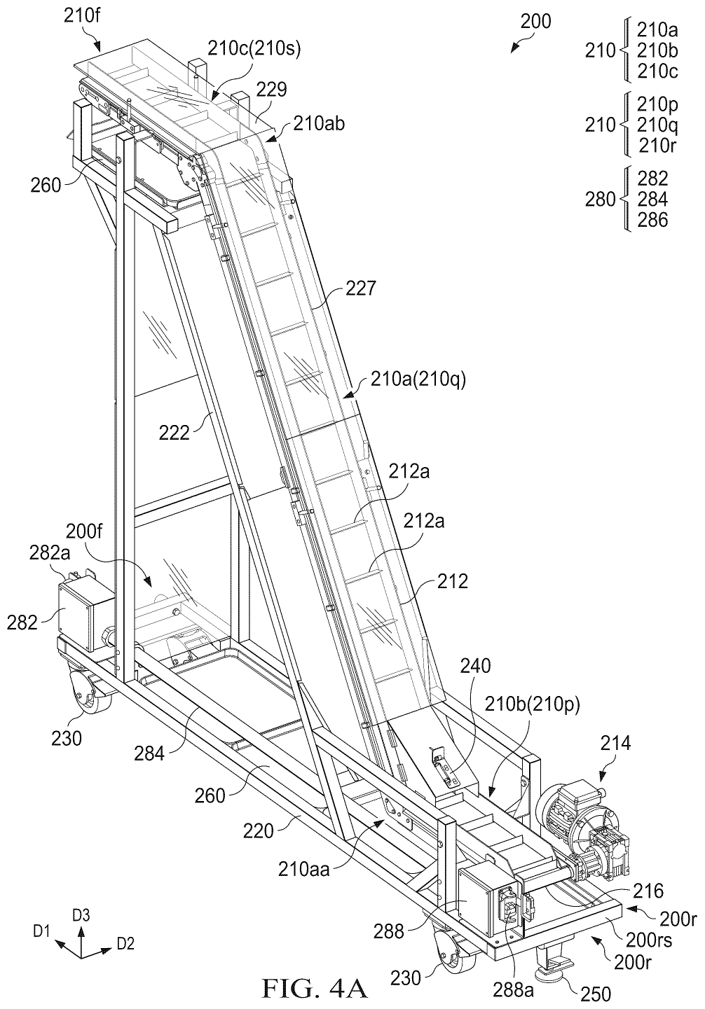

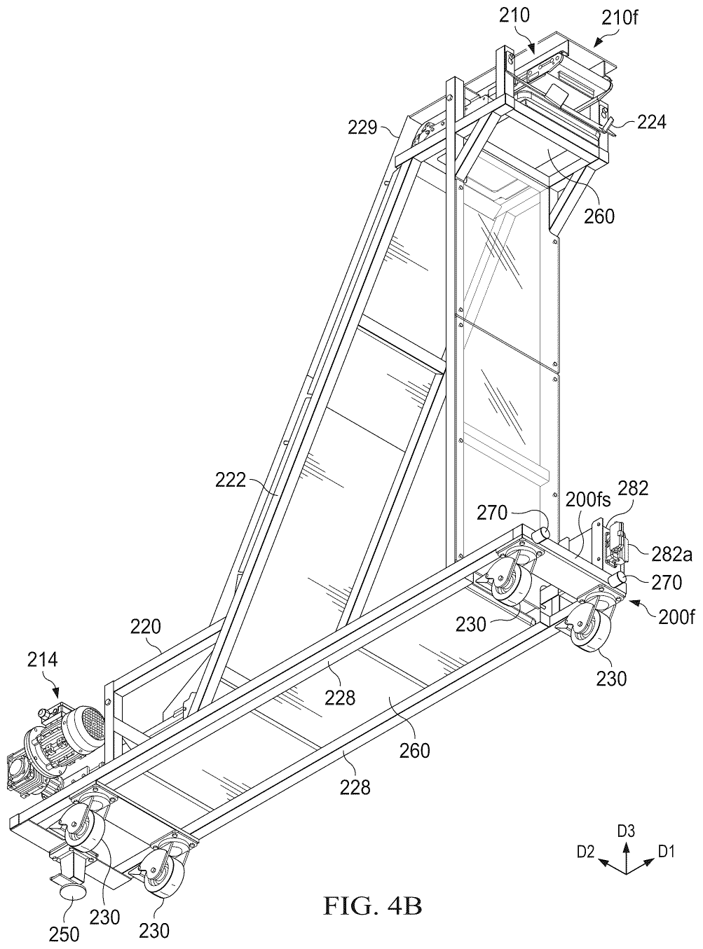

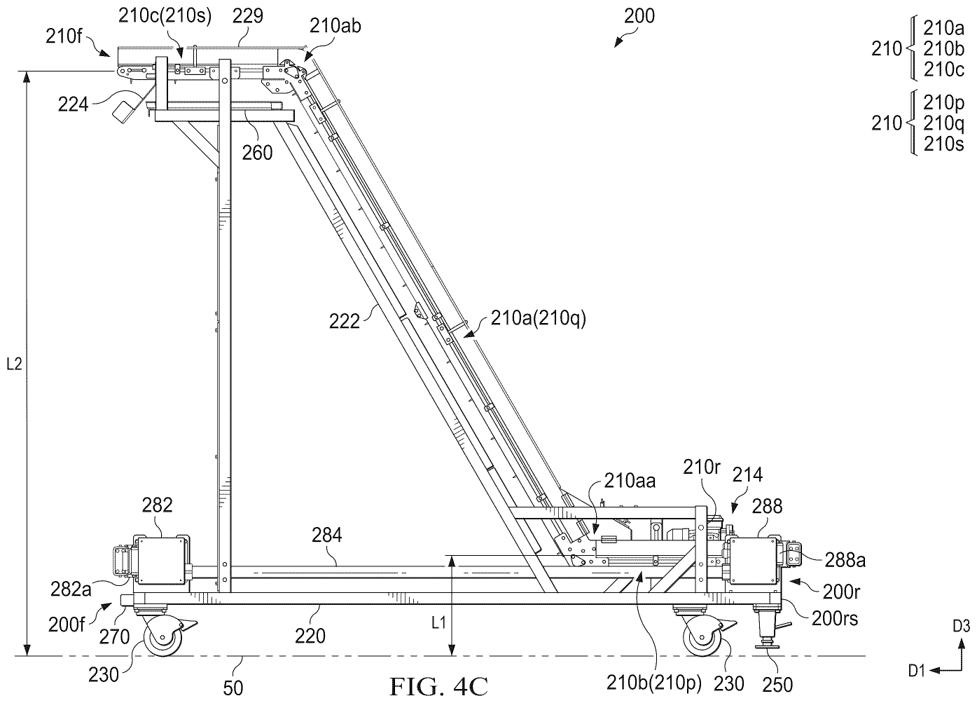

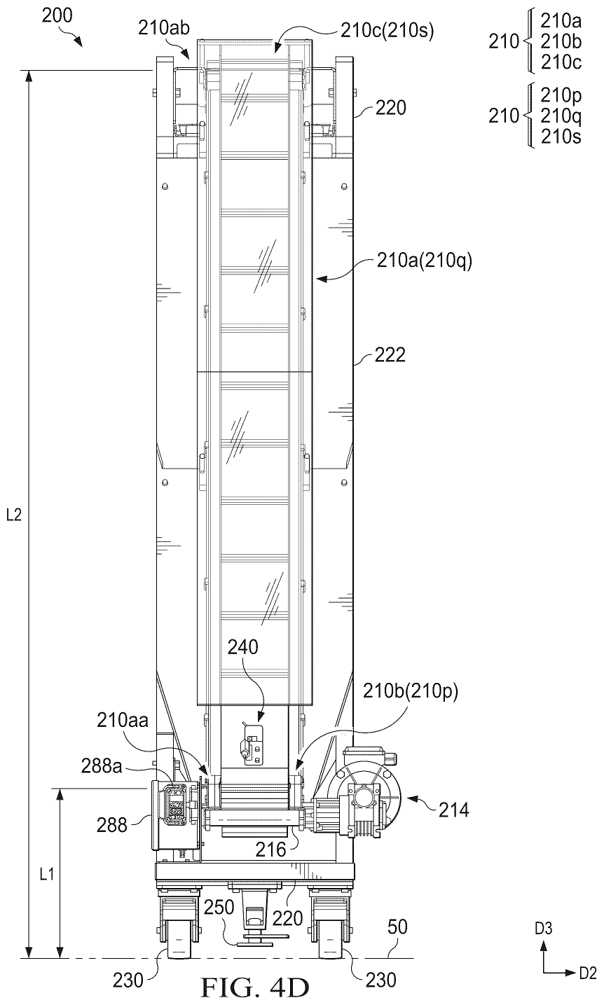

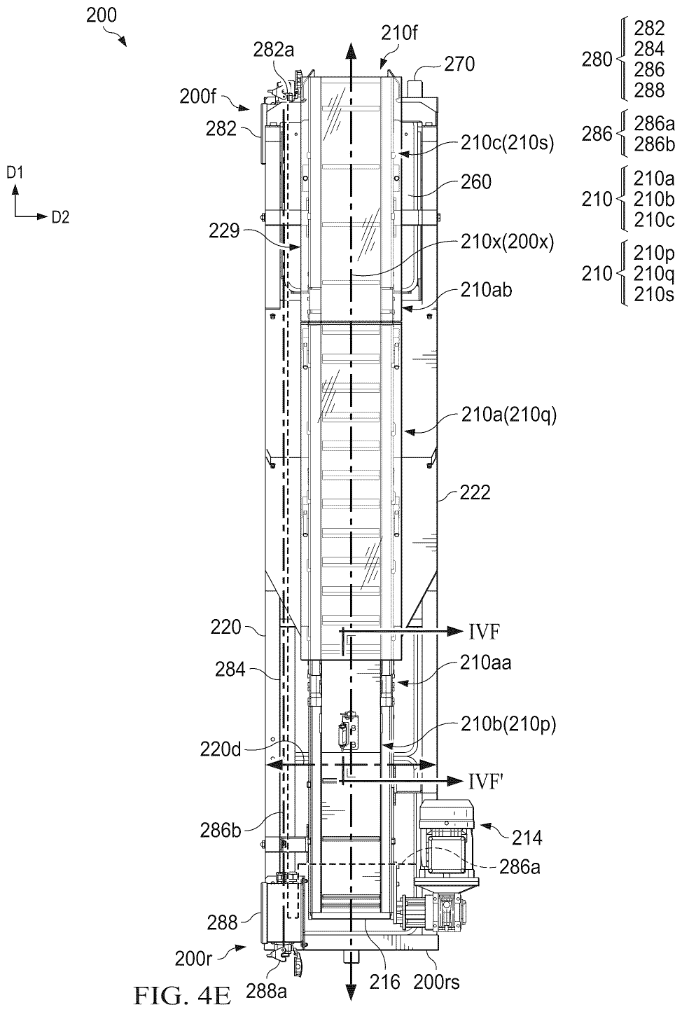

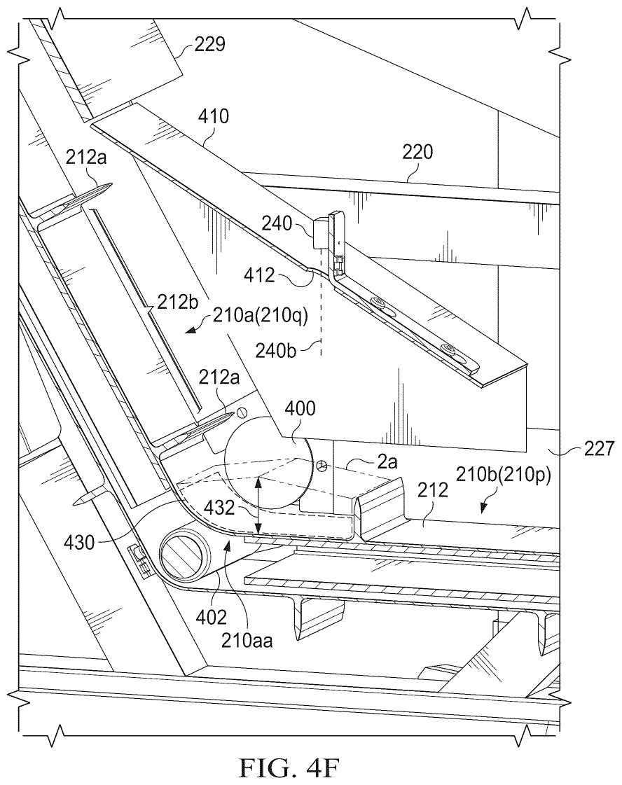

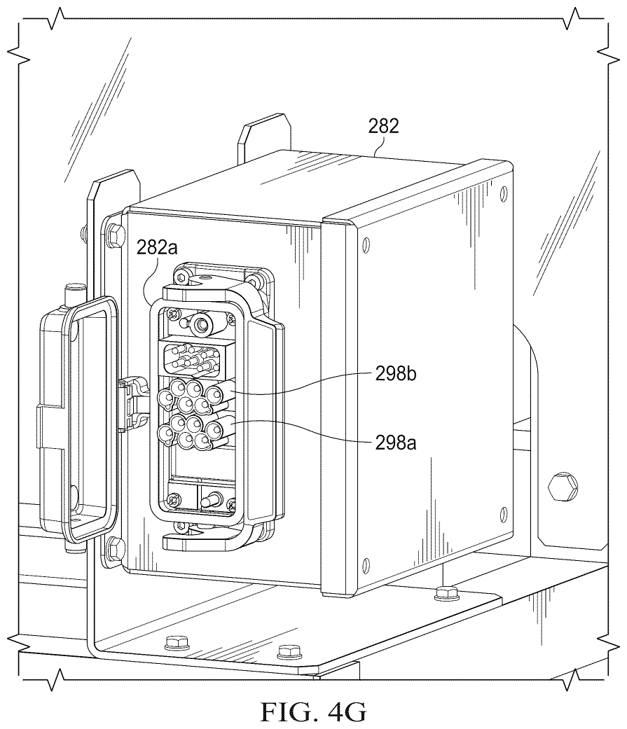

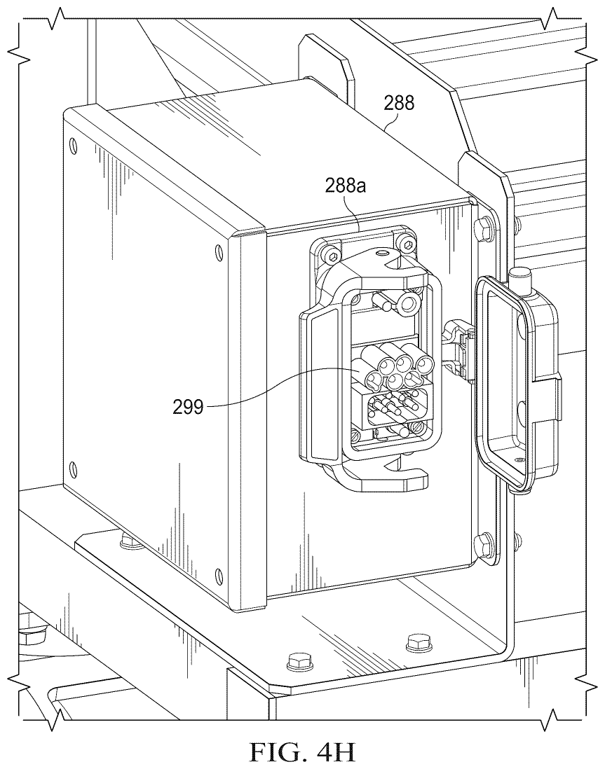

FIGS. 4A, 4B, 4C, 4D, 4E, 4F, 4G, and 4H are views of a conveyor assembly 200, according to some example embodiments. FIG. 4A is a top, left, rear perspective view of a conveyor assembly 200, according to some example embodiments. FIG. 4B is a bottom, right, front perspective view of the conveyor assembly 200 of FIG. 4A, according to some example embodiments. FIG. 4C is a side elevation view of the conveyor assembly 200 of FIG. 4A, according to some example embodiments. FIG. 4D is a rear elevation view of the conveyor assembly 200 of FIG. 4A, according to some example embodiments. FIG. 4E is a top plan view of the conveyor assembly 200 of FIG. 4A, according to some example embodiments. FIG. 4F is a cross-sectional perspective view of the conveyor assembly of FIG. 4A along cross-sectional view line IVF-IVF′ in FIG. 4E, according to some example embodiments. FIG. 4G is an expanded view of a first electrical junction box 282 of the conveyor assembly 200 of FIG. 4A. FIG. 4H is an expanded view of a second electrical junction box 288 of the conveyor assembly 200 of FIG. 4A. The conveyor assembly 200 shown in FIGS. 4A to 4H may be the same as the conveyor assembly 200 of the feed assembly 100 as shown in FIGS. 3A to 3G, but example embodiments are not limited thereto.

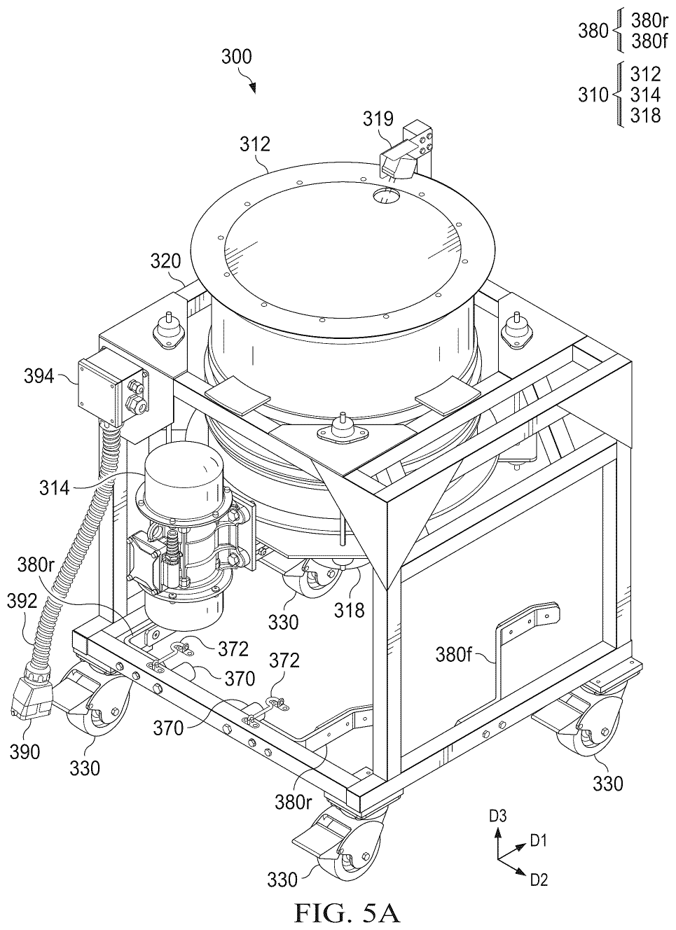

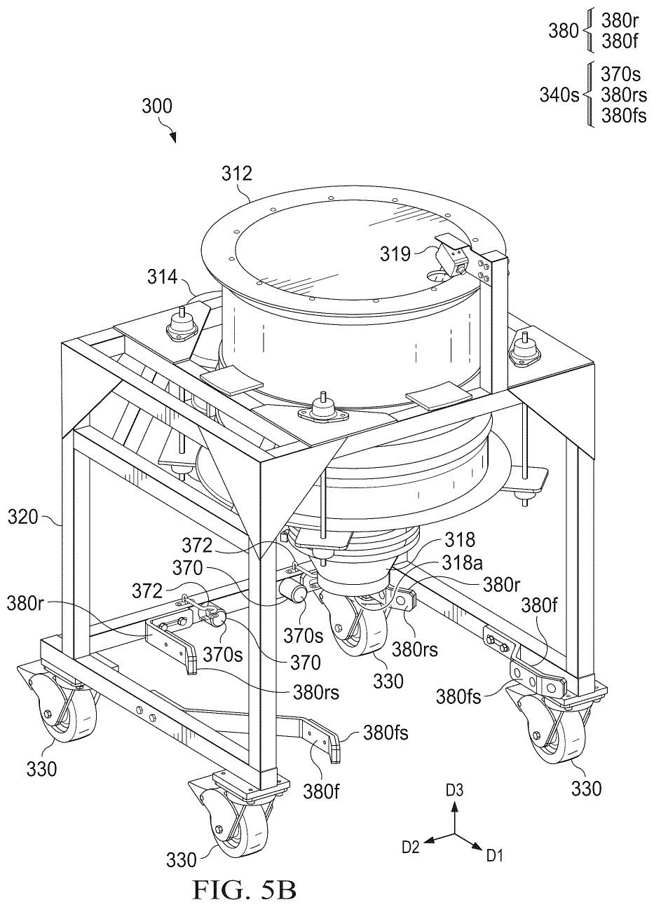

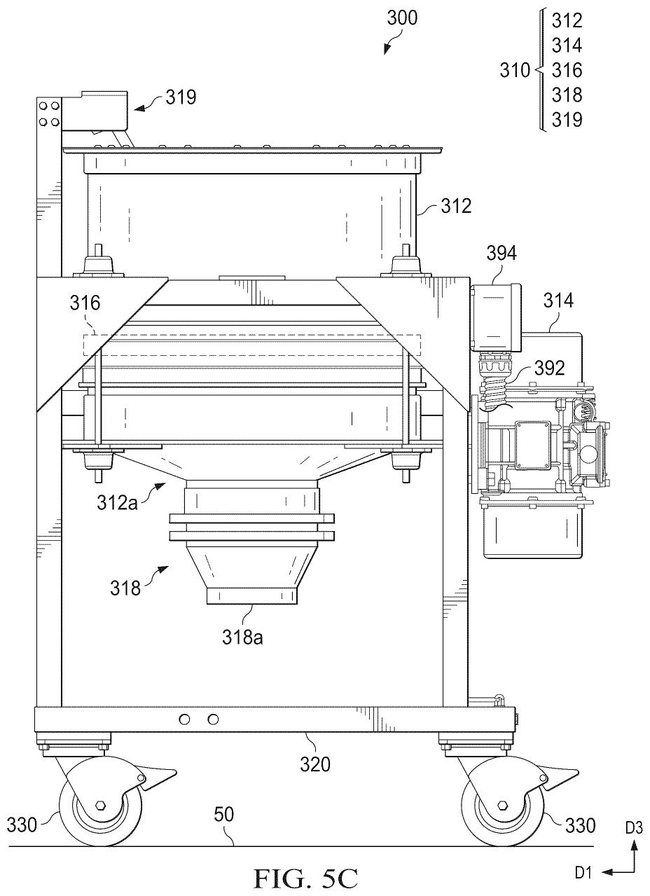

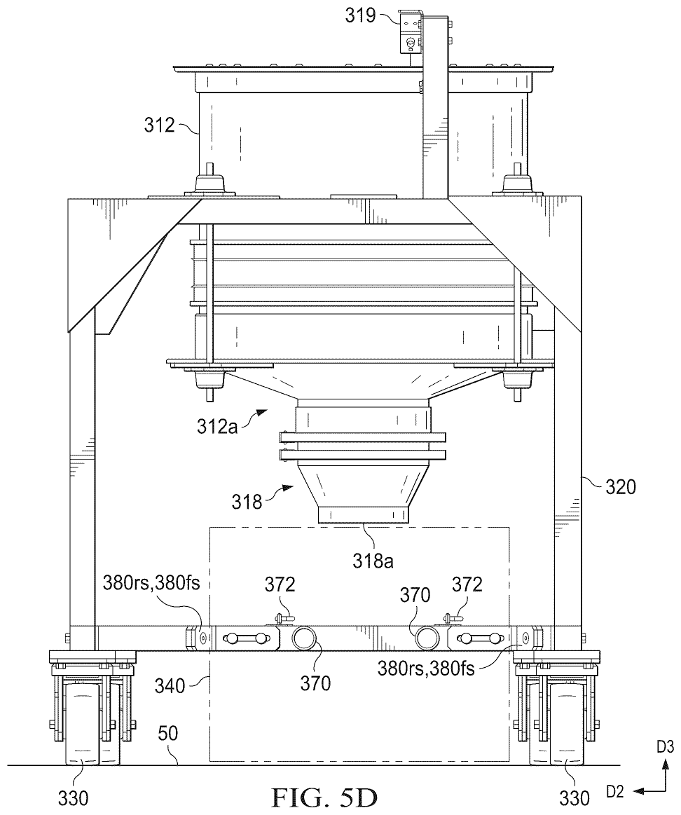

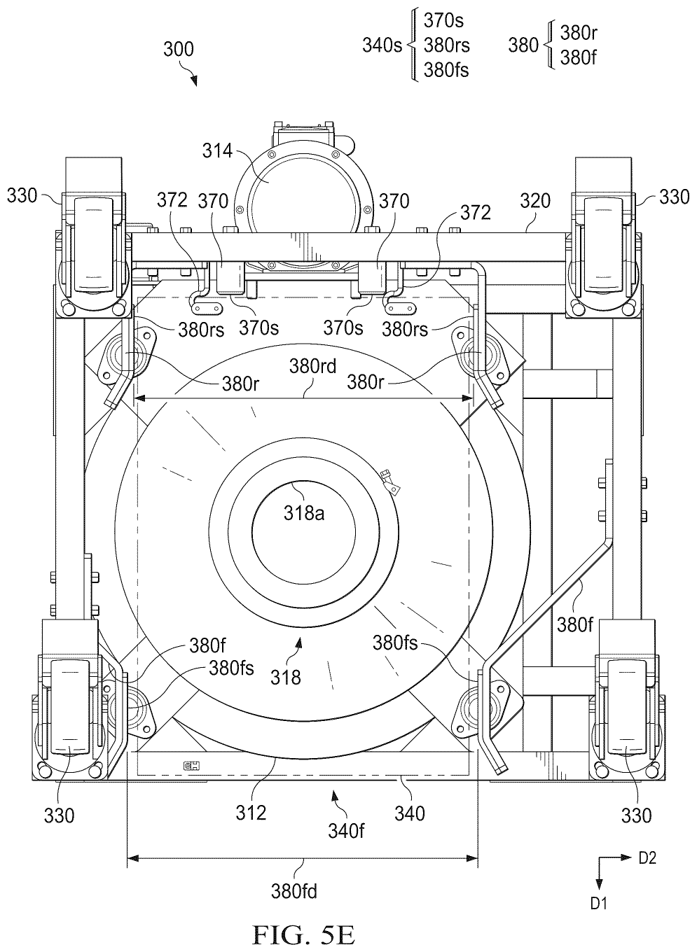

FIGS. 5A, 5B, 50, 5D, and 5E are views of a supply assembly 300, according to some example embodiments. FIG. 5A is a top, right, rear perspective view of a supply assembly 300, according to some example embodiments. FIG. 5B is a top, right, front perspective view of the supply assembly 300 of FIG. 5A, according to some example embodiments. FIG. 5C is a side elevation view of the supply assembly 300 of FIG. 5A, according to some example embodiments. FIG. 5D is a front elevation view of the supply assembly 300 of FIG. 5A, according to some example embodiments. FIG. 5E is a bottom plan view of the supply assembly 300 of FIG. 5A, according to some example embodiments. The supply assembly 300 shown in FIGS. 5A to 5E may be the same as the supply assembly 300 of the feed assembly 100 as shown in FIGS. 3A to 3G, but example embodiments are not limited thereto.

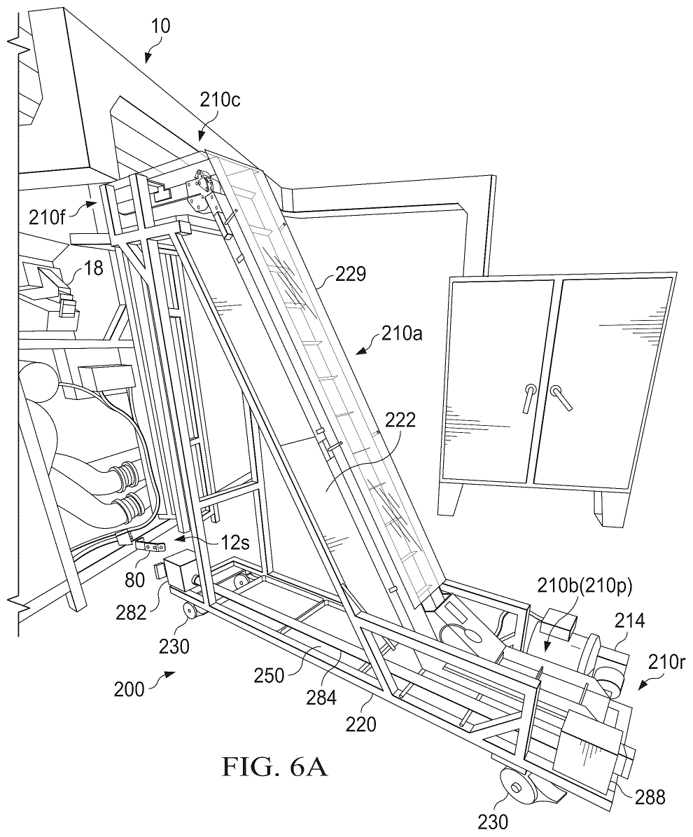

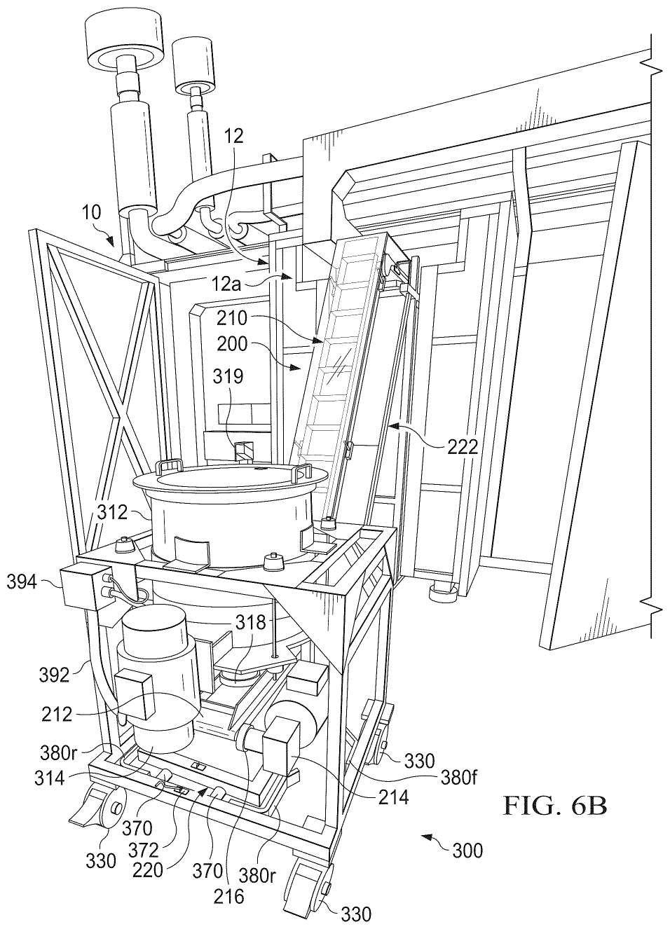

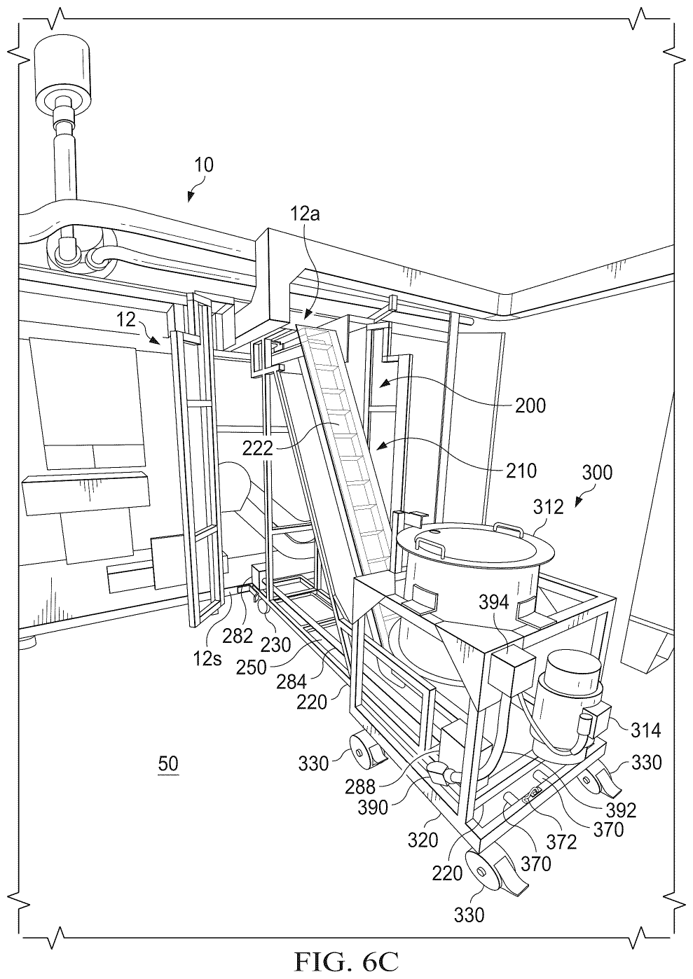

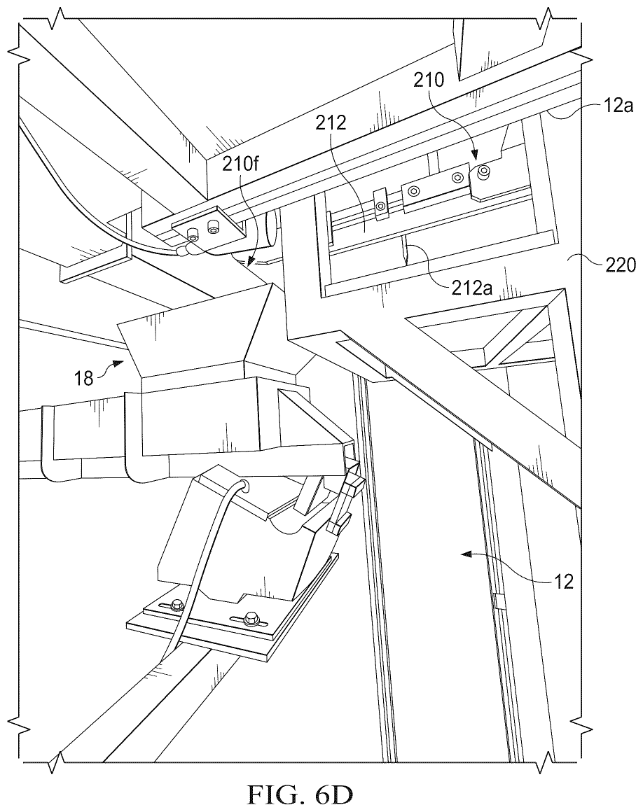

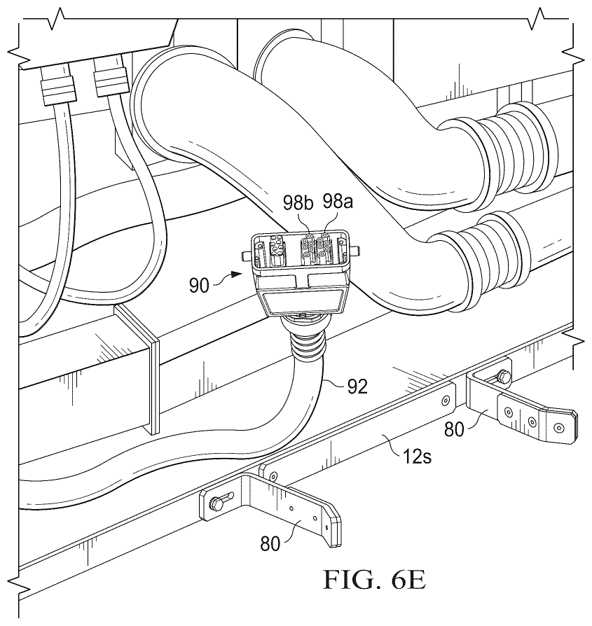

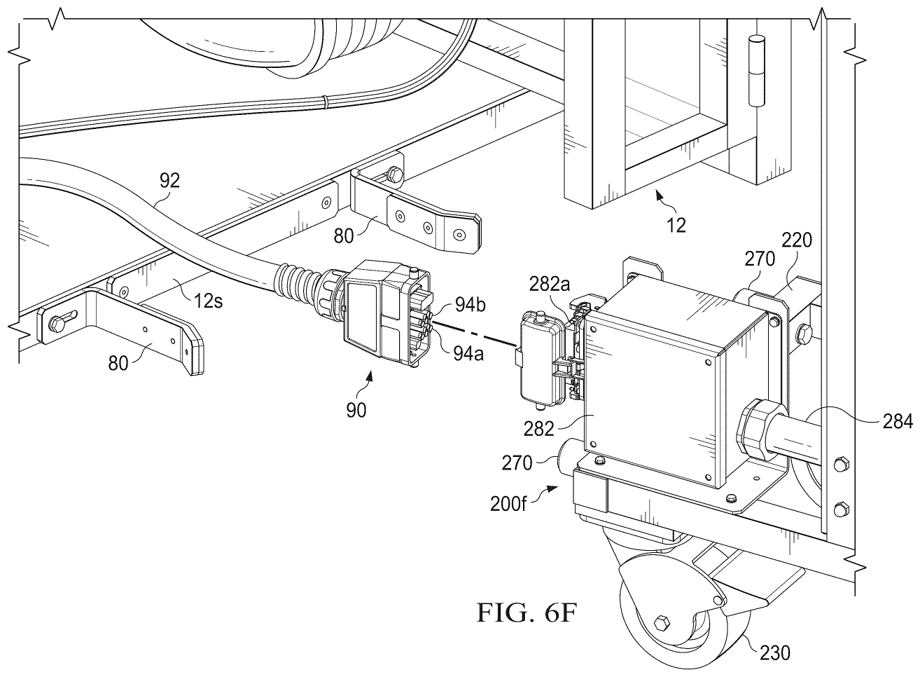

FIGS. 6A, 6B, 6C, 6D, 6E, and 6F are images of a feed assembly 100 and a manufacturing machine 10, according to some example embodiments. FIGS. 6A, 6B, and 6C are images of a feed assembly 100 aligned with a manufacturing machine 10 according to some example embodiments. FIG. 6D is an image of a front end 210f of the conveyor belt apparatus 210 of the feed assembly 100 shown in FIGS. 6A to 6C aligned with an intake port 12a of a manufacturing machine 10, according to some example embodiments. FIG. 6E is an image of a machine electrical connector 90 of a manufacturing machine 10, according to some example embodiments. FIG. 6F is an image of the machine electrical connector 90 of FIG. 6F and a first electrical junction box 282 of a conveyor assembly 200 of a feed assembly 100, according to some example embodiments. The manufacturing machine 10 shown in FIGS. 6A to 6F may be the same as the manufacturing machine 10 shown in FIGS. 1 and 2A-2B. The feed assembly 100 shown in FIGS. 6A to 6F may be the same as the feed assembly 100 shown in FIGS. 1, 2A-2B, and 3A to 3G, but example embodiments are not limited thereto. The conveyor assembly 200 shown in FIGS. 6A to 6F may be the same as the conveyor assembly 200 as shown in FIGS. 1, 2A and 2B, 3A to 3G, and 4A to 4H, but example embodiments are not limited thereto. The supply assembly 300 shown in FIGS. 6A to 6F may be the same as the supply assembly 300 as shown in FIGS. 1, 2A and 2B, 3A to 3G, and 5A to 5E, but example embodiments are not limited thereto.

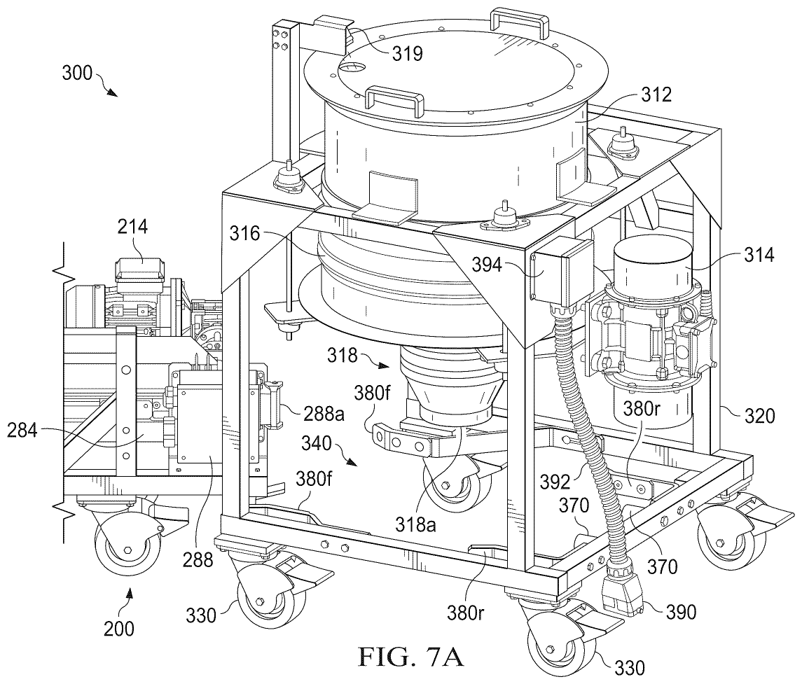

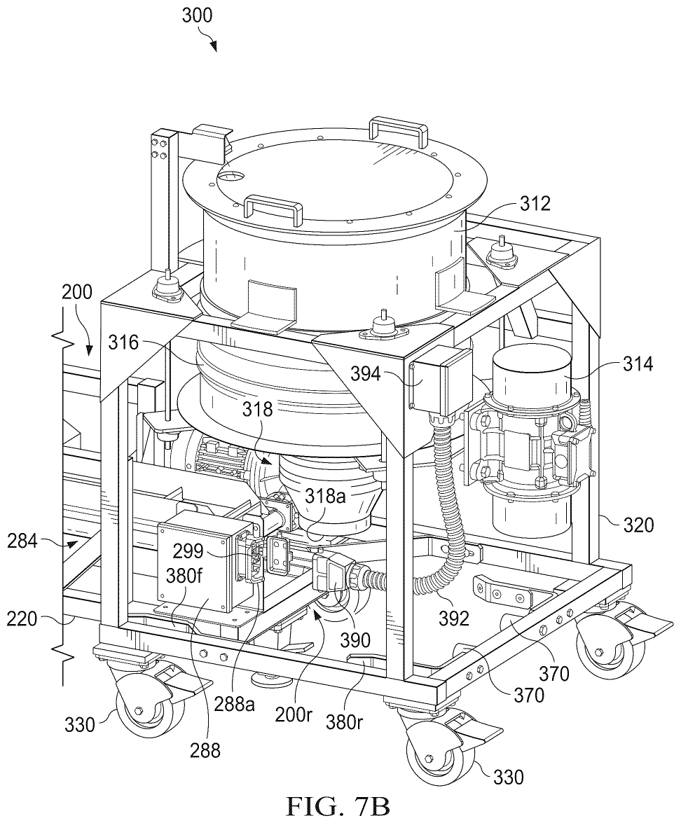

FIGS. 7A and 7B are images of a supply assembly 300, according to some example embodiments. FIG. 7A is an image of a supply assembly 300 of a feed assembly 100, according to some example embodiments. FIG. 7B is an image of the supply assembly 300 of FIG. 7A with a supply electrical connector 390 and a second electrical junction box 288 of a conveyor assembly 200 of a feed assembly 100, according to some example embodiments. The supply assembly 300 shown in FIGS. 7A and 7B may be the same as the supply assembly 300 shown in FIGS. 1, 2A and 2B, 3A to 3G, and 5A to 5E, but example embodiments are not limited thereto.

Referring to at least FIGS. 1, 2A and 2B, 3A to 3G, 4A to 4H, and 6A to 6G, in some example embodiments, a feed assembly 100 may include a conveyor assembly 200 and a supply assembly 300. The supply assembly 300 may hold an amount of a material 2 (e.g., a bulk material) and may controllably dispense (e.g., meter, index, etc.) one or more amounts of the material 2 through a discharge port (e.g., based on operating a driven member to cause controlled dispensing of bulk material through the discharge port). The supply assembly 300 may be adjustably positioned (located) so as to align (e.g., vertically overlap) the discharge port with a portion of the conveyor assembly 200 (e.g., a rear portion of a conveyor belt apparatus of the conveyor assembly 200), so that the supply assembly 300 is configured to discharge the material 2 onto the conveyor assembly 200. The conveyor assembly 200 may include a conveyor belt apparatus 210 operable to controllably convey (e.g., move) the material 2 received from the supply assembly 300 to move away from a rear end 210r of the conveyor belt apparatus 210 towards the front end 210f of the conveyor belt apparatus 210. The conveyor belt apparatus may be further operable to discharge the conveyed material 2 from the front end 210f of the conveyor belt apparatus 210. The conveyor assembly 200 may be configured to be positioned at a particular position 100p on a support surface 50 in relation to the manufacturing machine 10 (e.g., in relation to an intake port thereof, which may be at least one of intake ports 12a, 18a, or 14a) to align the front portion 200f of the conveyor assembly 200 with the manufacturing machine 10 so as to align the front end 210f of the conveyor belt apparatus 210 with the intake port 10a of the manufacturing machine 10. The supply assembly 300 may be further located at the particular position 100p to be aligned with the conveyor assembly 200, such that the feed assembly 100 is established at the particular position 100p and aligned with the manufacturing machine 10. The aligned conveyor belt apparatus 210 may be controllable to discharge material 2 from the front end 210f into a particular portion of the manufacturing machine 10 (e.g., the vibratory pan feeder 18 via an intake port 18a that is at least partially overlapping the front end 210f of aligned the conveyor belt apparatus 210 in the third direction D3) to enable the material 2 to be provided to the dispenser 14.

As shown in FIGS. 2A and 2B, the dispenser 14 may be vertically stacked (e.g., stacked in the third direction D3) above the packaging device 16 to enable the dispenser 14 to dispenser amounts of material 2 to the packaging device 16 at least partially under the influence of gravity. As a result, the dispenser intake port 14a is located at a certain level L3 (height) in the third direction D3 above the support surface 50 that is supporting the manufacturing machine 10. Additionally, in example embodiments of the manufacturing machine 10 that include a vibratory pan feeder 18, the vibratory pan feeder intake port 18a may be located at a higher vertical height (level) than the level L3 of the dispenser intake port 14a, for example level L4 as shown in FIG. 2B, to configure the vibratory pan feeder 18 to dispense material 2 through the discharge end 18b thereof to fall under gravity into the dispenser 14 through the dispenser intake port 14a. Accordingly, in some example embodiments the feed assembly 100 is configured to supply (feed) the material 2 to the manufacturing machine 10 so that the material 2 is supplied (discharged) into the manufacturing machine 10 at a level above the support surface 50 that is equal to or greater than the level L3 of the dispenser intake port 14a, the level L4 of the vibratory pan feeder intake port 18a, or a combination thereof.

In some example embodiments, the conveyor assembly 200 is configured to convey material 2 received at the rear conveyor section 210p of the conveyor belt apparatus 210 (said rear conveyor section 210p extending from the rear end 210r of the conveyor belt apparatus 210) to be lifted from a first level L1 above the support surface 50 in the third direction D3 to a second level L2 above the support surface 50 in the third direction D3, where the second level L2 is above the first level L1 in the third direction D3. The first level L1 may be relatively close to the support surface 50 (e.g., below the level L3 of the dispenser intake port 14a in the third direction D3, below the level L4 of the vibratory pan feeder intake port 18a in the third direction D3, or the like). The second level L2 may be aligned (e.g., at least partially overlapping in the first direction D1) the housing intake port 12a and which is equal to or greater than at least the level L3 of the dispenser intake port 14a, and in some example embodiments equal to or greater than the level L4 of the vibratory pan feeder intake port 18a. As a result, the supply apparatus 310 of the supply assembly 300 may be positioned relatively close to the support surface 50 in the third direction D3, for example such that the discharge port 318a is at a level that is between the first and second levels L1 and L2 in the third direction D3 and may be is below at least one of the level L4 of the vibratory pan feeder intake port 18a in the third direction D3 or the level L3 of the dispenser intake port 14a in the third direction D3.

Based on the feed assembly configuring the supply apparatus 310 to be positioned so that the discharge port 318a is located relatively close to the support surface 50 (e.g., below level L3) in the vertical direction D3, instead of being positioned such that the discharge port 318a is at or above at least level L3, the supply apparatus 310 of the supply assembly 300 may be configured to be filled with additional material 2 relatively easily by one or more operators without requiring said one or more operators to ascend to a great height (level) over the support surface 50 in the third direction D3. As a result, the feed assembly 100 may be configured to enable improved operator safety and reduced capital expenses associated with lifting the supply apparatus 310 to a greater height and building and maintaining structures to enable operators to ascend to the greater height of the supply apparatus 310 to add more material 2 thereto, maintain the supply apparatus 310, or the like. The feed assembly 100, based on providing the conveyor assembly 200 having a conveyor belt apparatus 210 that is at least partially inclined so as to be configured to lift conveyed material from the first level L1 to the second level L2, may be configured to provide material 2 discharged from the supply apparatus 310 at the lower level L1 into the manufacturing machine 10 at a higher level (e.g., L2) that enables the material 2 to fall in the third direction D3 from the front end 210f of the conveyor belt apparatus 210 into a device of the manufacturing machine 10 (e.g., into the vibratory pan feeder 18 via the intake port 18a thereof) under gravity without requiring redesign of the manufacturing machine 10 to lower the level of any of the intake ports 12a, 14a, or 18a to accommodate material conveyed from the supply apparatus 310 at a level that is lower than level L3.

In some example embodiments, the feed assembly 100 is movable over the support surface 50 in relation to the manufacturing machine 10 (e.g., based on rolling or sliding engagement of members of the conveyor assembly 200 and/or the supply assembly 300) to enable the feed assembly 100 (e.g., the conveyor assembly 200 and/or the supply assembly 300) to be adjustably repositioned in relation to the manufacturing machine 10. As shown, the conveyor assembly 200 and the supply assembly 300 may be provided as separate assemblies having separate frames and separate sets of one or more rollers and may be configured to be independently movable over the support surface 50. The independently movable conveyor assembly 200 and supply assembly 300 may be aligned with each other to establish the feed assembly 100 in alignment with the manufacturing machine at a particular position 100p that is aligned with the manufacturing machine 10 where the front end 210f of the conveyor belt apparatus 210 is aligned with an intake port 10a of the manufacturing machine 10.

Based on being independently movable, one or both of the conveyor assembly 200 and the supply assembly 300 may be configured to be independently moved and/or repositioned in relation to the particular position 100p and/or the manufacturing machine 10, and/or each other. Such configuration of the conveyor and supply assemblies 200 and 300 to be independently moved and/or repositioned may enable improved ease of maintenance of the conveyor assembly 200 and/or the supply assembly 300, as the conveyor assembly 200 and/or the supply assembly 300 may be independently moved to a location to enable improved access to elements thereof for maintenance and cleaning. Such configuration of the conveyor and supply assemblies 200 and 300 to be independently moved and/or repositioned may enable improved ease of replacement of the conveyor assembly 200 and/or the supply assembly 300 with replacement copies thereof. Such configuration of the conveyor and supply assemblies 200 and 300 to be independently moved and/or repositioned may enable improved ease of access to portions of the manufacturing machine 10 that are at least partially obscured when the feed assembly 100 is located at the particular position 100p, to thereby improve ease of maintenance and/or cleaning of a region at or around the particular position 100p. Such configuration of the conveyor and supply assemblies 200 and 300 to be independently moved and/or repositioned may enable improved flexibility of movement of the conveyor assembly 200 and/or the supply assembly 300, may enable selective replacement of a limited portion of the feed assembly 100 for maintenance (e.g., replacing the supply assembly 300 for cleaning of the supply apparatus 310 while keeping the conveyor assembly 200 at the particular position 100p and thus aligned with the manufacturing machine 10, etc.).

Referring to the conveyor assembly 200, and further referring to at least FIGS. 1, 2A and 2B, 3A to 3G, 4A to 4H, and 6A to 6F, in some example embodiments the conveyor assembly 200 may include a conveyor belt apparatus 210. The conveyor belt apparatus 210 may extend from a rear end 210r to a front end 210f along a longitudinal axis 210x of the conveyor belt apparatus 210 (which may be the same as the longitudinal axis 200x of the conveyor assembly 200 and which may extend parallel to the first direction D1 as shown and perpendicular to both the second and third directions D2 and D3 when the conveyor assembly 200 is at the particular position 100p in relation to the manufacturing machine 10). The conveyor belt apparatus 210 may have a front conveyor section 210s that is adjacent to the front end 210f, a rear conveyor section 210p that is adjacent to the rear end 210r and a central conveyor section 210q extending between (e.g., directly between) the front conveyor section 210s and the rear conveyor section 210p. The conveyor belt apparatus 210 may include a conveyor belt 212 that may extend in a loop around one or more rollers. The conveyor belt apparatus 210 may include a conveyor driver 214 configured to drive one or more of the rollers (e.g., one or more driven rollers 216) to cause movement of the conveyor belt 212 around the loop to move material 2 on the conveyor belt 212 towards the front end 210f of the conveyor belt apparatus 210. The conveyor belt apparatus 210 may include one or more wall structures 227 and/or cover structures 229 configured to mitigate premature loss of material 2 being conveyed on the conveyor belt 212 and/or addition of foreign material onto the conveyor belt 212. The conveyor belt apparatus 210 may be configured to operate the conveyor belt 212 to move one or more amounts, portions, etc. of material 2 (e.g., bulk material) on the conveyor belt 212 away from the rear end 210r and towards the front end 210f.

As shown, the conveyor belt 212 may include a set of cleats 212a that each extending transversely across the width of the conveyor belt 212 and are further spaced apart from each other along the length of the conveyor belt 212. Adjacent cleats 212a of the conveyor belt 212 may define a partitioned conveyor belt section 212b of the conveyor belt 212. Accordingly, the set of cleats 212a may partition the conveyor belt 212 along the length direction thereof into a plurality of longitudinal conveyor belt sections 212b. The conveyor belt 212 may be configured to convey (move, transport, etc.) separate portions of material received 2 from the supply assembly 300 in separate, respective longitudinal conveyor belt sections 212b based on being operated to move along a loop such that the portion of the conveyor belt 212 at the upper end of the loop moves from the rear end 210r to the front end 210f.

The conveyor belt apparatus 210 may include a conveyor driver 214 and one or more driven rollers 216 which may be coupled (e.g., mechanically coupled) to the conveyor driver 214 (e.g., in a direct drive configuration, via a transmission, or the like). The conveyor driver 214 may be any known driver (e.g., any known electric motor) and may be configured to operate to drive a driven roller 216. The conveyor belt 212 may extend over at least a portion of the one or more driven rollers 216 to be in contact with the one or more driven rollers 216, such that the conveyor driver 214 may drive the driven roller 216 to rotate to cause the conveyor belt 212 to move along a closed loop track. As shown, the conveyor belt apparatus 210 may include a driven roller 216 at the rear end 210r of the conveyor belt apparatus 210 and may be driven by the conveyor driver 214 to cause the conveyor belt 212 to move along the closed loop track such that the upper portion of the conveyor belt 212 facing upwards (away from the support surface 50) in the third direction D3 is caused to move from the rear end 210r to the front end 210f of the conveyor belt apparatus 210. However, example embodiments are not limited thereto, and the one or more driven rollers 216 may be at any location in the conveyor belt apparatus 210.

Still referring to at least FIGS. 1, 2A and 2B, 3A to 3G, 4A to 4H, and 6A to 6F, in some example embodiments, the conveyor assembly 200 may include a conveyor frame 220 coupled to the conveyor belt apparatus 210. The conveyor frame 220 may comprise a framework, including for example a load-bearing framework, of one or more structural beams, tubes, or the like. The conveyor frame 220 may be configured to at least partially structurally support some or all of a structural load of one or more elements of the conveyor assembly 200. For example, the conveyor frame 220 may be coupled to at least the conveyor belt apparatus 210 (interchangeably referred to as the conveyor belt apparatus 210 being coupled to the conveyor frame 220), and the conveyor frame 220 may be configured to at least partially structurally support a structural load (e.g., weight) of at least the conveyor belt apparatus 210. The conveyor frame 220 may further structurally support additional portions of the conveyor assembly 200. In some example embodiments, the conveyor frame 220 may include a weldment of multiple structural beams, including a weldment of tube structures as shown. However, example embodiments are not limited thereto, and the conveyor frame 220 may include any one or more structures coupled to the conveyor belt apparatus 210 and/or any one or more structures which may be configured to structurally support a load of at least the conveyor belt apparatus 210. The conveyor frame 220 may serve as a load-bearing structural framework of the conveyor assembly 200, and various elements of the conveyor assembly 200 may be coupled to the conveyor frame 220 and may be structurally supported (e.g., the load of said various elements may be supported) by the conveyor frame 220.

Still referring to at least FIGS. 1, 2A and 2B, 3A to 3G, 4A to 4H, and 6A to 6F, in some example embodiments, the conveyor assembly 200 may include one or more conveyor rollers 230. The one or more conveyor rollers 230 may be coupled to an underside of the conveyor frame 220. The one or more conveyor rollers 230 may be configured to rest on a support surface 50 and may be configured to at least partially support at least the conveyor frame 220 and the conveyor belt apparatus 210 on the support surface 50. For example, the conveyor frame 220 and the one or more conveyor rollers 230 may be configured to transmit some or all of the structural load (e.g., weight) of at least the conveyor belt apparatus 210 to the support surface 50. Accordingly, the conveyor assembly 200 may be at least partially structurally supported on a support surface 50 (e.g., a floor) by the one or more conveyor rollers 230.

As shown, the conveyor assembly 200 may include four conveyor rollers 230 coupled to the underside of the conveyor frame 220 at separate, respective corners of a rectangular plan area defined by the conveyor frame 220. However, example embodiments are not limited thereto, and the conveyor assembly 200 may include any quantity of conveyor roller 230 coupled to the conveyor frame 220 at any locations in relation to the conveyor frame 220.

The one or more conveyor rollers 230 may be configured to engage in rolling contact with a support surface 50 and thus enable the conveyor assembly 200 to be moved over the support surface 50 while continuing to structurally support the conveyor assembly 200 on the support surface 50. As a result, and as shown in FIGS. 1, 2A, and 2B, the conveyor assembly 200 may be configured to be movably positioned (e.g., moved, translated, rotated, etc.) to a particular position to align the front end 210f of the conveyor belt apparatus 210 with an intake port of an external structure such as an intake port 10a of the manufacturing machine 10 (e.g., one or more of intake ports 12a, 18a, or 14a). As described herein, aligning the front end 210f with the intake port of an external structure such as the manufacturing machine 10 may include positioning the front end 210f to at least partially overlap the intake port (e.g., intake port 18a) in at least one of the first direction D1, the second direction D2, or the third direction D3. As shown in at least FIGS. 1, 2A, and 2B, the conveyor assembly 200 may be movably positioned to the particular position 100p in relation to the manufacturing machine 10 to align the front end 210f of the conveyor belt apparatus 210 to at least partially overlap the intake port 18a in the third direction D3.

Referring to the supply assembly 300, and further referring to at least FIGS. 1, 2A and 2B, 3A to 3G, 5A to 5E, 6A to 6F, and 7A and 7B, in some example embodiments the supply assembly 300 may include a supply apparatus 310. The supply apparatus 310 may be configured to hold an amount of a material 2 (e.g., a bulk material, a granular material, filler material, any combination thereof, or the like) and may be configured to controllably discharge (e.g., dispense, feed, supply, etc.) the material 2 through a discharge port 318a. The supply apparatus 310 may be configured to periodically discharge a particular amount (e.g., mass and/or volume) of the material 2 through the discharge port 318a at a particular interval.

As shown, the supply apparatus 310 may include a static bin 312. The static bin 312 may be a cylindrical container configured to hold an amount of bulk material therein. It will be understood that example embodiments are not limited thereto, and the static bin 312 may be any container configured to hold bulk material therein. The supply apparatus 310 may include a supply driver 314 and one or more driven members 316 which may be coupled (e.g., mechanically coupled) to the supply driver 314 (e.g., in a direct drive configuration, via a transmission, or the like). The supply driver 314 may be any known driver (e.g., any known electric motor) and may be configured to operate to drive the one or more driven members 316. The one or more driven members 316 may include a diaphragm, membrane, baffle, plate, or the like located within an enclosure of the supply apparatus 310. As shown, the one or more driven members 316 may be located within the static bin 312, but example embodiments are not limited thereto. The one or more driven members 316 may be located at the bottom end 312a of the static bin 312, but example embodiments are not limited thereto and the one or more driven members 316 may be located at any location within an enclosure at least partially defined by the static bin 312.

The supply apparatus 310 may include a discharge structure 318 coupled to the bottom end 312a of the static bin 312 and defining a discharge port 318a of the supply apparatus 310. As shown, the discharge structure 318 may be a funnel extending and tapering below the bottom end 312a of the static bin 312 and may be below the driven member 316, but example embodiments are not limited thereto. As shown, the discharge structure 318 may define the discharge port 318a to have a central axis directed in the third direction D3 so that the discharge port 318a faces downwards, but example embodiments are not limited thereto.

In some example embodiments, the supply apparatus 310 may include a live bottom bin, such that the driven member 316 includes a vibratory baffle at the bottom end 312a of the static bin 312 and mechanically coupled to the supply driver 314, and the discharge structure 318 includes a funnel connected to the bottom end 312a of the static bin 312 and tapering from the bottom end 312a downwards in the third direction D3 to define the discharge port 318a. However, example embodiments of the supply apparatus 310 are not limited thereto.

As shown, the supply apparatus 310 may include a level sensor device 319 which may be configured to generate sensor data, and transmit the sensor data as one or more sensor data signals, indicating a level (depth) of bulk material held within the static bin 312. The level sensor device 319 may be configured to be electrically coupled to a controller 20 of the manufacturing system 1, and the controller 20 may be configured to process sensor data signals transmitted by the level sensor device 319 to determine a level of bulk material held in the static bin 312 and, in response to a determination that the level is below a threshold level value (which may be stored at a memory of the controller 20), transmit a warning signal indicating that additional bulk material is to be added to the static bin 312. The level sensor device 319 may be any known sensor device configured to generate sensor data indicating a level of a material in a region of space, including for example any known optical or laser level sensor devices.

Still referring to at least FIGS. 1, 2A and 2B, 3A to 3G, 5A to 5E, 6A to 6F, and 7A and 7B, in some example embodiments, the supply assembly 300 may include a supply frame 320 coupled to the supply apparatus 310. The supply frame 320 may comprise a framework, including for example a load-bearing framework, of one or more structural beams, tubes, or the like. The supply frame 320 may be configured to at least partially structurally support some or all of a structural load of one or more elements of the supply assembly 300. For example, the supply frame 320 may be coupled to at least the supply apparatus 310 (interchangeably referred to as the supply apparatus 310 being coupled to the supply frame 320), and the supply frame 320 may be configured to at least partially structurally support a structural load (e.g., weight) of at least the supply apparatus 310. The supply frame 320 may further structurally support additional portions of the supply assembly 300. In some example embodiments, the supply frame 320 may include a weldment of multiple structural beams, including a weldment of tube structures as shown. However, example embodiments are not limited thereto, and the supply frame 320 may include any one or more structures coupled to the supply apparatus 310 and/or any one or more structures which may be configured to structurally support a load of at least the supply apparatus. The supply frame 320 may serve as a load-bearing structural framework of the supply assembly 300, and various elements of the supply assembly 300 may be coupled to the supply frame 320 and may be structurally supported (e.g., the load of said various elements may be supported) by the supply frame 320.

Still referring to at least FIGS. 1, 2A and 2B, 3A to 3G, 5A to 5E, 6A to 6F, and 7A and 7B, in some example embodiments, the supply assembly 300 may include one or more supply rollers 330. The one or more supply rollers 330 may be coupled to an underside of the supply frame 320. The one or more supply rollers 330 may be configured to rest on the support surface 50 and may be configured to at least partially support at least the supply frame 320 and the supply apparatus 310 on the support surface 50. For example, the supply frame 320 and the one or more supply rollers 330 may be configured to transmit some or all of the structural load (e.g., weight) of at least the supply apparatus 310 to the support surface 50. Accordingly, the supply assembly 300 may be at least partially structurally supported on a support surface 50 (e.g., a floor) by the one or more supply rollers 330.

As shown, the supply assembly 300 may include four supply rollers 330 coupled to the underside of the supply frame 320 at separate, respective corners of a rectangular plan area defined by the supply frame 320. However, example embodiments are not limited thereto, and the supply assembly 300 may include any quantity of supply rollers 330 coupled to the supply frame 320 at any locations in relation to the supply frame 320.

The one or more supply rollers 330 may be configured to engage in rolling contact with a support surface 50 and thus enable the supply assembly 300 to be moved over the support surface 50 while continuing to structurally support the supply assembly 300 on the support surface 50. As a result, and as shown in FIGS. 1, 2A, 2B, and 3A to 3G, the supply assembly 300 may be configured to be movably positioned to align the discharge port 318a of the supply apparatus 310 with at least the rear conveyor section 210p of the conveyor belt apparatus 210 at or proximate to the rear end 210r thereof. As described herein, aligning the discharge port 318a with at least the rear conveyor section 210p of the conveyor belt apparatus 210 may include positioning the supply apparatus 310 to at least partially overlap the rear conveyor section 210p of the conveyor belt apparatus 210 in at least the third direction D3 so that the discharge port 318a at least partially overlaps the conveyor belt 212 at the rear conveyor section 210p of the conveyor belt apparatus 210. Such alignment of the supply assembly 300 with the conveyor assembly 200 may configure the supply apparatus 310 to discharge material 2 held therein through the discharge port 318a onto the conveyor belt 212 of conveyor belt apparatus 210 at the rear conveyor section 210p thereof, and the conveyor belt apparatus 210 may be operated to cause the conveyor belt 212 to move to convey such material to be conveyed towards the front end 210f of the conveyor belt apparatus 210 and discharged from the conveyor assembly 200 at the front end 210f.

In some example embodiments, including the example embodiments shown in FIGS. 1, 2A and 2B, 3A to 3G, 4A to 4H, 5A to 5E, 6A to 6F, and 7A and 7B, one or more of the conveyor rollers 230 may include a caster wheel, referred to herein as a conveyor caster wheel. Each conveyor caster wheel may be pivotably coupled to the conveyor frame 220 to enable translation and/or rotation of the conveyor assembly 200 in the first and/or second directions D1 and/or D2 on the support surface 50, thereby improving freedom of movement of the conveyor assembly 200 on the support surface 50. As further shown, in some example embodiments one or more of the supply rollers 330 may include a caster wheel, referred to herein as a supply caster wheel. Each supply caster wheel may be any known caster wheel and may be pivotably coupled to the supply frame 320 to enable translation and/or rotation of the supply assembly 300 in the first and/or second directions D1 and/or D2 on the support surface 50, thereby improving freedom of movement of the supply assembly 300 on the support surface 50.

In some example embodiments, the conveyor assembly 200 and the supply assembly 300 are each configured to be independently moved over the support surface 50 in order to be moved in relation to the manufacturing machine 10 and to be adjustably positioned (located) at a particular position 100p that is aligned with the manufacturing machine 10, for example such that a front end 210f of a conveyor belt apparatus 210 of a conveyor assembly 200 may be aligned (e.g., at least partially overlapping in the third direction D3) with one or more intake ports of the manufacturing machine 10 (e.g., intake port 18a) based on the conveyor assembly 200 being positioned at the particular position 100p. The conveyor assembly 200 may be configured to be moved to the particular position 100p to cause the front end 210f of the conveyor belt apparatus 210 to be aligned with an intake port 10a of the manufacturing machine 10 (e.g., at least one of intake ports 12a, 18a, or 14a), and the supply assembly 300 may be configured to be moved to the particular position 100p and to be aligned with the conveyor assembly 200 so that the discharge port 318a at least partially overlaps the rear conveyor section 210p of the conveyor belt apparatus 210 and thus at least partially overlaps the conveyor belt 212 at the rear conveyor section 210p in the third direction D3. Alignment of the front end 210f of the conveyor belt apparatus 210 with an intake port 10a of the manufacturing machine 10 may be referred to herein as alignment of the conveyor assembly 200 with the manufacturing machine 10. Based on such alignments of the conveyor assembly 200 and the supply assembly 300, the feed assembly 100 may be configured to supply (feed) a material (e.g., bulk material) to be discharged from the supply apparatus 310 to the conveyor belt 212 at the rear conveyor section 210p of the conveyor belt apparatus 210 and conveyed by the conveyor belt apparatus 210 from the rear conveyor section 210p to the front end 210f of the conveyor belt apparatus 210 to be discharged by the conveyor belt apparatus 210 from the front end 210f into the manufacturing machine 10 (e.g., to the vibratory pan feeder 18 via the intake port 18a thereof that is aligned with the front end 210f) to be conveyed to the dispenser 14. It will be understood that alignment (e.g., at least partially vertical overlap in the third direction D3) of the discharge port 318a with the conveyor belt 212 at the rear conveyor section 210p of the conveyor belt apparatus 210 may be referred to interchangeably herein as alignment (e.g., at least partially vertical overlap in the third direction D3) of the discharge port 318a with the rear conveyor section 210p of the conveyor belt apparatus 210.

In some example embodiments, the conveyor assembly 200 is configured to be moved to a particular position in relation to the manufacturing machine 10 and to at least partially inhibit movement of the conveyor assembly 200 from the particular position, so as to at least partially fix the conveyor assembly 200 in place in relation to the manufacturing machine 10. For example, where the conveyor assembly 200 is moved to be located at a particular position 100p that aligns the front end 210f of the conveyor belt apparatus 210 with an intake port (e.g., intake port 18a) of the manufacturing machine 10, the conveyor assembly 200 may be configured to be at least partially fixed in place on the support surface 50 at the particular position 100p so as to at least partially inhibit movement of the conveyor assembly 200 away from the particular position 100p and thus at least partially inhibit movement of the conveyor assembly 200 in relation to the manufacturing machine 10 and/or intake port thereof. Similarly, in some example embodiments, the supply assembly 300 is configured to be moved to the particular position 100p in relation to the manufacturing machine 10 (e.g., to align the discharge port 318a with the rear conveyor section 210p of the conveyor belt apparatus 210) and to at least partially inhibit movement of the supply assembly 300 from the particular position 100p, so as to fix the supply assembly 300 in place in relation to the conveyor assembly 200. For example, where the supply assembly 300 is moved to be located at a particular position 100p that aligns the discharge port 318a with the rear conveyor section 210p of the conveyor belt apparatus 210, the supply assembly 300 may be configured to be at least partially fixed in place on the support surface 50 at the particular position 100p so as to at least partially inhibit movement of the supply assembly 300 away from the particular position 100p and thus at least partially inhibit movement of the supply assembly 300 in relation to the conveyor assembly 200 and/or the manufacturing machine 10.

In some example embodiments, at least one roller of the one or more conveyor rollers 230, at least one roller of the one or more supply rollers 330, or any combination thereof may include one or more brakes, locks, or the like that are configured to adjustably engage a roller, wheel, the support surface 50, or the like to at least partially inhibit movement of a respective one of the conveyor assembly 200 or the supply assembly 300 over the support surface 50. For example, at least one roller of the one or more conveyor rollers 230 or the one or more supply rollers 330 may include one or more locking caster wheels configured to adjustably lock or brake the respective one or more wheels thereof in place. In the example embodiments shown in FIGS. 1, 2A and 2B, 3A to 3G, 4A to 4H, 5A to 5E, 6A to 6F, and 7A to 7B, the conveyor assembly 200 includes four conveyor rollers 230 that are each a locking caster wheel and the supply assembly 300 includes four supply rollers 330 that are each a locking caster wheel. However, example embodiments are not limited thereto. For example, one or more conveyor rollers 230 may be a locking caster wheel and one or more other conveyor rollers 230 may not be a locking conveyor roller (e.g., a non-locking caster wheel). In another example, one or more supply rollers 330 may be a locking caster wheel and one or more other supply rollers 330 may not be a locking conveyor roller (e.g., a non-locking caster wheel).

In some example embodiments, at least one assembly of the conveyor assembly 200 or the supply assembly 300 may include a locking device that is configured to engage the support surface 50 independently of a roller of the at least one assembly to at least partially inhibit movement of the at least one assembly in relation to the support surface 50. Such a locking device may include, for example, any known floor lock device. For example, as shown, the conveyor assembly 200 may include a floor lock device 250 (also referred to herein interchangeably as a floor lock) that is coupled to the conveyor frame 220 and which may be configured to engage the support surface 50 to at least partially inhibit movement of the conveyor assembly 200 in relation to the support surface 50 (e.g., based on the conveyor assembly 200 being positioned at the particular position 100p). In some example embodiments, the supply assembly 300 may include a floor lock, such as floor lock device 250 for example, coupled to the supply frame 320. However, example embodiments are not limited thereto, and in some example embodiments the floor lock device 250 may be omitted from one or both of the conveyor assembly 200 or the supply assembly 300. Accordingly, in some example embodiments, at least one frame of the conveyor frame 220 or the supply frame 320 may include (e.g., may be coupled to a floor lock that is configured to engage the support surface 50 to hold the at least one frame (and thus a corresponding assembly of the conveyor assembly 200 or the supply assembly 300 that includes the at least one frame) in place in relation to the support surface 50.

In some example embodiments, the conveyor belt apparatus 210 is at least partially inclined, for example in relation to the support surface 50, the first direction D1, or any combination thereof, to extend at least partially vertically (e.g., in the third direction D3) from a first level L1 to a second level L2, where the second level L2 is greater than the first level L1. As a result, the conveyor belt apparatus 210 may be configured to cause the conveyor belt 212 to move around a closed loop to lift material 2 being conveyed from the rear conveyor section 210p towards the front end 210f from the first level towards the second level L2. For example, as shown, the rear conveyor section 210p (and the rear end 210r) of the conveyor belt apparatus 210, which may include the lower conveyor section 210b, may be at the first level L1. As further shown, the front conveyor section 210s (and the front end 210f) of the conveyor belt apparatus 210, which may include the upper conveyor section 210c, may be at the second level L2. As further shown, the central conveyor section 210q of the conveyor belt apparatus 210 may include and/or may define an inclined conveyor section 210a extending along the longitudinal axis 210x (e.g., along the first direction D1) between the rear and front conveyor sections 210p and 210s and further extending vertically (e.g., along the third direction D3) at least partially vertically between the first level L1 and the second level L2. As shown in FIGS. 1, 2A, and 2B, the first level L1 may be smaller than both the level L3 of the dispenser intake port 14a and the level L4 of the vibratory pan feeder intake port 18a. As further shown, the second level L2 may be equal to or greater than both the level L3 of the dispenser intake port 14a and the level L4 of the vibratory pan feeder intake port 18a. As a result, the conveyor belt apparatus 210 may be configured to convey material 2 to be lifted to a second level L2 such that the conveyor belt apparatus 210 discharges material 2 from the front end 210f to fall under gravity through an aligned (e.g., at least partially overlapping in the third direction D3) at least one intake port 10a of the manufacturing machine 10 (e.g., intake port 18a) to be supplied to dispenser 14 (e.g., via the vibratory pan feeder 18). Accordingly, the supply assembly 300 may be configured to position the supply apparatus 310 at a relatively low level such that the discharge port 318a is below levels L2, L3, and L4 and above the first level L1 while the feed assembly 100 is still configured to provide material 2 discharged from the discharge port 318a onto the aligned rear conveyor section 210p of the conveyor belt apparatus 210 to the manufacturing machine 10 at a higher level L2 that is equal to or greater than at least the level L3.

As further shown in FIGS. 1, 2A and 2B, 3A to 3G, 4A to 4H, 5A to 5E, 6A to 6F, and 7A to 7B, in some example embodiments the conveyor belt apparatus 210 may include, in addition to the inclined conveyor section 210a extending in both the first and third directions D1 and D3, at least one of a lower conveyor section 210b or an upper conveyor section 210c. The rear conveyor section 210p of the conveyor belt apparatus 210 may include and/or at least partially define the lower conveyor section 210b. The lower conveyor section 210b may extend horizontally (e.g., along or parallel to the first direction D1, along or parallel to the longitudinal axis 210x, etc.) from a lower end 210aa of the inclined conveyor section 210a to a distal end at the first level L1. The lower conveyor section 210b may be a lower flat conveyor section extending along the first direction D1 at the first level L1. The distal end of the lower conveyor section 210b may be a distal end of the rear conveyor section 210p of the conveyor belt apparatus 210, which may be the rear end 210r of the conveyor belt apparatus at the first level L1. The lower end 210aa of the inclined conveyor section 210a may be at the first level L1. The front conveyor section 210s of the conveyor belt apparatus 210 may include and/or at least partially define the upper conveyor section 210c. The upper conveyor section 210c may extend horizontally (e.g., along or parallel to the first direction D1, along or parallel to the longitudinal axis 210x, etc.) from an upper end 210ab of the inclined conveyor section 210a to a distal end at the second level L2. The upper conveyor section 210c may be an upper flat conveyor section extending along the first direction D1 at the second level L2. The distal end of the upper conveyor section 210c may be a distal end of the front conveyor section 210s of the conveyor belt apparatus 210, which may be the front end 210f of the conveyor belt apparatus at the second level L2. The upper end 210ab of the inclined conveyor section 210a may be at the second level L2. In some example embodiments, where the conveyor belt apparatus 210 includes the lower and upper conveyor sections 210b and 210c and the inclined conveyor section 210a therebetween, the conveyor belt apparatus 210 may be configured to receive a material 2 onto the conveyor belt 212 at the rear conveyor section 210p, and thus onto the conveyor belt at the lower conveyor section 210b, move the received material 2 along the rear conveyor section 210p of the conveyor belt apparatus 210 at the first level L1 to a lower end 210aa of the inclined conveyor section 210a, move the material 2 from the first level L1 to the second level L2 along the inclined conveyor section 210a, and move the material 2 along the front conveyor section 210s of the conveyor belt apparatus 210 at the second level L2 from an upper end 210ab of the inclined conveyor section 210a to the front end 210f of the conveyor belt apparatus 210. However, it will be understood that at least one of the lower conveyor section 210b or the upper conveyor section 210c may be omitted (e.g., at least one conveyor section of the rear conveyor section 210p or the front conveyor section 210s of the conveyor belt apparatus 210 may define a portion of the inclined conveyor section 210a and the at least one conveyor section may, in combination with the central conveyor section 210q, define the inclined conveyor section 210a. It will further be understood that, in some example embodiments, the inclined conveyor section 210a may be omitted (e.g., the central conveyor section 210q may be present in the conveyor belt apparatus 210 but may not be an “inclined” conveyor section and instead may extend between opposite ends thereof in the first direction D1 without extending between different levels in the third direction D3) such that the rear, central, and front conveyor sections 210p, 210q, and 210s may each at a same level (e.g., the second level L2) and the conveyor belt apparatus 210 may be configured to move material 2 from the rear end 210r to the front end 210f at a same level along the entire length of the conveyor belt apparatus 210 from the rear end 210r to the front end 210f through the rear, central, and front conveyor sections 210p, 210q, and 210s, where the same level may be the second level L2, the first level L1, or any other level.

As shown in at least FIG. 4F, in some example embodiments where the conveyor belt apparatus 210 includes an inclined conveyor section 210a and a lower conveyor section 210b extending from the lower end 210aa of the inclined conveyor section 210a, the conveyor belt apparatus 210 may include an upper roller wheel 400 and a lower roller wheel 402 that are configured to, together with the wall structures 227, direct the conveyor belt 212 passing through the lower end 210aa between conveyor sections 210b and 210a to change movement direction from extending flat (horizontally) at the lower conveyor section 210b in the first direction D1 to extend along an inclined path at the inclined conveyor section 210a in the first and third directions D1 and D3.

As shown, the conveyor assembly 200 may include a conveyor chute 224, also referred to as a discharge ramp, coupled to at least one of the conveyor belt apparatus 210 or the conveyor frame 220 at the front portion 200f (e.g., front end) of the conveyor assembly 200 and thus at the front end 210f of the conveyor belt apparatus 210. The conveyor chute 224 may be configured to be aligned with an intake port 10a of the manufacturing machine 10 (e.g., the vibratory pan feeder intake port 18a as shown in FIGS. 2A and 2B) based on the conveyor assembly 200 being positioned at the particular position 100p to align the front end 210f with the intake port. The conveyor chute 224 may be configured to direct material 2 discharged from (e.g., falling from) the front end 210f of the conveyor belt apparatus 210 towards the aligned intake port of the manufacturing machine 10 (e.g., intake port 18a) based on the conveyor assembly 200 being positioned at the particular position 100p to align the front end 210f with the intake port 12a. In some example embodiments, the conveyor chute 224 may be omitted from the conveyor assembly 200.

As further shown in at least FIG. 4F, the conveyor assembly 200 may include a level sensor device 240 that is configured to generate sensor data, and transmit the sensor data as one or more sensor data signals, indicating a level 432 (e.g., depth) of material 2a at a junction region 430 on the conveyor belt 212 of the conveyor belt apparatus 210 that is at the lower end 210aa of the inclined conveyor section 210a and thus is at the intersection (e.g., junction) of the inclined and lower conveyor sections 210a and 210b. The level sensor device 240 may be any known sensor device configured to generate sensor data indicating a level (e.g., depth) of a material in a region of space, including for example any known optical or laser level sensor devices, although example embodiments are not limited thereto.

The conveyor belt 212 may move sequential conveyor belt sections 212b through the junction region 430 based on operation of the conveyor belt apparatus 210 to cause movement of the conveyor belt 212. In some example embodiments, based on the transition between the conveyor section 210b and the upwards-directed inclined conveyor section 210a, the conveyor belt apparatus 210 is configured to operate to cause material 2 in at least one conveyor belt section 212b moving through the junction region 430 (e.g., at the lower end 210aa) to transition between moving horizontally in direction D1 to moving at an incline in both the first and vertical direction s D1 and D3. As a result, at least some of the material 2 transitioning between the horizontal movement and the inclined movement may fall back from the inclined conveyor section 210a to collect at the junction region 430 instead of continuing along the inclined conveyor section 210a towards the upper end 210ab of the inclined conveyor section 210a. While at least some of such material 2 collected at the junction region 430 may later be conveyed by the moving conveyor belt sections 212b along the inclined conveyor section 210a from the junction region 430, a persistent mass or amount of material 2a may accumulate at the junction region 430 during operation of the feed assembly 100 (e.g., during operation of both the supply apparatus 310 to discharge material 2 onto the conveyor belt 212 at the rear conveyor section 210p and operation of the conveyor belt apparatus 210 to move the material 2 to the front end 210f of the conveyor belt apparatus 210).

As shown, the conveyor belt apparatus 210 may include a shroud 410 covering the junction region 430, and the shroud 410 may have an opening 412 extending therethrough. The sensor device 240 may be exposed to the junction region 430 through the opening 412, for example such that the sensor device 240 may be a laser level sensor device configured to direct a laser beam 240b through the opening 412 and receive, through the opening 412, reflected light from the material 2a at the junction region 430 and thus may be connected to an outer surface of the shroud 410 so as to protect the sensor device 240 from material 2 being moved by the conveyor belt apparatus 210 through the junction region 430 while enabling the sensor device 240 to monitor the junction region 430 and the level 432 of material 2a at said junction region 430. As described herein, in some example embodiments the manufacturing system 1 is configured to monitor the level 432 of the material 2a at the junction region 430 and to control operation of at least one of the conveyor belt apparatus 210 or the supply apparatus 310 to control the level 432 of the material 2a at the junction region 430 to be within a certain range of level values (e.g., equal to or smaller than a particular threshold level value).

Still referring to FIGS. 1, 2A and 2B, 3A to 3G, 4A to 4H, and 6A to 6F, the conveyor assembly 200 may include one or more tray shelves 228 coupled to the conveyor frame 220 or incorporated as part of the conveyor frame 220, where the one or more tray shelves 228 are configured to support one or more catch trays 260 vertically underneath (e.g., underneath in the third direction D3) one or more portions of the conveyor belt apparatus 210. The one or more catch trays may be any known tray structure, including for example a tray having a lip or ridge structure as shown. The one or more catch trays 260 may catch excess material 2 spilling from the conveyor belt apparatus 210 or falling from the conveyor belt 212 moving along the underside of the conveyor belt apparatus 210 from the front end 210f to the rear end 210r. The one or more catch trays 260 may be removable from the one or more tray shelves 228 to enable any material caught therein to be poured from the one or more catch trays 260 into the static bin 312 of the supply apparatus 310, thereby enabling recovery of the spilled material 2 to be fed to the manufacturing machine 10 and thus minimizing material 2 loss from the manufacturing system 1 due to spillage. As shown, one or more tray shelves 228 and one or more supported catch trays 260 may be located underneath one or more of the rear, central, or front conveyor sections 210p, 210q, or 210s and for example may be located underneath each of the inclined, lower flat, and upper conveyor sections 210a to 210c. In some example embodiments, the conveyor assembly 200 may be configured to support separate catch trays 260 at same or different levels in the third direction D3, but example embodiments are not limited thereto.

As shown, in some example embodiments the conveyor assembly 200 may include an inclined catch ramp 222 vertically (e.g., in the third direction D3) underneath the inclined conveyor section 210a. The inclined catch ramp, and one or more lower tray shelves 228 configured to support one or more catch trays 260 vertically underneath the lower end 210aa of the inclined conveyor section 210a. As shown, the inclined catch ramp 222 may be configured to catch fallen material 2 falling below at least a portion of the conveyor belt apparatus 210 and direct the fallen material 2 to follow an inclined path downward towards one or more lower tray shelves 228 configured to support one or more catch trays 260 thereof, such that the inclined catch ramp 222 may direct such fallen material into one or more catch trays 260 supported by the one or more lower tray shelves 228.

Still referring to FIGS. 1, 2A and 2B, 3A to 3G, 4A to 4H, 5A to 5E, 6A to 6F, and 7A to 7B, in some example embodiments the supply assembly 300 may be configured to be movably positioned in relation to the conveyor assembly 200 to at least partially vertically overlap (align, overlap in the third direction D3, etc.) the discharge port 318a of the supply apparatus 310 over the rear conveyor section 210p of the conveyor belt apparatus 210, to enable the conveyor assembly 200 to convey, to the front end 210f, material 2 that is discharged from the discharge port 318a onto the conveyor belt 212 at the rear conveyor section 210p based on operation of the conveyor belt apparatus 210. Accordingly, the feed assembly 100 may be configured to convey (e.g., discharge, supply, feed, etc.) such material 2 from the front end 210f and to and through an intake port of an external structure (e.g., the intake port 18a of the manufacturing machine 10) based on operation of the supply apparatus 310 to discharge the material 2 to the conveyor belt apparatus 210 at the rear conveyor section 210p thereof and further operation of the conveyor belt apparatus 210 to convey the material 2 from the rear conveyor section 210p to the front end 210f of the conveyor belt apparatus 210.

As shown, in some example embodiments the supply frame 320 may include one or more structures at least partially defining an internal slot 340 overlapping the discharge port 318a in the third direction D3 (e.g., vertically overlapping the discharge port 318a). The internal slot 340 may be a volume space defined in at least the first and second directions D1 and D2 by inner surfaces 340s of the supply assembly 300 having dimensions at least partially complementary to the dimensions of the outer surface 220s dimensions of at least a rear portion 200r of the conveyor assembly 200, for example such that a distance 380fd in the second direction D2 between opposing inner surfaces 380fs of the front locating brackets 380f (and/or a distance 380rd in the second direction D2 between opposing inner surfaces 380rs of the rear locating brackets 380r) is equal to or substantially equal to (e.g., within a 10% margin) the width 220d in the second direction between opposite outer surfaces 220s of the conveyor frame 220 at the rear portion 200r of the conveyor assembly 200. The rear portion 200r of the conveyor assembly 200 may include the rear end 210r of the conveyor belt apparatus 210 and at least a portion of the rear conveyor section 210p of the conveyor belt apparatus 210.

As shown, the supply assembly 300 may include one or more locating members, including longitudinal bumpers 370 and locating brackets 380 which include front and rear locating brackets 380f and 380r, where the respective inner surfaces 370s, 380fs and 380rs collectively amount to inner surfaces 340s defining lateral boundaries (e.g., in the first and second direction D1 and D2) of the internal slot 340 within the supply assembly 300, where the internal slot 340 is open at a front opening 340f defined by the outermost surfaces of the supply assembly 300 (e.g., of the supply frame 320) and thus the internal slot 340 may be referred to as an open slot enclosure. As further shown, the internal slot 340 may be defined in the third direction D3 between the support surface 50 upon which the supply assembly 300 is located (e.g., is resting) and the discharge port 318a of the supply apparatus 310.

As shown in FIGS. 3A to 3G, the supply assembly 300 may define the internal slot 340 to be configured to receive, enclose, and/or overlap at least the rear portion 200r of the conveyor assembly 200, based on the supply assembly 300 moving over the support surface 50 in relation to the conveyor assembly 200. For example, where the conveyor assembly 200 is located at the particular position 100p and fixed in place, the supply assembly 300 may move over the support surface 50 and further move towards the rear portion 200r of the conveyor assembly 200 in the first direction D1 so that the rear portion 200r is received into the internal slot 340 via the front opening 340f of the internal slot 340. The supply assembly 300 may move over the rear portion 200r of the conveyor assembly 200 until the internal longitudinal bumpers 370 engage a rear surface 200rs of the rear portion 200r at an end of the internal slot 340 opposing the front opening 340f to arrest relative movement of the supply assembly 300 in relation to the conveyor assembly 200 in the first direction D1 and to align the discharge port 318a with the rear conveyor section 210p of the conveyor belt apparatus 210 in at least the first direction D1. The front and rear locating brackets 380f and 380r may constrain relative movement of the rear portion 200r of the conveyor assembly 200 in relation to the supply assembly 300 in the second direction D2 (lateral direction) when the rear portion 200r is in the internal slot 340, to thereby align the discharge port 318a with the rear conveyor section 210p of the conveyor belt apparatus 210 in at least the second direction D2. Accordingly, the supply assembly 300 and the conveyor assembly 200 may be aligned with each other such that the discharge port 318a is aligned (e.g., at least partially vertically overlaps, at least partially overlaps in the third direction D3) with the conveyor belt apparatus 210 at the rear end 210r thereof to configure the supply apparatus 310 to supply material 2 onto the rear conveyor section 210p of the conveyor belt apparatus 210 to be moved by the conveyor belt apparatus 210 towards the front end 210f thereof.

While example embodiments show the locating brackets 380 and longitudinal bumpers 370 that are configured to align the conveyor assembly 200 and the supply assembly 300 to be coupled to the supply frame 320 as part of the supply assembly 300, example embodiments are not limited thereto. In some example embodiments at least some or all of such locating brackets 380 and longitudinal bumpers 370 as shown in FIGS. 5A to 5E (referred to collectively as one or more locating members) may be included in the conveyor assembly 200 instead of the supply assembly 300. Additionally, at least one of the longitudinal bumpers 370 and/or locating brackets 380 may be omitted from one of both of the conveyor assembly 200 and/or the supply assembly 300. Accordingly, at least one assembly of the conveyor assembly 200 or the supply assembly 300 may include one or more locating members (e.g., 370 and/or 380) configured to engage a frame of another assembly of the conveyor assembly 200 or the supply assembly 300 to align the discharge port 318a of the supply apparatus 310 to at least partially vertically overlap the conveyor belt 212 at the rear conveyor section 210p of the conveyor belt apparatus 210.

Still referring to at least FIGS. 1, 2A and 2B, 3A to 3G, 4A to 4H, and 6A to 6F, in some example embodiments the conveyor assembly 200 may include one or more locating members configured to at least partially position (e.g., locate, align, etc.) the conveyor assembly 200 in relation to an external structure, for example the manufacturing machine 10, based on engaging a surface of the external structure, for example an outer surface 12s of the housing structure 12 of the manufacturing machine 10, such that the front end 210f of the conveyor belt apparatus is at least partially located (e.g., aligned) at a particular position 100p (which may include a particular relative position and relative orientation) in relation to the external structure (e.g., the manufacturing machine 10). For example, as shown, the conveyor assembly 200 may include one or more longitudinal bumpers 270 extending from a front surface 200fs of the conveyor assembly 200 (which may be a front outer surface of the conveyor frame 220 and configured to engage an outer surface 12s of the housing structure 12 of the manufacturing machine 10 in the first direction D1 so as to space apart, and thus align in the first direction D1, the conveyor assembly 200 and thus the front end 210f of the conveyor belt apparatus 210 in relation to the manufacturing machine 10 (e.g., at least an intake port 10a thereof).

As further shown, the manufacturing machine 10 may include one or more sets of locating brackets 80 having inner surfaces 80s defining a slot 94 having lateral boundaries in the second direction D2 which are complementary to the outer surfaces 220s of a front portion 200f of the conveyor assembly 200 (which may be a front portion of the conveyor frame 220 adjacent to the front surface 200fs), for example such that a distance 80sd in the second direction D2 between opposing inner surfaces 80s of the locating brackets 80 is equal to or substantially equal to (e.g., within a 10% margin) the width 220d in the second direction between opposite outer surfaces 220s of the conveyor frame 220 at the front portion 200f of the conveyor assembly 200. Accordingly, the locating brackets 80 may define a slot 94 into which at least the front portion 200f of the conveyor assembly 200 (e.g., a front portion of the conveyor frame 220) is configured to be inserted in order to align the conveyor assembly 200 along at least the second direction D2 in relation to the manufacturing machine 10 when the front portion 200f is sufficiently inserted into the slot 94 to engage the longitudinal bumpers 270 with the outer surface 12s to align the conveyor assembly 200 in relation to the manufacturing machine 10 in the first direction D1 and, as a result, to align the front end 210f of the conveyor belt apparatus 210 with the manufacturing machine 10 in at the first and second directions D1 and D2 to further align the front end 210f with at least one intake port 10a of the manufacturing machine 10 in at least one of the first, second, or third directions D1, D2, or D3. The conveyor frame 220 may engage the set of locating brackets 80 of the manufacturing machine 10 (referred to as external locating brackets) to align the front end 210f of the conveyor belt apparatus 210 along the lateral direction D2 in relation to the manufacturing machine 10. Accordingly, the conveyor assembly 200 and/or an external structure (e.g., the manufacturing machine 10) may include one or more locating members (e.g., longitudinal bumpers 270 and/or locating brackets 80) configured to at least partially position (e.g., align) the conveyor assembly 200 in relation to the external structure (e.g., the manufacturing machine 10) based on engaging a surface of the external structure (e.g., based on one or more of the longitudinal bumpers 270 engaging the outer surface 12s of the housing structure 12 of the manufacturing machine 10), such that the front end 210f of the conveyor belt apparatus 210 is at least partially located at (e.g., is aligned in the first and second directions D1 and D2) a particular position in relation to the external structure (e.g., the manufacturing machine 10).

While example embodiments show the locating brackets 80 as being connected to the manufacturing machine 10 and show at least a front portion of the conveyor frame 220 (e.g., the front portion 200f of the conveyor assembly 200) as being configured to be at least partially inserted into a slot 94 defined by the locating brackets 80, example embodiments are not limited thereto. In some example embodiments, the locating brackets 80 may be coupled to the conveyor frame 220 and may be configured to engage and/or define a slot configured to receive at least a portion of the manufacturing machine 10 to align the conveyor assembly 200 in relation to the manufacturing machine 10 along one or more directions (e.g., the first and/or second directions D1 and/or D2), to thereby align the front end 210f of the conveyor belt apparatus 210 along the one or more directions.

Still referring to FIGS. 1, 2A and 2B, 3A to 3G, 4A to 4H, and 6A to 6F, in some example embodiments the conveyor assembly 200 may include an electrical distribution assembly 280. The electrical distribution assembly 280 may be configured to electrically couple elements of at least the conveyor assembly 200 to an external power supply 30, for example via a machine electrical connector 90 of the manufacturing machine 10 so as to receive electrical power 30a therefrom. The electrical distribution assembly 280 may further be configured to electrically couple elements of at least the conveyor assembly 200 to an external controller 20 to enable the controller 20 to receive signals (e.g., sensor data signals) from at least such elements of the conveyor assembly 200 (e.g., from level sensor device 240) and/or to transmit command signals and/or selectively control the supply of electrical power to one or more elements of at least the conveyor assembly 200 to control operation thereof (e.g., at least the conveyor driver 214). The electrical distribution assembly 280 may, in some example embodiments, be configured to electrically couple the supply apparatus 310 of the supply assembly 300 to an external power supply 30 through the conveyor assembly 200, for example through a single connection between the conveyor assembly 200 and an external structure (e.g., via a connection between the first electrical connector port 282a and a machine electrical connector 90 connected thereto, where the machine electrical connector 90 is electrically coupled, via at least cabling 92 (which may include any electrical cabling, circuitry or the like), to a power supply 30. The electrical distribution assembly 280 may also be configured to electrically couple sensor devices of the conveyor assembly 200 and/or the supply assembly 300 (e.g., levels sensor device 240 and/or level sensor device 319) to an external controller 20 via the single electrical connector port (first electrical connector port 282a). As a result, the conveyor assembly 200 may be configured to enable simplified electrical connections between the conveyor belt apparatus 210 and supply apparatus 310 of the feed assembly 100 with a power supply 30 and/or controller 20. Such simplified electrical connections may enable modularity and ease of rapid connection, disconnection, replacement, and/or adjustable positioning of the conveyor assembly 200 and supply assembly 300, and thus of the feed assembly 100, in relation to an external structure (e.g., the manufacturing machine 10), thereby improving ease and/or flexibility of operations to couple or decouple the feed assembly 100 or any assembly thereof, or the like, reducing complexity of operations to couple or decouple the feed assembly 100 or any assembly thereof, or the like.

While the machine electrical connector 90 may be described herein as being included in the manufacturing machine 10, it will be understood that example embodiments are not limited thereto. In some example embodiments, the machine electrical connector 90 may be separate from the manufacturing machine 10, for example separate from the electrical circuitry and conduits of the manufacturing machine 10, and the machine electrical connector may be electrically coupled to the power supply 30 and/or the controller 20 independently of the manufacturing machine 10, where the manufacturing machine 10 may be electrically coupled to the power supply 30 and/or the controller 20 independently of the machine electrical connector 90. As a result, in some example embodiments, the machine electrical connector 90 and the manufacturing machine 10 may be electrically coupled to the power supply 30 and/or the controller 20 in parallel. In such example embodiments, the machine electrical connector 90 may be configured to connect with the first electrical connector port 282a of the conveyor assembly 200 to enable the feed assembly 100 and the manufacturing machine 10 to be electrically coupled in parallel to the power supply 30 and/or the controller 20. In some example embodiments, the machine electrical connector 90 may be electrically coupled to electrical circuitry and/or conduits of the manufacturing machine 10 and thus may be electrically coupled to the power supply 30 and/or controller 20 through at least some electrical circuitry and/or conduits the manufacturing machine 10, such that the machine electrical connector 90 and the manufacturing machine 10 may be electrically coupled in series to the power supply 30 and/or the controller 20. As a result, in such example embodiments, the machine electrical connector 90 may be configured to connect with the first electrical connector port 282a of the conveyor assembly 200 to enable the feed assembly 100 to be electrically coupled to the power supply 30 and/or the controller 20 through at least some electrical circuitry and/or conduits of the manufacturing machine 10, and thus the feed assembly 100 and the manufacturing machine 10 may be electrically coupled in series to the power supply 30 and/or the controller 20.

As shown, the electrical distribution assembly 280 of the conveyor assembly 200 may include a first electrical junction box 282. The first electrical junction box 282 may include a first electrical connector port 282a configured to connect with an external electrical connector. As shown, the first electrical connector port 282a may be configured to connect with a machine electrical connector 90 that is connected to a distal end of an cabling 92 and which may be electrically connected to a power supply 30, controller 20, or the like via cabling 92, so as to electrically couple the conveyor assembly 200 with the power supply 30, the controller 20, or the like via at least the first electrical connector port 282a.

As shown in at least FIG. 4G, the first electrical connector port 282a may include separate electrical connectors 298a and 298b which may electrically couple with separate elements of the conveyor assembly 200. As shown, the first electrical connector port 282a may be configured to connect with a machine electrical connector 90 that is electrically coupled, via at least cabling 92, to a power supply 30 of the manufacturing system 1. In some example embodiments, the machine electrical connector 90 is included in the manufacturing machine 10 and is electrically coupled to the power supply 30 through the manufacturing machine 10 (and in some example embodiments, through the controller 20 separately from or in addition to the manufacturing machine 10). The manufacturing machine 10 may be electrically coupled to the power supply 30 and may include the machine electrical connector 90 and cabling 92 and may be configured to supply at least a portion of the electrical power 30a received from the power supply 30 to the conveyor assembly 200 via the machine electrical connector 90, based on the machine electrical connector 90 being connected to the first electrical connector port 282a of the first electrical junction box 282. It will be understood that the first electrical junction box 282 may be any known electrical junction box, and the first electrical connector port 282a and electrical connectors 298a and 298b thereof may include known electrical connector or set of electrical connectors that are configured to connect with another electrical connector to electrically couple the electrical distribution assembly 280 of the conveyor assembly 200 with an external power supply 30. While the first electrical connector port 282a is shown to include two separate electrical connectors 298a and 298b, it will be understood that example embodiments are not limited thereto, and in some example embodiments the first electrical connector port 282a may include any quantity of electrical connectors, including for example one electrical connector.

As shown, the electrical distribution assembly 280 may include one or more electrical conduits 286 connected between the first electrical connector port 282a (e.g., one or more electrical connectors thereof) and one or more elements of the conveyor assembly 200 to configure such one or more elements to be electrically coupled to an external power supply 30 based on the first electrical connector port 282a being connected with an external electrical connector (e.g., machine electrical connector 90) that is electrically coupled to the power supply 30.

For example, the electrical conduits 286 may include a first electrical conduit 286a which may include one or more instances (e.g., units, pieces, etc.) of electrical cabling, electrical circuitry, or any combination thereof coupling one or more connectors of the first electrical connector port 282a (e.g., electrical connector 298a) with at least the conveyor driver 214. As a result, the electrical distribution assembly 280 may be configured to electrically couple at least the conveyor driver 214 to an external power supply 30 and/or controller 20, to thereby configure the conveyor belt apparatus 210 to receive electrical power, control signals, ort eh like and thus to be controllably operated, based on the first electrical connector port 282a connecting with the machine electrical connector 90 (restated as the electrical distribution assembly 280 connecting the first electrical connector port 282a with the machine electrical connector 90).

In some example embodiments, the electrical distribution assembly 280 may include a second electrical junction box 288 including a second electrical connector port 288a, and the electrical conduits 286 may further include a second electrical conduit 286b which may include one or more instances (e.g., units, pieces, etc.) of electrical cabling, electrical circuitry, or any combination thereof coupling the first electrical connector port 282a (e.g., one or more connectors thereof, for example the second electrical connector 298b) of the first electrical junction box 282 with the second electrical connector port 288a (e.g., one or more connectors thereof, for example the electrical connector 299).

In some example embodiments, the first electrical conduit 286a and the second electrical conduit 286b may be coupled to separate, respective electrical connectors of the first electrical connector port 282a. For example, as shown in FIG. 4G, the first electrical connector port 282a may include first and second electrical connectors 298a and 298b, where the first electrical conduit 286a may be electrically connected to the first electrical connector 298a and not to the second electrical connector 298b, while the second electrical conduit 286b may be electrically connected to the second electrical connector 298b and not to the first electrical connector 298a. Accordingly, the first and second electrical conduits 286a and 286b may be electrically connected to the first electrical connector port 282a in parallel. Referring to FIG. 6F, the machine electrical connector 90 may include first and second electrical connectors 98a and 98b that are each electrically coupled (e.g., in parallel) to the power supply 30 and/or the controller 20 (e.g., through the manufacturing machine 10 or independently of the manufacturing machine 10). The first electrical connector 298a of the first electrical connector port 282a may be configured to be complementary to the first electrical connector 98a of the machine electrical connector 90, and the second electrical connector 298b of the first electrical connector port 282a may be configured to be complementary to the second electrical connector 98b of the machine electrical connector 90, and the first electrical connector port 282a may be configured to connect with the machine electrical connector 90 to connect the first electrical connectors 298a and 98a to each other and to separately connect the second electrical connectors 298b and 98b to each other, thereby electrically coupling the first and second electrical connectors 298a and 298b in parallel to the power supply 30 and/or the controller 20 through at least the machine electrical connector 90.

As shown, in some example embodiments, the electrical distribution assembly 280 may include an electrical channel structure 284 configured to enclose and protect at least some or all of the electrical conduits 286 (e.g., at least some or all of one or both of the first and second electrical conduits 286a and 286b). As shown, the electrical channel structure 284 may include a hollow tube that may extend between the first and second electrical junction boxes 282 and 288, but example embodiments are not limited thereto. In some example embodiments, the first electrical conduit 286a may extend from the first electrical junction box 282 to the second electrical junction box 288 through the electrical channel structure 284 and may further extend from the second electrical junction box 288 to at least the conveyor driver 214, but example embodiments are not limited thereto. In some example embodiments, the second electrical conduit 286b may extend from the first electrical junction box 282 to the second electrical junction box 288 through the electrical channel structure 284, but example embodiments are not limited thereto.

In some example embodiments, the one or more electrical conduits 286 may include an electrical conduit (e.g., the first electrical conduit 286a) which may be coupled to the level sensor device 240 of the conveyor assembly 200, and the electrical distribution assembly 280 may be configured to electrically couple the level sensor device 240 to an external power supply 30 and/or controller 20 based on the first electrical connector port 282a being connected with the machine electrical connector 90.

In some example embodiments, the supply assembly 300 may include a supply electrical connector 390 which may be coupled with at least the supply driver 314 of the supply apparatus 310 (e.g., via at least one of cabling 392 and/or a junction box 394). The supply electrical connector 390 may be configured to connect with the second electrical connector port 288a of the second electrical junction box 288 of the conveyor assembly 200. The supply electrical connector 390 may be coupled to the supply driver 314 via cabling 392 and a junction box 394, but example embodiments are not limited thereto. The supply electrical connector 390 may be configured to electrically couple the supply apparatus 310 (e.g., at least the supply driver 314) to the electrical distribution assembly 280. Furthermore, based on the second electrical conduit 286b coupling the second electrical connector port 288a (e.g., at least one electrical connector thereof, such as electrical connector 299) with the first electrical connector port 282a (e.g., at least the second electrical connector 298b thereof), the supply apparatus 310 (e.g., at least the supply driver 314 thereof) may be electrically coupled with a power supply 30 through the supply electrical connector 390 and the electrical distribution assembly 280 (e.g., the second electrical connector port 288a, the second electrical conduit 286b, and the first electrical connector port 282a) based on the supply electrical connector 390 being connected to the second electrical connector port 288a and the first electrical connector port 282a further being connected to a machine electrical connector 90 that is electrically coupled with the power supply 30. As a result, the electrical distribution assembly 280 may be configured to electrically couple the supply assembly 300 (e.g., the supply apparatus 310) to the external power supply 30 through the second electrical connector port 288a and the first electrical connector port 282a (e.g., via electrical connector 299, second electrical conduit 286b, and electrical connector 298b), based on the first electrical connector port 282a connecting with the machine electrical connector 90 and the supply electrical connector 390 connecting with the second electrical connector port 288a.

In some example embodiments, the first and second electrical junction boxes 282 and 288 are coupled to the conveyor frame 220 at opposite ends of the conveyor frame (e.g., at the front portion 200f that is at or adjacent to the front surface 200fs and at the rear portion 200r that is at or adjacent to the rear surface 200rs, respectively, of the conveyor assembly 200) along the longitudinal axis 200x of the conveyor assembly 200 (which may be the same or coaxial with the longitudinal axis 210x of the conveyor belt apparatus 210). Based on the first electrical junction box 282 being at the front portion 200f of the conveyor assembly 200, positioning the conveyor assembly 200 to be aligned with the manufacturing machine 10 so that the front end 210f of the conveyor belt apparatus 210 is aligned with the intake port 10a of the manufacturing machine 10 may cause the first electrical junction box 282 and the first electrical connector port 282a thereof to be proximate to (and in some example embodiments, facing) the manufacturing machine 10 and to be proximate to a machine electrical connector 90 of the manufacturing machine 10, thereby enabling the machine electrical connector 90 to be extended to and connected with the first electrical connector port 282a without requiring excessive length of cabling 92. As a result, clutter, excessive connection hardware, and/or structural complexity at the interface between the front portion 200f of the conveyor assembly 200 and the manufacturing machine 10 may be reduced, thereby reducing capital costs and further reducing a risk of inadvertent disconnection or damage of the cabling 92 due to tangling, exposure and inadvertent cutting of the cabling 92 by an operator, tool, or other equipment, etc. In addition, based on the second electrical junction box 288 being at the rear portion 200r of the conveyor assembly 200, positioning the supply assembly 300 to receive the rear portion 200r of the conveyor assembly 200 into the internal slot 340 defined by the supply assembly 300 to align the discharge port 318a with the rear conveyor section 210p of the conveyor belt apparatus 210 may cause the second electrical junction box 288 and the second electrical connector port 288a thereof to be proximate to (and in some example embodiments, facing) the supply electrical connector 390 of the supply assembly 300, thereby enabling the supply electrical connector 390 to be extended to and connected with the second electrical connector port 288a without requiring excessive length of cabling 392. As a result, clutter, excessive connection hardware, and/or structural complexity at the interface between the conveyor assembly 200 and the supply assembly 300 may be reduced, thereby reducing capital costs and further reducing a risk of inadvertent disconnection or damage of the cabling 392 due to tangling, exposure and inadvertent cutting of the cabling 392 by an operator, tool, or other equipment, etc.

In some example embodiments, where the supply assembly 300 includes one or more sensor devices such as level sensor device 319, the supply electrical connector 390 may be coupled to the level sensor device 319, such that connecting the supply electrical connector 390 with the second electrical connector port 288a and further connecting the first electrical connector port 282a with the machine electrical connector 90 may electrically couple the one or more sensor devices of the supply assembly 300 with an external power supply 30 and/or controller 20 to thereby configure the one or more sensor devices to generate sensor data and communicate the sensor data as one or more sensor data signals to a remote device (e.g., controller 20) via the electrical distribution assembly 280 and the machine electrical connector 90.

As shown, the first and second electrical conduits 286a and 286b may be connected to separate, respective electrical connectors 298a and 298b of the first electrical connector port 282a and thus may be understood to be connected to the first electrical connector port 282a in parallel. As a result, the electrical connectors 298a and 298b of the first electrical connector port 282a may be understood to be configured to be electrically coupled to separate, respective ones of the conveyor driver 214 and the second electrical connector port 288a, such that the conveyor driver 214 and the second electrical connector port 288a (and thus a supply driver 314 of the supply assembly 300) may be electrically coupled to the first electrical connector port 282a in parallel based on the supply electrical connector 390 connecting with the second electrical connector port 288a. The second electrical connector port 288a of the second electrical junction box 288 may thus be configured to connect with the supply electrical connector 390 to electrically couple the supply apparatus 310 to the external power supply 30 and/or controller 20 through the second electrical connector port 288a and the first electrical connector port 282a, based on the first electrical connector port 282a connecting with the machine electrical connector 90.

As a result, and as shown, the electrical distribution assembly 280 may be configured to provide a simple, easily detachable (e.g., reversible) electrical connection between the controllable elements (e.g., drivers) and/or sensors of the separate assemblies 200 and 300 of the feed assembly 100 with a single external electrical connector (e.g., machine electrical connector 90) to facilitate a simplified and easily manipulated electrical connection which may be quickly and easily connected or disconnected to enable quick and easy movement and/or replacement of one or both of the conveyor assembly 200 and/or the supply assembly 300 in relation to the manufacturing machine 10 to facilitate improved ease of maintenance, cleaning, inspection, or the like of the feed assembly 100 or any portion thereof (e.g., the conveyor assembly 200 and/or the supply assembly 300), the manufacturing machine 10, a region of the support surface 50 overlapped by the feed assembly 100 in the particular position 100p, any combination thereof, or the like.

In some example embodiments, the conveyor assembly 200 and the supply assembly 300 may include one or more physical connectors 372 (which may include any known physical connectors including for example latch connectors, interlocks, etc.) configured to physically couple the conveyor assembly 200 and the supply assembly 300 (e.g., the conveyor frame 220 and the supply frame 320) to each other independently of the electrical distribution assembly 280 based on the supply assembly 300 being positioned in relation to the conveyor assembly 200 such that the discharge port 318a is aligned with the rear conveyor section 210p of the conveyor belt apparatus 210, for example based on the rear portion 200r of the conveyor assembly 200 being received into the internal slot 340 defined by the supply assembly 300 such that the longitudinal bumpers 370 of the supply assembly 300 engage (e.g., contact) a rear surface 200rs of the conveyor assembly 200 that may be defined by a rear surface of the conveyor frame 220 within the internal slot 340. However, it will be understood that in some example embodiments the one or more physical connector 372 may be omitted from either or both of the conveyor assembly 200 and the supply assembly 300.

Referring to FIGS. 1, 2A, and 2B, the manufacturing system 1 may include the manufacturing machine 10, the feed assembly 100 located at the particular position 100p thereof such that the front end 210f of the conveyor belt apparatus 210 is aligned with (e.g., at least partially overlaps in the third direction D3) at least one intake port 10a (e.g., intake port 18a) of the manufacturing machine 10 and the discharge port 318a of the supply assembly 300 is aligned with (e.g., at least partially overlaps in the third direction D3) the rear conveyor section 210p of the conveyor belt apparatus 210, a power supply 30, and a controller 20. The controller 20 may be electrically coupled to at least the feed assembly 100 based on the machine electrical connector 90 being electrically coupled to the controller 20 and further connected to the first electrical connector port 282a of the electrical distribution assembly 280 of the conveyor assembly 200. The controller 20 may be configured to operate the manufacturing machine 10, for example the dispenser 14, packaging device 16, and/or vibratory pan feeder 18 thereof, to cause the manufacturing machine to process a material 2 received via one or more intake ports 10a to form (e.g., dispense) one or more discrete units of the material 2. The supply apparatus 310 may hold (store) an amount of the material 2 (e.g., as a bulk material) in the static bin 312. The controller 20 may be electrically coupled to at least the supply driver 314 of the supply assembly 300 via at least the electrical distribution assembly 280 of the conveyor assembly 200, and the supply electrical connector 390 connected to the electrical distribution assembly 280, and the machine electrical connector 90 connected to the electrical distribution assembly 280. The controller 20 may be electrically coupled to at least the conveyor driver 214 of the conveyor assembly 200 via at least the electrical distribution assembly 280 and the machine electrical connector 90 connected thereto. The controller 20 may control the supply apparatus 310 based on controlling at least the supply driver 314 to cause the supply apparatus 310 to controllably discharge amounts of the material 2 through the discharge port 318a onto the aligned rear conveyor section 210p of the conveyor belt apparatus 210. The controller 20 may control the conveyor belt apparatus 210 based on controlling at least the conveyor driver 214 to control the movement of the conveyor belt 212 and material 2 thereon (e.g., in one or more conveyor belt sections 212b) to the front end 210f of the conveyor belt apparatus 210 and to be further discharge such material from the conveyor belt apparatus at the front end 210f into the manufacturing machine 10 (e.g., the vibratory pan feeder 18) via one or more intake ports 10a (e.g., via intake port 18a, intake port 12a, or a combination thereof).

In some example embodiments, the level sensor device 240 may generate sensor data indicating a level 432 (e.g., depth) of accumulated material 2a at the junction region 430 in the conveyor belt apparatus 210, for example at the junction between the lower conveyor section 210b and the inclined conveyor section 210a. The conveyor assembly 200 may be configured to enable such sensor data to be transmitted in one or more sensor data signals from the level sensor device 240 to the first electrical connector port 282a. The controller 20 may be configured to receive the sensor data based on the connection between the controller 20 and the first electrical connector port 282a via at least the machine electrical connector 90. The controller 20 may process the sensor data to determine a value of the level 432 of material 2a at the junction region 430 and may be configured to independently control at least one of the conveyor belt apparatus 210 (e.g., based on controlling the conveyor driver 214) or the supply apparatus 310 (e.g., based on controlling the supply driver 314) based on processing the sensor data to cause the level 432 of material 2a at the junction region 430 at the lower end 210aa to be within a particular range of level values. Accordingly, the feed assembly 100 may be controlled to reduce, minimize, or prevent excessive buildup of material in the feed assembly 100 at the junction region 430 at the lower end 210aa of the inclined conveyor section 210a, thereby reducing, minimizing, or preventing a risk of equipment malfunction or breakdown, interruption or undesired variation in rate of discharge of bulk material from the front end 210f into the manufacturing machine 10 by the conveyor belt apparatus 210, any combination thereof, or the like. For example, in some example embodiments, the controller 20 may process the sensor data generated by the level sensor device 240, and which may be received at the controller 20 via the electrical distribution assembly 280 or via a separate communication pathway or conduit (e.g., a separate wired or wireless communication length) to determine a value of the level 432 (e.g., depth in the vertical direction D3) of the material 2a at the junction region 430, execute a control loop to generate one or more output values indicating a target level of the material, based on a process variable that is the determined value of the level of the material and a setpoint that is a stored level setpoint value, and control the at least one of the conveyor driver 214 or the supply driver 314 based on the one or more output values to control the level 432 of the material 2a. Such a control loop executed by the controller 20 may be a proportional-integral-derivative (PID) control loop.

The controller 20 may be configured to control the at least one of the conveyor driver 214 or the supply driver 314 such that the level 432 of the material 2a at the junction region 430 is caused to be equal to or smaller than a threshold value, thereby reducing, minimizing, or preventing excessive material 2a buildup at the junction region 430. For example, the controller 20 may cause the conveyor driver 214 to increase the rate of speed at which the conveyor belt 212 moves and to thereby increase the rate at which material 2 is removed from the junction region 430 and/or may reduce the rate at which the supply apparatus 310 discharges material 2 onto the conveyor belt 212 at the rear conveyor section 210p of the conveyor belt apparatus 210 (e.g., the lower conveyor section 210b) in order to reduce the rate at which material is introduced to the junction region 430, to thereby reduce the level 432 of material 2a at the junction region 430 to be equal to or less than a threshold value. In some example embodiments, the controller 20 may be configured to control the at least one of the conveyor driver 214 or the supply driver 314 such that the level of the material at the junction region 430 is caused to be equal to or greater than a minimum threshold value.

While the conveyor assembly 200 according to some example embodiments, including the example embodiments as shown in at least FIGS. 1, 2A and 2B, 3A to 3G, 4A to 4H, and 6A to 6F, includes a conveyor belt apparatus 210 that includes the conveyor belt 212, the conveyor driver 214, the one or more driven rollers 216 coupled to the conveyor driver 214 where the conveyor belt 212 extends over at least a portion of the one or more driven rollers 216, a conveyor frame 220 coupled to the conveyor belt apparatus 210, and one or more conveyor rollers 230 coupled to an underside of the conveyor frame 220, example embodiments are not limited thereto. In some example embodiments, the conveyor belt apparatus 210 may be configured to convey a material 2 from a rear conveyor section 210p of the conveyor belt apparatus 210 to a front end 210f of the conveyor belt apparatus 210. In some example embodiments, the conveyor belt apparatus 210 may omit one or more of the conveyor belt 212, the conveyor driver 214, or the one or more driven rollers 216. For example, in some example embodiments, the conveyor belt apparatus 210 may omit the conveyor belt 212 and may include a different conveying device, for example a plurality of rollers, a sequence of movable containers, or the like. In another example, the conveyor belt apparatus 210 may omit the conveyor driver 214 and may include driven rollers 216 or any other mechanism configured to engage and control movement of the conveyor belt 212 and which may be configured to be coupled to an external driver that is external to the conveyor assembly 200. In another example, the conveyor belt apparatus 210 may omit the driven roller 216 and may include any known driven mechanism and/or driven member configured to transmit power received from the conveyor driver 214 (e.g., via a driveshaft of the conveyor driver) to the conveyor belt 212 (e.g., based on contact with the conveyor belt) to induce movement of the conveyor belt 212. In another example, the conveyor belt apparatus 210 may omit the driven roller 216 and may include a conveyor driver 214 including a power transmitting element (e.g., a driveshaft) that directly contacts the conveyor belt 212 to directly move the conveyor belt 212. In some example embodiments, the conveyor driver 214 may be understood to be configured to control movement of the conveyor belt 212 (e.g., directly, based on transmitting power, torque or the like thereto via one or more driven mechanisms, based on transmitting power, torque or the like thereto via one or more driven members, or the like). In some example embodiments, the conveyor assembly 200 may omit one or more of the conveyor frame 220 or the one or more conveyor rollers 230. For example, the conveyor assembly 200 may omit the conveyor frame 220 and may include a conveyor belt apparatus 210 connected directly to the one or more conveyor rollers 230 and supported directly on the support surface 50 by the one or more conveyor rollers 230 independently of any separate conveyor frame 220. In another example, the conveyor assembly 200 may omit the one or more conveyor rollers 230 and the conveyor belt apparatus 210 and/or the conveyor frame 220 may include one or more sliders, sliding surfaces, or the like configured to engage in sliding movement with the support surface 50 to slidingly support the conveyor belt apparatus 210 and/or conveyor frame 220 on the support surface 50. In some example embodiments the conveyor assembly 200 may include one or more conveyor rollers 230 that are not coupled to an underside of the conveyor frame 220 and/or which are not configured to at least partially support the conveyor frame 220 and the conveyor belt apparatus 210 on a support surface 50. In some example embodiments, the conveyor assembly 200 may include one or more conveyor rollers 230 which may be coupled to any portion of the conveyor frame 220, the conveyor belt apparatus 210, the electrical distribution assembly 280, or any combination thereof. In some example embodiments, the conveyor belt apparatus 210 may omit an inclined conveyor section 210a and may be configured to cause material 2 to be conveyed at a same level (e.g., vertical distance) from the support surface 50 from a rear conveyor section 210p of the conveyor belt apparatus 210 to the front end 210f thereof. In some example embodiments, the conveyor assembly 200 may omit the electrical distribution assembly 280 or any portion thereof, including for example omitting one or more of the first electrical junction box 282, the second electrical junction box 288, the electrical channel structure 284, the first electrical conduit 286a, the second electrical conduit 286b, or any combination thereof. For example, the conveyor belt apparatus 210 or any portion thereof, including for example the conveyor driver 214 and/or the level sensor device 240, may include an electrical connector port configured to be directly connected to an external electrical connector (e.g., a machine electrical connector 90) independently of any electrical distribution assembly 280, to electrically couple the conveyor belt apparatus 210 or any portion thereof, including for example the conveyor driver 214 and/or the level sensor device 240, to an external power supply 30 independently of any first electrical junction box 282, electrical conduits 286, or the like.

While the supply assembly 300 according to some example embodiments, including the example embodiments as shown in at least FIGS. 1, 2A and 2B, 3A to 3G, 5A to 5E, 6A to 6F, and 7A and 7B, includes a supply apparatus 310 that includes the static bin 312, the supply driver 314, the driven member 316, the discharge structure 318, the supply frame 320, and the one or more supply rollers 330 coupled to an underside of the supply frame 320 and configured to at least partially support the supply frame 320 and the supply apparatus 310 on the support surface 50, example embodiments are not limited thereto. In some example embodiments, the supply apparatus 310 is configured to discharge (e.g., controllably discharge) a material 2 through a discharge port 318a defined by one or more structures of the supply apparatus 310. In some example embodiments, the supply apparatus 310 may omit one or more of the static bin 312, the supply driver 314, the driven member 316, or the discharge structure 318. For example, the supply apparatus 310 may omit the static bin 312 and may include the discharge structure 318 as a hopper configured to receive and direct externally supplied material 2 through a bottom discharge port 318a without holding the material 2 in a separate static bin 312 in the supply apparatus 310. In another example, the supply apparatus 310 may omit the supply driver 314 and the driven member 316 or any other mechanism configured to engage and control movement of the material 6 through the discharge port 318a and which may be configured to be coupled to an external driver that is external to the supply assembly 300. In another example, the supply apparatus 310 may omit the driven member 316 and may include a supply driver 314 including a power transmitter (e.g., driveshaft) directly exposed to the interior of the discharge structure 318 and configured to directly engage material 2 therein to control movement of the material 2 through the discharge port 318a of the supply apparatus 310. In another example, the supply apparatus 310 may omit the discharge structure 318 and may include one or more structures, separate from a discharge structure 318, which may define a discharge port 318a. In another example, the supply apparatus 310 may include a static bin 312 which at least partially defines the discharge port 318a at a bottom end 312a thereof. In some example embodiments, the supply assembly 300 may omit one or more of the supply frame 320 or the one or more supply rollers 330. For example, the supply assembly 300 may omit the supply frame 320 and may include a supply apparatus 310 that is connected directly to the one or more supply rollers 330 and supported directly on the support surface 50 by the one or more supply rollers 330 independently of any separate supply frame 320. In another example, the supply assembly 300 may omit the one or more supply rollers 330 and the supply apparatus 310 and/or supply frame 320 may include one or more sliders, sliding surfaces, or the like configured to engage in sliding movement with the support surface 50 to slidingly support the supply apparatus 310 and/or supply frame 320 on the support surface 50. In some example embodiments the supply assembly 300 may include one or more supply rollers 330 that are not coupled to an underside of the supply frame 320 and/or which are not configured to at least partially support the supply frame 320 and the supply apparatus 310 on a support surface 50. In some example embodiments, the supply assembly 300 may include one or more supply rollers 330 which may be coupled to any portion of the supply frame 320, the supply apparatus 310, or any combination thereof. In some example embodiments, the supply assembly 300 may omit the supply electrical connector 390, the cabling 392, the junction box 394, or any combination thereof. For example, the supply driver 314 and/or the level sensor device 319 may include an electrical connector port configured to be directly connected to an external electrical connector (e.g., a machine electrical connector 90) to electrically couple the supply driver 314, and thus the supply apparatus 310, to an external power supply 30 independently of the conveyor assembly 200 and/or any electrical distribution assembly 280 thereof.

FIG. 8 is a flowchart of a method S800 of configuring a manufacturing system 1, according to some example embodiments, including for example with regard to the manufacturing system 1 shown in FIGS. 1 and 2A to 2B. The method S800 shown in FIG. 8 may be implemented with regard to the feed assembly 100, the conveyor assembly 200, the supply assembly 300, the manufacturing machine 10, the controller 20, the power supply 30, any combination thereof, or the like according to any of the example embodiments, including any of the example embodiments shown in FIGS. 1 to 7B. It will be understood that operations of the method S800 as shown in FIG. 8 may be rearranged relative to what is shown in FIG. 8. One or more operations may be added to the method S800 relative to what is shown in FIG. 8. One or more operations shown in FIG. 8 may be omitted from the method S800.

At S802, the method S800 may include movably positioning a conveyor assembly 200 over a support surface 50 in relation to a manufacturing machine 10 to position (“locate”) the conveyor assembly at a particular position 100p (e.g., including a particular relative position and/or a particular relative orientation in the first and second directions D1 and D2) in relation to the manufacturing machine 10 to thereby align the conveyor assembly 200 with the manufacturing machine 10. The movement may include moving the conveyor frame 220 such that the conveyor rollers 230 enable rolling contact with the support surface 50 to facilitate movement of the conveyor assembly 200 over the support surface 50. The particular position 100p may be aligned with at least one intake port 10a of the manufacturing machine 10 (e.g., intake port 12a, intake port 18a, intake port 14a, or any combination thereof). As a result, movably positioning the conveyor assembly 200 to the particular position 100p to align with the manufacturing machine 10 at S802 may align (e.g., at least partially overlap in the third direction D3) the front end 210f of the conveyor belt apparatus 210 with at least one intake port 10a of the manufacturing machine 10 (e.g., intake port 18a). The particular position 100p may be at least partially defined by one or more structures of the manufacturing machine 10, including for example the position of the intake port 12a, intake port 18a, intake port 14a, or any combination thereof in a plan view on the first and second directions D1 and D2, As shown in at least FIG. 3E, the particular position 100p may be at least partially defined by the slot 94 that is further defined by an outer surface 12s and locating brackets 80 of the manufacturing machine 10, such that the conveyor assembly 200 may be positioned at the particular position 100p based on the front portion 200f of the conveyor assembly 200 (including front surface 200fs) being inserted into the slot 94 to engage the longitudinal bumpers 270 thereof with the outers surface 12s of the manufacturing machine 10 between the locating brackets 80, thereby aligning the conveyor assembly 200 at the particular position 100p and thereby aligning the conveyor assembly 200 in relation to the manufacturing machine 10 and elements thereof. Such alignment may include causing the front end 210f of the conveyor belt apparatus 210 to at least partially overlap at least one intake port 10a in at least one of the first direction D1, the second direction D2, or the third direction D3 such that the conveyor assembly 200 is positioned to discharge material 2 from the conveyor belt apparatus 210 at the front end 210f into the manufacturing machine 10 via the at least one intake port 10a (e.g., directly from the front end 210f into the vibratory pan feeder 18 via the intake port 18a thereof) such that the material is received at the dispenser 14 (e.g., via the vibratory pan feeder 18).

At S804, the method S800 may include operating one or more locking devices of the conveyor assembly 200 to at least partially inhibit movement of the conveyor assembly 200 in relation to the manufacturing machine 10. For example, in example embodiments where the conveyor assembly 200 includes one or more conveyor rollers 230 including one or more locking devices (e.g., one or more locking caster wheels), the operating at S804 may include operating the one or more locking devices to at least partially lock or brake the one or more conveyor rollers 230 to at least partially inhibit rolling movement thereof with the support surface 50. In another example, in example embodiments where the conveyor assembly 200 includes one or more floor lock devices 250, the operating at S804 may include operating the one or more floor lock devices 250 to engage the support surface 50 to at least partially inhibit movement of the conveyor assembly 200 in relation to the support surface 50.

At S806, the method S800 may include movably positioning the supply assembly 300 over the support surface 50 in relation to the conveyor assembly to align (e.g., at least partially overlap in the third direction D3) the discharge port 318a of the supply apparatus 310 with the conveyor belt 212 at the rear conveyor section 210p of the conveyor belt apparatus 210 of the conveyor assembly 200. The movement may include moving the supply frame 320 such that the supply rollers 330 enable rolling contact with the support surface 50 to facilitate movement of the supply assembly 300 over the support surface 50. The movably positioning may include moving the supply assembly 300 in the first direction D1 in relation to the conveyor assembly 200 (e.g., parallel to the longitudinal axis 200x and/or 210x) and over the rear portion 200r of the conveyor assembly 200 so that the rear portion 200r is received into the internal slot 340 of the supply assembly 300 via the front opening 340f thereof. The movably positioning at S806 may include moving the supply assembly 300 over the rear portion 200r of the conveyor assembly 200 so that the rear portion 200r moves through the internal slot 340, constrained in the second direction D2 by the locating brackets 380 of the supply assembly 300, until the rear surface 200rs of the conveyor assembly 200 contacts the longitudinal bumpers 370 opposite the front opening 340f of the internal slot 340 to arrest further movement in the first direction D1 of the supply assembly 300 in relation to the conveyor assembly 200, at which point the discharge port 318a may be aligned with (e.g. at least partially overlapping in the third direction D3) the rear conveyor section 210p of the conveyor belt apparatus 210.

At S808, the method S800 may include operating one or more locking devices of the supply assembly 300 to at least partially inhibit movement of the supply assembly 300 in relation to the conveyor assembly 200 and/or the manufacturing machine 10. For example, in example embodiments where the supply assembly 300 includes one or more supply rollers 330 including one or more locking devices (e.g., one or more locking caster wheels), the operating at S808 may include operating the one or more locking devices to at least partially lock or brake the one or more supply rollers 330 to at least partially inhibit rolling movement thereof with the support surface 50. In another example, in example embodiments where the supply assembly 300 includes one or more floor lock devices, the operating at S808 may include operating the one or more floor lock devices to engage the support surface 50 to at least partially inhibit movement of the supply assembly 300 in relation to the support surface 50.

It will be understood that, in some example embodiments, at least one of S804 or S808 may be omitted from the method S800. Accordingly, in some example embodiments, the method S800 may include operating a locking device of at least one assembly of the conveyor assembly 200 or the supply assembly 300 to at least partially inhibit movement of the at least one assembly in relation to the manufacturing machine 10.

At S810, the method S800 may include connecting the first electrical connector port 282a of the first electrical junction box 282 of the electrical distribution assembly 280 of the conveyor assembly 200 with the machine electrical connector 90 that is electrically coupled to a power supply 30 and/or controller 20 of the manufacturing system 1, to thereby electrically couple at least the conveyor belt apparatus 210 (e.g., at least the conveyor driver 214) with the power supply 30 (e.g., via the controller 20) through at least a first electrical conduit 286a coupling the conveyor belt apparatus 210 to the first electrical connector port 282a, the first electrical connector port 282a itself, and the machine electrical connector 90. Accordingly, the connecting at S810 may enable at least the conveyor belt apparatus 210 to be controllably operated by the controller 20 of the manufacturing system 1. The controller 20 may further be configured to controllably operate the manufacturing machine 10 and therefore may be configured to controllably operate the feed assembly 100 in coordination with the manufacturing machine 10. In some example embodiments, the connecting at S810 may electrically couple the controller 20 with a level sensor device 240 of the conveyor assembly 200, to enable the controller 20 to receive and process sensor data signals transmitted by the level sensor device 240 and to further control one or more portions of the feed assembly 100, the manufacturing machine 10, or any combination thereof based on processing one or more such sensor data signals.

At S812, the method S800 may include connecting the second electrical connector port 288a of the second electrical junction box 288 of the electrical distribution assembly 280 of the conveyor assembly 200 with the supply electrical connector 390 of the supply assembly 300, where the supply electrical connector 390 is configured to be electrically coupled to the supply apparatus 310 (e.g., at least the supply driver 314), and where the second electrical connector port 288a is coupled with at least one electrical connector (e.g., second electrical connector 298b) of the first electrical connector port 282a by at least a second electrical conduit 286b, to thereby electrically couple the supply apparatus 310 to the first electrical connector port 282a of the first electrical junction box 282 through at least the second electrical conduit 286b, to thereby configure the electrical distribution assembly 280 to electrically couple at least the supply apparatus 310 (e.g., at least the supply driver 314) with the power supply 30 (e.g., via the controller 20) via at least the first electrical connector port 282a, the second electrical conduit 286b, and the second electrical connector port 288a.

In some example embodiments, the method S800 may include performing the connecting at S812 (connecting the second electrical connector port 288a with the supply electrical connector 390) and the connecting at S810 (connecting the first electrical connector port 282a with the machine electrical connector 90) in any order (e.g., performing S812 subsequently to performing S810 as shown in FIG. 8, performing S810 and S812 simultaneously or substantially simultaneously, or rearranging S810 and S812 to perform S810 subsequently to performing S812). The method S800 may include performing S810 and S812 to electrically couple the supply apparatus 310 (e.g., at least the supply driver 314) with the power supply 30 (e.g., via the controller 20) through at least the supply electrical connector 390, the second electrical connector port 288a, the first electrical connector port 282a, and the machine electrical connector 90. The method S800 may include performing S810 and S812 to enable at least the supply apparatus 310 to be controllably operated by the controller 20 of the manufacturing system 1. In some example embodiments, a first electrical conduit 286a may couple the conveyor belt apparatus 210 (e.g., conveyor driver 214) to a first electrical connector 298a of the first electrical connector port 282a while the connecting at S812 may couple the supply apparatus 310 (e.g., supply driver 314) to a separate, second electrical connector 298b of the first electrical connector port 282a. Accordingly, the method S800 may include performing S810 and S812 to electrically couple both the conveyor belt apparatus 210 and the supply apparatus 310 to the power supply 30 and/or controller 20 through separate, respective electrical connectors 298a and 298b of a single electrical connector port (e.g., first electrical connector port 282a) that is connected with a single machine electrical connector 90.

In some example embodiments, the connecting at S812 may electrically couple the controller 20 with a level sensor device 319 of the supply assembly 300, to configure the manufacturing system 1 to enable the controller 20 to receive and process sensor data signals transmitted by the level sensor device 319 and to further control one or more portions of the feed assembly 100, the manufacturing machine 10, or any combination thereof based on processing one or more such sensor data signals.

At S820, the method S800 may include operating one or more portions of the manufacturing system 1 to process a material 2 to provide (e.g., form, dispense, package, etc.) one or more discrete units of the material. The operating at S820 may be performed by at least the controller 20, for example based on a processor (e.g., CPU) of the controller 20 executing a program of instructions stored at a memory (e.g., SSD) of the controller 20 and transmitting one or more control signals (and/or controlling a supply of electrical power 30a) to the manufacturing machine 10, the feed assembly 100, or any combination thereof.

At S822, the operating at S820 may include the controller 20 operating the conveyor belt apparatus 210 and the supply apparatus 310 of the feed assembly 100 to controllably supply (“feed”) one or more amounts of a material 2 (e.g., bulk material) to the manufacturing machine 10. For example, the operating at S822 may include the controller 20 operating the supply driver 314 and the conveyor driver 214 (e.g. controlling operation thereof, for example via transmitting one or more control signals and/or controlling a supply of electrical power 30a thereto) to cause material 2 to be discharged from the supply apparatus 310 onto the conveyor belt 212 at the rear conveyor section 210p thereof and to be moved away from the rear end 210r and towards the front end 210f by the conveyor belt apparatus 210 and to be further discharged from the conveyor belt apparatus 210 at the front end 210f into the manufacturing machine 10 through at least one intake port 10a (e.g., intake port 18a) such that the material 2 is received as bulk material at the manufacturing machine 10. The controller 20 may perform such operating at S820 based on a processor of the controller 20 executing a program of instructions stored at the memory to generate control signals and/or control the supply of electrical power 30a to the supply driver 314 (e.g., to control the rate at which material 2 is discharged from the supply apparatus 310 to the conveyor belt apparatus 210) and the conveyor driver 214 (to control the rate at which the conveyor belt apparatus 210 conveys the discharged amounts of material 2 to the front end 210f and discharges such material 2 from the front end 210f into the manufacturing machine 10).

It will be understood that any of the operations of S800 may include adding material 2 to the supply apparatus 310 (e.g., to the static bin 312) to enable the supply apparatus 310 be operated to controllably discharge the material 2 through the discharge port 318a. For example addition of material to the supply apparatus 310 may occur subsequently to the movably positioning and/or movement inhibition of the supply assembly at S806 and/or S808, but example embodiments are not limited thereto, and material 2 may be added e.g., supplied, fed, etc.) into the supply apparatus 310 at any point during the method S800, including being added multiple times (e.g., in response to a determination during the operating at S820 that a level of material 2 in the static bin 312 of the supply apparatus 310 is less than a threshold level value). Material 2 may be added to the supply apparatus 310 via manual operation (e.g., based on an operator pouring an amount of the material 2 (e.g., bulk material) into the static bin 312 via a top opening of the static bin 312).

At S824, the operating at S820 may include the controller 20 operating the manufacturing machine 10 to process material 2 that is received from the feed assembly 100 (e.g., discharged from the conveyor belt apparatus 210 at the front end thereof 210f into the manufacturing machine 10) to form one or more discrete units (e.g., pieces, volumes, amounts, packages, etc.) of the material 2. For example, where the material 2 is supplied into the manufacturing machine 10 from the feed assembly 100 at S822, the material 2 may be supplied into a vibratory pan feeder 18 of the manufacturing machine 10 via an intake port 18a, and the operating at S824 may include the controller 20 operating the vibratory pan feeder 18 (e.g., controlling a driver mechanically coupled the vibratory pan feeder 18) to vibrate and convey such supplied material 2 to the dispenser 14 through the dispenser intake port 14a. The operating at S824 may include the controller 20 operating the dispenser 14 to dispense, via the dispenser discharge port 14b, a material 2 that is received into the dispenser 14 via the dispenser intake port 14a as separate amounts (e.g., discrete units) of the material. The dispenser 14 may be operated to compress the received material to provide the separate amounts of the material to have a same or different (e.g., greater) density (e.g., greater packing density) than the bulk material received into the dispenser 14 from the feed assembly 100 (directly or via one or more intermediate devices including for example the vibratory pan feeder 18). The operating at S824 may include the controller 20 operating a packaging device 16 to package the one or more separate amounts (discrete units) of the material dispensed by the dispenser 14 into separate packages, to form one or more packaged products. The operating at S824 may include the controller 20 operating one or more devices of the manufacturing machine 10 (e.g., the vibratory pan feeder 18, the dispenser 14, the packaging device 16, etc.) simultaneously so that the manufacturing machine 10 is controlled to form (e.g., produce”) packaged products at a consistent or substantially consistent rate of production. It will be understood that S822 and S824 may be performed at least partially simultaneously (e.g., concurrently), entirely simultaneously, sequentially, or any combination thereof.

The controller 20 may adjustably control some or all of the operating at S820 (e.g., some or all of the operating at S822 and/or S824), including adjustably controlling operation of the supply apparatus 310 and/or the conveyor belt apparatus 210, based on processing sensor data signals received from one or more sensor devices (e.g., level sensor device 240 of the conveyor assembly 200), where the controller 20 may receive such sensor data signals via at least the connection between the first electrical connector port 282a and the machine electrical connector 90. Accordingly, the operating at S820 (e.g., the operating at S822, and/or S824) may include independently controlling at least one of the conveyor belt apparatus 210 or the supply apparatus 310 based on processing sensor data signals generated by the level sensor device 240 to cause a level 432 of material 2a in the junction region 430 of the conveyor belt apparatus 210 to be within a particular range of level values. Such an operation may include some or all of the method S900 shown in FIG. 9.

FIG. 9 is a flowchart of a control method S900, according to some example embodiments. The method S900 shown in FIG. 9 may be implemented as part of the operating at S820, including as part of the operating at S822 and/or S824. The method S900 may be implemented with regard to the feed assembly 100, the conveyor assembly 200, the supply assembly 300, the manufacturing machine 10, the controller 20, the power supply 30, any combination thereof, or the like according to any of the example embodiments, including any of the example embodiments shown in FIGS. 1 to 7B. It will be understood that operations of the method S900 as shown in FIG. 9 may be rearranged relative to what is shown in FIG. 9. One or more operations may be added to the method S900 relative to what is shown in FIG. 9. One or more operations shown in FIG. 9 may be omitted from the method S900.

Referring generally to FIG. 9, the controller 20 may be configured (e.g., based on a memory of the controller 20 storing a program of instructions, also referred to herein as a cascade control program, and a processor of the controller 20 executing the program of instructions) to implement a control method that controls the level 432 of material 2a at the junction region 430 at the lower end 210aa of the inclined conveyor section 210a of the conveyor assembly 200.

Referring generally to the control method shown in FIG. 9, implementing the control program may include receiving and processing sensor data generated by the level sensor device 240 (e.g., via a communication pathway extending through a connection between the first electrical connector port 282a and the machine electrical connector 90) to determine a value of the level 432 of the material 2a in the junction region 430 of the conveyor belt apparatus 210, executing a control loop (e.g., a proportional-integral-derivative (PID) control loop) to generate one or more output values indicating a target level 432 of material 2a in the junction region 430, based on a process variable that is the determined value of the level 432 of material 2a and a level setpoint value, or “setpoint” that is a stored level setpoint value, and controlling at least a portion of the feed assembly 100 and/or the manufacturing machine 10 (e.g., the conveyor driver 214 of the conveyor belt apparatus 210, the supply driver 314 of the supply apparatus 310, a driver mechanically coupled to and configured to control vibration of the vibratory pan feeder 18, any combination thereof, or the like) based on the one or more output values to control the level 432 of material 2a in the junction region 430.

Still referring generally to FIG. 9, the controller 20 may be configured to implement (e.g., execute) cascading a control loop that includes a PID control loop based on using the sensor data generated by the level sensor device 240 as an input process variable of the PID control loop.

The PID control loop may operate as a control loop implementing a PID algorithm according to equation (1):

$$u ( t ) = {K}_{p} e ( t ) + {K}_{i} {\int }_{0}^{t} e ( τ ) d τ + {K}_{d} \frac{de ( t )}{dt} \qquad ( 1 )$$

where, in equation (1), “u(t)” is the output variable (also referred to herein interchangeably as an output value) of the PID control loop, “Kₚ” is a proportional gain value (e.g., a tuning parameter), “Kᵢ” is an integral gain value (e.g., a tuning parameter), “K_{d}” is a derivative gain value (e.g., a tuning parameter), “t” is the present time or instantaneous time, an “τ” is a variable of integration, and “e(t)” is an error according to equation (2):

$$e ( t ) = S P x - P V ( t ) ) \qquad ( 2 )$$

where, in equation (2), “SPx” is the setpoint value or “setpoint” of the PID control loop, and “PV(t)” is the instantaneous value of the process variable of the PID control loop. The values of the proportional, derivative, and derivative gain values Kₚ, Kᵢ, and K_{d}, may be experimentally determined values and may be constant values that may be stored at the controller 20 (e.g., in a memory thereof).

In some example embodiments, the PID control loop may use a particular, or predetermined, level setpoint value (e.g., a level value of “15.0” in a level value range of 0-100) which may be stored at the controller 20 and may use a received sensor data value indicating the level 432 of material 2a (e.g., 9.072165), indicated by the sensor data generated by the level sensor device 240, as the process variable of the PID control loop. The PID control loop may implement a PID control loop as described herein, using at least the process value and setpoint value, to generate one or more output values (e.g., 30.175331 against a setpoint value of 15.0).

The one or more output values may each serve as a control value to control one or more of the conveyor belt apparatus 210 or the supply apparatus 310 of the feed assembly 100 (e.g., the conveyor driver 214 or the supply driver 314). For example, the control loop may generate first and second output values that may indicate respective first and second separate control signals, where the first control signal is to be transmitted to the supply driver 314 and the second control signal is to be transmitted to the conveyor driver 214. In another example, the control loop may generate an output value, and the controller 20 may access an empirically generated lookup table, stored at a memory of the controller 20, that associates the output value with corresponding first and second control signals and apply the output value to the lookup table to determine the first and second control signals. The first control signal, when received at the supply driver 314, may cause the supply driver 314 to control the frequency and/or duration amplitude, stroke, and/or vibration frequency of vibration of the driven member 316 which controls the frequency, magnitude, and rate of discharge of material from the supply apparatus 310 to the conveyor belt apparatus 210. The second control signal, when received at the conveyor driver 214, may cause the conveyor driver 214 to control the operating speed (e.g., conveyor belt 212 speed which controls the rate of conveyance of material by the conveyor belt apparatus 210 and discharge of material from the front end 210f thereof. In some example embodiments, the value (magnitude) of an output value may indicate a specific motor speed (e.g., specific rate of rotation) of a particular driver 214 or 314, and the controller 20 may process the output value to generate a command signal that is transmitted to a particular driver 214 or 314 to cause the driver to responsively operate (e.g., rotate) as specified by the output value (e.g., rotate at the specific motor speed indicated by the output value).

In some example embodiments, the controller 20 may directly transmit an output value to a corresponding driver 214 or 314 to cause the driver to responsively operate as specified by the output value (e.g., rotate at a specific motor speed indicated by the output value). In some example embodiments, the value (magnitude) of an output value may indicate a specific property (e.g., voltage and/or current) of electrical power to be supplied to a corresponding driver 214 or 314 to cause the driver to rotate at a specific motor speed, and the controller 20 may process the output value and, based on the output value, adjustably control one or more properties (e.g., current, voltage, etc.) of a supply of electrical power to the driver (e.g., from a power supply such as mains power to the driver via the controller 20 and/or switchgear controlled by the controller 20) to cause the driver to rotate at the specific motor speed. The controller 20 may include any known power supply circuitry (e.g., a voltage regulator) configured to adjust properties (e.g., voltage and/or current) of electrical power supplied to various drivers of the feed assembly 100, manufacturing machine 10, or any combination thereof.

Referring now to FIG. 9, at S902, the method S900 may include receiving, at the controller 20, a sensor data signal generated by the level sensor device 240. At S904, the method S900 may include processing, at the controller 20, the sensor data signal (e.g., sensor data included in the sensor data signal) to determine a value of the level 432 of material 2a in the junction region 430 of the conveyor belt apparatus 210 at a given instantaneous time “t”. In some example embodiments, the determined level value may be input into a control loop (e.g., a PID control loop) as a process variable of the control loop (e.g., a process variable of the PID control loop). At S906, the method S900 may include retrieving, at the controller 20, a stored level setpoint value, indicating a target value of the level 432 of material 2a in the junction region 430, and inputting the stored level setpoint value into the control loop (e.g., PID control loop) as a setpoint of the control loop.

At S908, the method S900 may include executing, at the controller 20, a control loop (e.g., PID control loop) using the process variable and the setpoint, using for example equations (1) and (2) as described herein (which may be stored at, and loaded and executed from, a memory of the controller 20) with stored gain values (which may be stored at a memory of the controller 20) to generate one or more output variables (referred to herein interchangeably as one or more output values) that indicate one or more control values of one or more control signals to control the conveyor belt apparatus 210 via control of the conveyor driver 214 and/or to control the supply apparatus 310 via control of the supply driver 314.

At S910, the method S900 may include generating, at the controller 20, one or more control signals are generated based on the value(s) of the one or more output variables and transmitting said one or more control signals to the conveyor driver 214 and/or the supply driver 314 to cause the conveyor driver 214 to control the conveyor belt apparatus 210 (e.g., the conveyor belt 212 conveyance speed) in order to control the rate at which material is conveyed by the conveyor belt apparatus 210 to the front end 210f and/or to cause the supply driver 314 to control the supply apparatus (e.g., the frequency and magnitude of discharge of material from the discharge port 318a) in order to control the rate at which material is discharged onto the conveyor belt apparatus 210, in order to control the level of material at the junction region 430.

Referring generally to FIG. 9, a control program implemented by the controller 20, to control at least one of the conveyor driver 214 or the supply driver 314 based on sensor data generated by the level sensor device 240, may cause the level 432 of material 2a at the junction region 430 at the lower end 210aa of the inclined conveyor section 210a to be within a particular range of level values. Accordingly, the feed assembly 100 may be controlled to reduce, minimize, or prevent excessive buildup of material 2a in the feed assembly 100 at the junction region 430, thereby reducing, minimizing, or preventing a risk of equipment malfunction or breakdown, interruption or undesired variation in rate of discharge of bulk material from the front end 210f into the manufacturing machine 10 by the conveyor belt apparatus 210, any combination thereof, or the like. For example, in some example embodiments, the controller 20 may process the sensor data generated by the level sensor device 240, and which may be received at the controller 20 via the electrical distribution assembly 280 or via a separate communication pathway (e.g., a separate wired or wireless communication length) to determine a value of the level 432 (e.g., depth in the vertical direction D3) of the material 2a at the junction region 430, execute a control loop to generate one or more output values indicating a target level of the material, based on a process variable that is the determined value of the level of the material and a setpoint that is a stored level setpoint value, and control the at least one of the conveyor driver 214 or the supply driver 314 based on the one or more output values to control the level 432 of the material 2a.

Such a control loop executed by the controller 20 may be a proportional-integral-derivative (PID) control loop. The controller 20 may be configured to control the at least one of the conveyor driver 214 or the supply driver 314 such that the level 432 of the material 2a at the junction region 430 is caused to be equal to or smaller than a threshold value, thereby reducing, minimizing, or preventing excessive material 2a buildup (accumulation) at the junction region 430. For example, the controller 20 may cause the conveyor driver 214 to increase the rate of speed at which the conveyor belt 212 moves and to thereby increase the rate at which material 2 is removed from the junction region 430 and/or may reduce the rate at which the supply apparatus 310 discharges material 2 onto the conveyor belt 212 at the rear conveyor section 210p of the conveyor belt apparatus 210 in order to reduce the rate at which material 2 is introduced to the junction region 430, to thereby reduce the level 432 of material 2a at the junction region 430 to be equal to or less than a threshold value. In some example embodiments, the controller 20 may be configured to control the at least one of the conveyor driver 214 or the supply driver 314 such that the level 432 of the material 2a at the junction region 430 is caused to be equal to or greater than a minimum threshold value.

While FIG. 9 illustrates a control method S900 that may utilize a control loop such as a PID control loop, example embodiments are not limited thereto. For example, in some example embodiments a controller 20 may process sensor data signals generated by the sensor device 240 to determine control signal values for control signals to transmit to the conveyor driver 214 and the supply driver 314 to control the level 432 of material 2a in the junction region 430 based on applying a value of a sensor data signal to an empirically-generated lookup table that associates sensor data signal values to a value of a first control signal and a value of a second control signal, and further transmitting the first and second control signals to the supply driver 314 and the conveyor driver 214, respectively, where the lookup table is empirically generated to provide control signal values, based on a sensor data signal associated with a particular level 432 of material 2a in the junction region 430, where such control signal values cause the conveyor driver 214 and the supply driver 314 to be controlled to cause the level 432 of material 2a in the junction region 430 (e.g., at the junction region 430) to approach and/or to remain within a particular range of level values, including for example causing the level 432 to be equal to or smaller than a threshold level value, causing the level 432 to be equal to or greater than a minimum level value, or any combination thereof.

While some example embodiments have been disclosed herein, it should be understood that other variations may be possible. Such variations are not to be regarded as a departure from the spirit and scope of the present inventive concepts, and all such modifications as would be obvious to one skilled in the art are intended to be included within the scope of the following claims.

### EXAMPLE EMBODIMENTS

Example Embodiment 1: A feed assembly, comprising:
a conveyor assembly, the conveyor assembly including
   a conveyor belt apparatus including
      a conveyor belt,
      a conveyor driver, and
      one or more driven rollers coupled to the conveyor driver, the conveyor belt extending over at least a portion of the one or more driven rollers,
   a conveyor frame coupled to the conveyor belt apparatus,
   one or more conveyor rollers coupled to an underside of the conveyor frame, the one or more conveyor rollers configured to at least partially support the conveyor frame and the conveyor belt apparatus on a support surface; and a supply assembly, the supply assembly including,
   a supply apparatus, the supply apparatus including
      a static bin,
      a supply driver,
      a driven member at a bottom end of the static bin, the driven member coupled to the supply driver, and
      a discharge structure coupled to the bottom end of the static bin, the discharge structure defining a discharge port, a supply frame coupled to the supply apparatus, and
   one or more supply rollers coupled to an underside of the supply frame, the one or more supply rollers configured to at least partially support the supply frame and the supply apparatus on the support surface,
wherein the supply frame at least partially defines an internal slot vertically overlapping the discharge port, the internal slot having defined inner surface dimensions complementary to outer surface dimensions of at least a rear portion of the conveyor assembly.

Example Embodiment 2: The feed assembly of Example Embodiment 1, wherein the supply apparatus includes a live bottom bin, such that
the driven member includes a vibratory baffle at the bottom end of the static bin and mechanically coupled to the supply driver, and
the discharge structure includes a funnel connected to the bottom end of the static bin.

Example Embodiment 3: The feed assembly of Example Embodiment 1, wherein
the one or more conveyor rollers include a conveyor caster wheel pivotably coupled to the conveyor frame, and
the one or more supply rollers include a supply caster wheel pivotably coupled to the supply frame.

Example Embodiment 4: The feed assembly of Example Embodiment 3, wherein
at least one caster wheel of the conveyor caster wheel or the supply caster wheel is a locking caster wheel.

Example Embodiment 5: The feed assembly of Example Embodiment 1, wherein at least one assembly of the conveyor assembly or the supply assembly includes a locking device configured to at least partially inhibit movement of the at least one assembly in relation to the support surface.

Example Embodiment 6: The feed assembly of Example Embodiment 1, wherein
a rear end of the conveyor belt apparatus is at a first level, a front end of the conveyor belt apparatus is at a second level that is above the first level, and the conveyor belt apparatus includes an inclined conveyor section extending at least partially vertically between the first level and the second level.

Example Embodiment 7: The feed assembly of Example Embodiment 6, wherein the conveyor belt apparatus includes
a lower conveyor section extending horizontally from a lower end of the inclined conveyor section to the rear end of the conveyor belt apparatus at the first level, and
an upper conveyor section extending horizontally from an upper end of the inclined conveyor section to the front end of the conveyor belt apparatus at the second level.

Example Embodiment 8: The feed assembly of Example Embodiment 7, wherein the conveyor assembly includes a level sensor device configured to generate sensor data indicating a level of material at the lower end of the inclined conveyor section.

Example Embodiment 9: The feed assembly of Example Embodiment 6, wherein the conveyor assembly includes
an inclined catch ramp vertically underneath the inclined conveyor section, and
one or more lower tray shelves configured to support one or more catch trays vertically underneath a lower end of the inclined catch ramp.

Example Embodiment 10: The feed assembly of Example Embodiment 1, wherein the conveyor belt includes a set of cleats extending transversely across at least a portion of a width of the conveyor belt, the set of cleats partitioning the conveyor belt along a length direction of the conveyor belt into a plurality of conveyor sections.

Example Embodiment 11: The feed assembly of Example Embodiment 1, wherein the conveyor assembly includes one or more locating members configured to at least partially position the conveyor assembly in relation to an external structure based on engaging a surface of the external structure, such that a front end of the conveyor belt apparatus is at least partially located at a particular position in relation to the external structure.

Example Embodiment 12: The feed assembly of Example Embodiment 11, wherein the conveyor frame is configured to engage a set of external locating brackets of the external structure to align the front end of the conveyor belt apparatus along a lateral direction in relation to the external structure, the lateral direction perpendicular to a longitudinal axis of the conveyor assembly.

Example Embodiment 13: The feed assembly of Example Embodiment 1, wherein an assembly of the conveyor assembly or the supply assembly includes
one or more locating members configured to engage a frame of another assembly of the conveyor assembly or the supply assembly to align the discharge port of the supply apparatus to vertically overlap the conveyor belt at a rear conveyor section of the conveyor belt apparatus.

Example Embodiment 14: The feed assembly of Example Embodiment 1, wherein the conveyor assembly includes an electrical distribution assembly, the electrical distribution assembly including
a first electrical junction box including a first electrical connector port, and
a first electrical conduit coupling the first electrical connector port with the conveyor driver.

Example Embodiment 15: The feed assembly of Example Embodiment 14, wherein
the electrical distribution assembly further includes
   a second electrical junction box including a second electrical connector port, and
   a second electrical conduit coupling the first electrical connector port with the second electrical connector port, the first electrical conduit and the second electrical conduit coupled to separate, respective electrical connectors of the first electrical connector port, and
the supply assembly includes a supply electrical connector coupled with the supply driver, the supply electrical connector configured to connect with the second electrical connector port of the second electrical junction box.

Example Embodiment 16: The feed assembly of Example Embodiment 15, wherein
the first electrical junction box and the second electrical junction box are coupled to the conveyor frame at opposite ends of the conveyor frame along a longitudinal axis of the conveyor assembly.

Example Embodiment 17: The feed assembly of Example Embodiment 1, wherein at least one frame of the conveyor frame or the supply frame includes a floor lock configured to engage the support surface to hold the at least one frame in place in relation to the support surface.

Example Embodiment 18: The feed assembly of Example Embodiment 1, wherein the conveyor assembly includes a conveyor chute coupled to at least one of the conveyor belt apparatus or the conveyor frame at a front end of the conveyor assembly.

Example Embodiment 19: The feed assembly of Example Embodiment 1, wherein the conveyor assembly includes one or more tray shelves configured to support one or more catch trays vertically underneath at least a portion of the conveyor belt apparatus.

Example Embodiment 20: A manufacturing system for processing a material, the manufacturing system comprising:
the feed assembly of Example Embodiment 1, wherein the supply apparatus is configured to store the material in the static bin;
a manufacturing machine having an intake port and a dispenser configured to form one or more discrete units of the material based on processing one or more amounts of the material received through the intake port; and
a controller electrically coupled to at least the feed assembly, the controller electrically coupled to the conveyor driver and the supply driver, the controller configured to control a supply of the material from the feed assembly and through the intake port based on
   controlling the conveyor belt apparatus based on controlling the conveyor driver, and
   controlling the supply apparatus based on controlling the supply driver.

Example Embodiment 21: The manufacturing system of Example Embodiment 20, wherein
a rear end of the conveyor belt apparatus is at a first level, a front end of the conveyor belt apparatus is at a second level that is above the first level,
the conveyor belt apparatus includes
   an inclined conveyor section extending at least partially vertically between the first level and the second level,
   a lower conveyor section extending horizontally from a lower end of the inclined conveyor section to the rear end of the conveyor belt apparatus at the first level, and
   an upper conveyor section extending horizontally from an upper end of the inclined conveyor section to the front end of the conveyor belt apparatus at the second level,
the conveyor assembly includes a level sensor device configured to generate sensor data indicating a level of material at the lower end of the inclined conveyor section, and
the controller is configured to independently control at least one of the conveyor belt apparatus or the supply apparatus based on processing the sensor data to cause the level of material to be within a particular range of level values.

Example Embodiment 22: The manufacturing system of Example Embodiment 21, wherein the controller is configured to
process the sensor data generated by the level sensor device to determine a value of the level of the material,
execute a control loop to generate one or more output values indicating a target level of the material, based on a process variable that is the determined value of the level of the material and a setpoint that is a stored level setpoint value, and
control the at least one of the conveyor driver or the supply driver based on the one or more output values to control the level of the material.

Example Embodiment 23: The manufacturing system of Example Embodiment 22, wherein the controller is configured to control the at least one of the conveyor driver or the supply driver such that the level of the material is caused to be equal to or smaller than a threshold value.

Example Embodiment 24: The manufacturing system of Example Embodiment 20, wherein
the manufacturing machine includes a machine electrical connector electrically coupled to a power supply,
the conveyor assembly includes an electrical distribution assembly, the electrical distribution assembly including
   a first electrical junction box including a first electrical connector port, and
   a first electrical conduit coupling the first electrical connector port with the conveyor driver,
wherein the machine electrical connector is connected to the first electrical connector port to electrically couple the conveyor driver to the power supply through at least the first electrical conduit, the first electrical connector port, and the machine electrical connector.

Example Embodiment 25: The manufacturing system of Example Embodiment 24, wherein
the electrical distribution assembly further includes
   a second electrical junction box including a second electrical connector port, and
   a second electrical conduit coupling the first electrical connector port with the second electrical connector port, the first electrical conduit and the second electrical conduit coupled to separate, respective electrical connectors of the first electrical connector port,
the supply assembly includes a supply electrical connector coupled with the supply driver, the supply electrical connector connected with the second electrical connector port of the second electrical junction box, and
the machine electrical connector is connected to the first electrical connector port to
   electrically couple the conveyor driver to the power supply through at least the first electrical conduit, the first electrical connector port, and the machine electrical connector, and
   electrically couple the supply driver to the power supply through at least the supply electrical connector, the second electrical connector port, the second electrical conduit, the first electrical connector port, and the machine electrical connector.

Example Embodiment 26: A method for operating the feed assembly of Example Embodiment 1, the method comprising:
movably positioning the conveyor assembly over a support surface in relation to a manufacturing machine to align a front end of the conveyor belt apparatus with an intake port of the manufacturing machine; and
movably positioning the supply assembly over the support surface in relation to the conveyor assembly to vertically overlap the discharge port of the supply apparatus with the conveyor belt at a rear conveyor section of the conveyor belt apparatus.

Example Embodiment 27: The method of Example Embodiment 26, wherein
at least one assembly of the conveyor assembly or the supply assembly includes a locking device, and
the method further includes operating the locking device of the at least one assembly to at least partially inhibit movement of the at least one assembly in relation to the manufacturing machine.

Example Embodiment 28: The method of Example Embodiment 26, wherein
the manufacturing machine includes a machine electrical connector electrically coupled to a power supply,
the conveyor assembly includes an electrical distribution assembly, the electrical distribution assembly including
   a first electrical junction box including a first electrical connector port, and
   a first electrical conduit coupling the first electrical connector port with the conveyor driver, and
the method further includes connecting the machine electrical connector to the first electrical connector port to electrically couple the conveyor driver to the power supply through at least the first electrical conduit, the first electrical connector port, and the machine electrical connector.

Example Embodiment 29: The method of Example Embodiment 28, wherein
the electrical distribution assembly further includes
   a second electrical junction box including a second electrical connector port, and
   a second electrical conduit coupling the first electrical connector port with the second electrical connector port, the first electrical conduit and the second electrical conduit coupled to separate, respective electrical connectors of the first electrical connector port,
the supply assembly includes a supply electrical connector coupled with the supply driver, and
the method further includes connecting the supply electrical connector with the second electrical connector port of the second electrical junction box to electrically couple the supply assembly to the first electrical connector port of the first electrical junction box through the second electrical conduit.

Example Embodiment 30: The method of Example Embodiment 26, further comprising:
operating the supply driver and the conveyor driver to cause a material to be discharged from the supply apparatus onto the conveyor belt at the rear conveyor section of the conveyor belt apparatus and to be moved from the rear conveyor section to the front end of the conveyor belt apparatus and to be further discharged from the conveyor belt apparatus at the front end into the manufacturing machine through the intake port; and
operating the manufacturing machine to process the material to form one or more discrete units of the material.

Example Embodiment 31: The method of Example Embodiment 30, wherein
a rear end of the conveyor belt apparatus is at a first level, the front end is at a second level that is above the first level,
the conveyor belt apparatus includes
   an inclined conveyor section extending at least partially vertically between the first level and the second level,
   a lower conveyor section extending horizontally from a lower end of the inclined conveyor section to the rear end of the conveyor belt apparatus at the first level, and
   an upper conveyor section extending horizontally from an upper end of the inclined conveyor section to the front end of the conveyor belt apparatus at the second level,
the conveyor assembly includes a level sensor device configured to generate sensor data indicating a level of material at the lower end of the inclined conveyor section, and
the method further includes independently controlling at least one of the conveyor belt apparatus or the supply apparatus based on processing the sensor data to cause the level of material to be within a particular range of level values.

Example Embodiment 32: The method of Example Embodiment 31, wherein the independently controlling includes
processing the sensor data generated by the level sensor device to determine a value of the level of the material,
executing a control loop to generate an output value indicating a target level of the material, based on a process variable that is the determined value of the level of the material and a setpoint that is a stored level setpoint value, and
controlling the at least one of the conveyor driver or the supply driver based on the output value to control the level of the material.

Example Embodiment 33: A feed assembly, comprising:
a conveyor assembly, the conveyor assembly including
   a conveyor belt apparatus extending from a rear end of the conveyor belt apparatus to a front end of the conveyor belt apparatus, the conveyor belt apparatus including a rear conveyor section, the rear conveyor section adjacent to the rear end,
   a conveyor frame configured to at least partially structurally support the conveyor belt apparatus, and
   one or more conveyor rollers coupled to the conveyor frame, the one or more conveyor rollers configured to enable movement of the conveyor assembly over a support surface; and
a supply assembly, the supply assembly including,
   a supply apparatus configured to discharge a material through a discharge port,
   a supply frame configured to at least partially structurally support a load of the supply apparatus, and
   one or more supply rollers coupled to the supply frame, the one or more supply rollers configured to enable movement of the supply assembly over the support surface,
wherein the conveyor assembly is configured to be movably positioned to align the front end of the conveyor belt apparatus with an intake port of an external structure, and the supply assembly is configured to be movably positioned in relation to the conveyor assembly to vertically overlap the discharge port of the supply apparatus over the rear conveyor section of the conveyor belt apparatus, to enable the conveyor assembly to convey material discharged from the discharge port of the supply apparatus to the intake port of the external structure based on operation of the supply apparatus to discharge the material to the rear conveyor section of the conveyor belt apparatus and operation of the conveyor belt apparatus to convey the material from the rear conveyor section of the conveyor belt apparatus to the front end of the conveyor belt apparatus.

Example Embodiment 34: The feed assembly of Example Embodiment 33, wherein the supply apparatus includes a live bottom bin.

Example Embodiment 35: The feed assembly of Example Embodiment 33, wherein
the one or more conveyor rollers include a conveyor caster wheel pivotably coupled to the conveyor frame, and
the one or more supply rollers include a supply caster wheel pivotably coupled to the supply frame.

Example Embodiment 36: The feed assembly of Example Embodiment 35, wherein
at least one caster wheel of the conveyor caster wheel or the supply caster wheel is a locking caster wheel.

Example Embodiment 37: The feed assembly of Example Embodiment 33, wherein at least one assembly of the conveyor assembly or the supply assembly includes a locking device configured to at least partially inhibit movement of the at least one assembly in relation to the support surface.

Example Embodiment 38: The feed assembly of Example Embodiment 33, wherein
the rear end is at a first level, the front end is at a second level that is above the first level, and the conveyor belt apparatus includes an inclined conveyor section extending at least partially vertically between the first level and the second level.

Example Embodiment 39: The feed assembly of Example Embodiment 38, wherein the conveyor belt apparatus is configured to
move the material from the rear end of the conveyor belt apparatus to a lower end of the inclined conveyor section along a lower conveyor section at the first level,
move the material from the first level to the second level along the inclined conveyor section, and
move the material from an upper end of the inclined conveyor section to the front end of the conveyor belt apparatus along an upper conveyor section at the second level.

Example Embodiment 40: The feed assembly of Example Embodiment 39, wherein the conveyor assembly includes a level sensor device configured to generate sensor data indicating a level of material at the lower end of the inclined conveyor section.

Example Embodiment 41: The feed assembly of Example Embodiment 38, wherein the conveyor assembly includes
an inclined catch ramp configured to catch fallen material falling below at least a portion of the conveyor belt apparatus, and direct the fallen material to follow an inclined path downward towards one or more lower tray shelves.

Example Embodiment 42: The feed assembly of Example Embodiment 33, wherein the conveyor belt apparatus includes a conveyor belt having a set of cleats extending transversely across at least a portion of a width of the conveyor belt, the set of cleats partitioning the conveyor belt along a length direction of the conveyor belt into a plurality of conveyor sections.

Example Embodiment 43: The feed assembly of Example Embodiment 33, wherein the conveyor assembly includes one or more locating members configured to at least partially position the conveyor assembly in relation to the external structure based on engaging a surface of the external structure, such that the front end of the conveyor belt apparatus is at least partially located at a particular position in relation to the external structure.

Example Embodiment 44: The feed assembly of Example Embodiment 43, wherein the conveyor frame is configured to engage a set of external locating brackets of the external structure to align the front end of the conveyor belt apparatus along a lateral direction in relation to the external structure, the lateral direction perpendicular to a longitudinal axis of the conveyor assembly.

Example Embodiment 45: The feed assembly of Example Embodiment 33, wherein an assembly of the conveyor assembly or the supply assembly includes
one or more locating members configured to engage a frame of another assembly of the conveyor assembly or the supply assembly to align the discharge port of the supply apparatus to vertically overlap the rear conveyor section of the conveyor belt apparatus.

Example Embodiment 46: The feed assembly of Example Embodiment 33, wherein the conveyor assembly includes an electrical distribution assembly, the electrical distribution assembly including
a first electrical junction box including a first electrical connector port configured to be electrically coupled to a conveyor driver of the conveyor belt apparatus, the electrical distribution assembly configured to electrically couple the conveyor driver to an external power supply based on connecting the first electrical connector port with an external electrical connector that is electrically coupled with the external power supply.

Example Embodiment 47: The feed assembly of Example Embodiment 46, wherein
the electrical distribution assembly further includes
   a second electrical junction box including a second electrical connector port, the first electrical connector port including electrical connectors configured to be electrically coupled to separate, respective ones of the conveyor driver and the second electrical connector port, such that the conveyor driver and the second electrical connector port are electrically coupled to the first electrical connector port in parallel, and
the supply assembly includes a supply electrical connector coupled with a supply driver of the supply apparatus, the supply electrical connector configured to connect with the second electrical connector port of the second electrical junction box to electrically couple the supply assembly to the external power supply through the second electrical connector port and the first electrical connector port, based on the first electrical connector port connecting with the external electrical connector.

Example Embodiment 48: The feed assembly of Example Embodiment 47, wherein
the first electrical junction box and the second electrical junction box are coupled to the conveyor frame at opposite ends of the conveyor frame along a longitudinal axis of the conveyor assembly.

Example Embodiment 49: The feed assembly of Example Embodiment 33, wherein at least one frame of the conveyor frame or the supply frame includes a floor lock configured to engage the support surface to hold the at least one frame in place in relation to the support surface.

Example Embodiment 50: The feed assembly of Example Embodiment 33, wherein the conveyor assembly includes a conveyor chute configured to direct material conveyed from the front end of the conveyor belt apparatus along an inclined discharge path.

Example Embodiment 51: The feed assembly of Example Embodiment 33, wherein the conveyor assembly includes one or more tray shelves configured to support one or more catch trays vertically underneath at least a portion of the conveyor belt apparatus to configure the conveyor assembly to catch material falling below the conveyor belt apparatus.

Example Embodiment 52: A manufacturing system for processing a material, the manufacturing system comprising:
the feed assembly of Example Embodiment 33, wherein the supply apparatus is configured to store the material in a static bin;
a manufacturing machine having an intake port and a dispenser configured to form one or more discrete units of the material based on processing one or more amounts of the material received through the intake port; and
a controller electrically coupled to at least the feed assembly, the controller electrically coupled to a conveyor driver of the conveyor belt apparatus and a supply driver of the supply apparatus, the controller configured to control a supply of the material from the feed assembly and through the intake port based on
   controlling the conveyor belt apparatus based on controlling the conveyor driver, and
   controlling the supply apparatus based on controlling the supply driver.

Example Embodiment 53: The manufacturing system of Example Embodiment 52, wherein
the rear end is at a first level, the front end is at a second level that is above the first level,
the conveyor belt apparatus includes
   an inclined conveyor section extending at least partially vertically between the first level and the second level,
   a lower conveyor section extending horizontally from a lower end of the inclined conveyor section to the rear conveyor section of the conveyor belt apparatus at the first level, and
   an upper conveyor section extending horizontally from an upper end of the inclined conveyor section to the front end of the conveyor belt apparatus at the second level,
the conveyor assembly includes a level sensor device configured to generate sensor data indicating a level of material at the lower end of the inclined conveyor section, and
the controller is configured to independently control at least one of the conveyor belt apparatus or the supply apparatus based on processing the sensor data to cause the level of material to be within a particular range of level values.

Example Embodiment 54: The manufacturing system of Example Embodiment 53, wherein the controller is configured to
process the sensor data generated by the level sensor device to determine a value of the level of the material,
execute a control loop to generate an output value indicating a target level of the material, based on a process variable that is the determined value of the level of the material and a setpoint that is a stored level setpoint value, and
control the at least one of the conveyor driver or the supply driver based on the output value to control the level of the material.

Example Embodiment 55: The manufacturing system of Example Embodiment 54, wherein the controller is configured to control the at least one of the conveyor driver or the supply driver such that the level of the material is caused to be equal to or smaller than a threshold value.

Example Embodiment 56: The manufacturing system of Example Embodiment 52, wherein
the manufacturing machine includes a machine electrical connector electrically coupled to a power supply,
the conveyor assembly includes an electrical distribution assembly, the electrical distribution assembly including a first electrical junction box including a first electrical connector port configured to be electrically coupled to the conveyor driver,
wherein the machine electrical connector is connected to the first electrical connector port to electrically couple the conveyor driver to the power supply through at least the first electrical connector port and the machine electrical connector.

Example Embodiment 57: The manufacturing system of Example Embodiment 56, wherein
the electrical distribution assembly further includes a second electrical junction box including a second electrical connector port,
the first electrical connector port includes electrical connectors configured to be electrically coupled to separate, respective ones of the conveyor driver and the second electrical connector port, such that the conveyor driver and the second electrical connector port are electrically coupled in parallel with the first electrical connector port,
the supply assembly includes a supply electrical connector coupled with the supply driver, the supply electrical connector connected with the second electrical connector port of the second electrical junction box, and
the machine electrical connector is connected to the first electrical connector port to
   electrically couple the conveyor driver to the power supply through at least the first electrical connector port and the machine electrical connector, and
   electrically couple the supply driver to the power supply through at least the supply electrical connector, the second electrical connector port, the first electrical connector port, and the machine electrical connector.

Example Embodiment 58: A method for operating the feed assembly of Example Embodiment 33, the method comprising:
movably positioning the conveyor assembly over a support surface in relation to a manufacturing machine to align the front end of the conveyor belt apparatus with an intake port of the manufacturing machine; and
movably positioning the supply assembly over the support surface in relation to the conveyor assembly to vertically overlap the discharge port of the supply apparatus with the rear conveyor section of the conveyor belt apparatus.

Example Embodiment 59: The method of Example Embodiment 58, wherein
at least one assembly of the conveyor assembly or the supply assembly includes a locking device, and
the method further includes operating the locking device of the at least one assembly to at least partially inhibit movement of the at least one assembly in relation to the manufacturing machine.

Example Embodiment 60: The method of Example Embodiment 58, wherein
the manufacturing machine includes a machine electrical connector electrically coupled to a power supply,
the conveyor assembly includes an electrical distribution assembly, the electrical distribution assembly including a first electrical junction box including a first electrical connector port configured to be electrically coupled to a conveyor driver of the conveyor belt apparatus, and
the method further includes connecting the machine electrical connector to the first electrical connector port to electrically couple the conveyor driver to the power supply through at least the first electrical connector port and the machine electrical connector.

Example Embodiment 61: The method of Example Embodiment 60, wherein
the electrical distribution assembly further includes a second electrical junction box including a second electrical connector port,
the first electrical connector port includes electrical connectors configured to be electrically coupled to separate, respective ones of the conveyor driver and the second electrical connector port, such that the conveyor driver and the second electrical connector port are electrically coupled in parallel with the first electrical connector port,
the supply assembly includes a supply electrical connector coupled with a supply driver of the supply apparatus, the supply electrical connector connected with the second electrical connector port of the second electrical junction box, and
the method further includes connecting the supply electrical connector with the second electrical connector port of the second electrical junction box to electrically couple the supply assembly to the first electrical connector port of the first electrical junction box.

Example Embodiment 62: The method of Example Embodiment 58, further comprising:
operating the supply apparatus and the conveyor belt apparatus to cause material to be discharged from the supply apparatus onto the rear conveyor section of the conveyor belt apparatus and to be moved from the rear conveyor section to the front end of the conveyor belt apparatus and to be further discharged from the conveyor belt apparatus at the front end into the manufacturing machine through the intake port; and
operating the manufacturing machine to process the material to form one or more discrete units of the material.

Example Embodiment 63: The method of Example Embodiment 62, wherein
the rear end is at a first level, the front end is at a second level that is above the first level,
the conveyor belt apparatus includes
   an inclined conveyor section extending at least partially vertically between the first level and the second level,
   a lower conveyor section extending horizontally from a lower end of the inclined conveyor section to the rear end of the conveyor belt apparatus at the first level, and
   an upper conveyor section extending horizontally from an upper end of the inclined conveyor section to the front end of the conveyor belt apparatus at the second level,
the conveyor assembly includes a level sensor device configured to generate sensor data indicating a level of material at the lower end of the inclined conveyor section, and
the method further includes independently controlling at least one of the conveyor belt apparatus or the supply apparatus based on processing the sensor data to cause the level of material to be within a particular range of level values.

Example Embodiment 64: The method of Example Embodiment 63, wherein the independently controlling includes
processing the sensor data generated by the level sensor device to determine a value of the level of the material,
executing a control loop to generate an output value indicating a target level of the material, based on a process variable that is the determined value of the level of the material and a setpoint that is a stored level setpoint value, and
controlling the at least one of the conveyor belt apparatus or the supply apparatus based on the output value to control the level of the material.

What is claimed:

1. A feed assembly, comprising:
a conveyor assembly, the conveyor assembly including
a conveyor belt apparatus extending from a rear end of the conveyor belt apparatus to a front end of the conveyor belt apparatus, the conveyor belt apparatus including a rear conveyor section, the rear conveyor section adjacent to the rear end,
a conveyor frame configured to at least partially structurally support the conveyor belt apparatus, and
one or more conveyor rollers coupled to the conveyor frame, the one or more conveyor rollers configured to enable movement of the conveyor assembly over a support surface; and
a supply assembly, the supply assembly including,
a supply apparatus configured to discharge a material through a discharge port,
a supply frame configured to at least partially structurally support a load of the supply apparatus, and
one or more supply rollers coupled to the supply frame, the one or more supply rollers configured to enable movement of the supply assembly over the support surface,
wherein the conveyor assembly is configured to be movably positioned to align the front end of the conveyor belt apparatus with an intake port of an external structure, and the supply assembly is configured to be movably positioned in relation to the conveyor assembly to vertically overlap the discharge port of the supply apparatus over the rear conveyor section of the conveyor belt apparatus, to enable the conveyor assembly to convey material discharged from the discharge port of the supply apparatus to the intake port of the external structure based on operation of the supply apparatus to discharge the material to the rear conveyor section of the conveyor belt apparatus and operation of the conveyor belt apparatus to convey the material from the rear conveyor section of the conveyor belt apparatus to the front end of the conveyor belt apparatus.

2. The feed assembly of claim 1, wherein
the rear end is at a first level, the front end is at a second level that is above the first level, and the conveyor belt apparatus includes an inclined conveyor section extending at least partially vertically between the first level and the second level.

3. The feed assembly of claim 2, wherein the conveyor belt apparatus is configured to
move the material from the rear end of the conveyor belt apparatus to a lower end of the inclined conveyor section along a lower conveyor section at the first level,
move the material from the first level to the second level along the inclined conveyor section, and
move the material from an upper end of the inclined conveyor section to the front end of the conveyor belt apparatus along an upper conveyor section at the second level.

4. The feed assembly of claim 1, wherein the conveyor belt apparatus includes a conveyor belt having a set of cleats extending transversely across at least a portion of a width of the conveyor belt, the set of cleats partitioning the conveyor belt along a length direction of the conveyor belt into a plurality of conveyor sections.

5. The feed assembly of claim 1, wherein the conveyor assembly includes one or more locating members configured to at least partially position the conveyor assembly in relation to the external structure based on engaging a surface of the external structure, such that the front end of the conveyor belt apparatus is at least partially located at a particular position in relation to the external structure.

6. The feed assembly of claim 1, wherein an assembly of the conveyor assembly or the supply assembly includes
one or more locating members configured to engage a frame of another assembly of the conveyor assembly or the supply assembly to align the discharge port of the supply apparatus to vertically overlap the rear conveyor section of the conveyor belt apparatus.

7. The feed assembly of claim 1, wherein the conveyor assembly includes an electrical distribution assembly, the electrical distribution assembly including
a first electrical junction box including a first electrical connector port configured to be electrically coupled to a conveyor driver of the conveyor belt apparatus, the electrical distribution assembly configured to electrically couple the conveyor driver to an external power supply based on connecting the first electrical connector port with an external electrical connector that is electrically coupled with the external power supply.

8. The feed assembly of claim 7, wherein
the electrical distribution assembly further includes
a second electrical junction box including a second electrical connector port, the first electrical connector port including electrical connectors configured to be electrically coupled to separate, respective ones of the conveyor driver and the second electrical connector port, such that the conveyor driver and the second electrical connector port are electrically coupled to the first electrical connector port in parallel, and
the supply assembly includes a supply electrical connector coupled with a supply driver of the supply apparatus, the supply electrical connector configured to connect with the second electrical connector port of the second electrical junction box to electrically couple the supply assembly to the external power supply through the second electrical connector port and the first electrical connector port, based on the first electrical connector port connecting with the external electrical connector.

9. A manufacturing system for processing a material, the manufacturing system comprising:
the feed assembly of claim 1, wherein the supply apparatus is configured to store the material in a static bin;
a manufacturing machine having an intake port and a dispenser configured to form one or more discrete units of the material based on processing one or more amounts of the material received through the intake port; and
a controller electrically coupled to at least the feed assembly, the controller electrically coupled to a conveyor driver of the conveyor belt apparatus and a supply driver of the supply apparatus, the controller configured to control a supply of the material from the feed assembly and through the intake port based on
controlling the conveyor belt apparatus based on controlling the conveyor driver, and
controlling the supply apparatus based on controlling the supply driver.

10. The manufacturing system of claim 9, wherein
the rear end is at a first level, the front end is at a second level that is above the first level,
the conveyor belt apparatus includes
an inclined conveyor section extending at least partially vertically between the first level and the second level,
a lower conveyor section extending horizontally from a lower end of the inclined conveyor section to the rear conveyor section of the conveyor belt apparatus at the first level, and
an upper conveyor section extending horizontally from an upper end of the inclined conveyor section to the front end of the conveyor belt apparatus at the second level,
the conveyor assembly includes a level sensor device configured to generate sensor data indicating a level of material at the lower end of the inclined conveyor section, and
the controller is configured to independently control at least one of the conveyor belt apparatus or the supply apparatus based on processing the sensor data to cause the level of material to be within a particular range of level values.

11. The manufacturing system of claim 10, wherein the controller is configured to
process the sensor data generated by the level sensor device to determine a value of the level of the material,
execute a control loop to generate an output value indicating a target level of the material, based on a process variable that is the determined value of the level of the material and a setpoint that is a stored level setpoint value, and
control the at least one of the conveyor driver or the supply driver based on the output value to control the level of the material.

12. The manufacturing system of claim 11, wherein the controller is configured to control the at least one of the conveyor driver or the supply driver such that the level of the material is caused to be equal to or smaller than a threshold value.

13. The manufacturing system of claim 9, wherein
the manufacturing machine includes a machine electrical connector electrically coupled to a power supply,
the conveyor assembly includes an electrical distribution assembly, the electrical distribution assembly including a first electrical junction box including a first electrical connector port configured to be electrically coupled to the conveyor driver,
wherein the machine electrical connector is connected to the first electrical connector port to electrically couple the conveyor driver to the power supply through at least the first electrical connector port and the machine electrical connector.

14. The manufacturing system of claim 13, wherein
the electrical distribution assembly further includes a second electrical junction box including a second electrical connector port,
the first electrical connector port includes electrical connectors configured to be electrically coupled to separate, respective ones of the conveyor driver and the second electrical connector port, such that the conveyor driver and the second electrical connector port are electrically coupled in parallel with the first electrical connector port,
the supply assembly includes a supply electrical connector coupled with the supply driver, the supply electrical connector connected with the second electrical connector port of the second electrical junction box, and
the machine electrical connector is connected to the first electrical connector port to
electrically couple the conveyor driver to the power supply through at least the first electrical connector port and the machine electrical connector, and
electrically couple the supply driver to the power supply through at least the supply electrical connector, the second electrical connector port, the first electrical connector port, and the machine electrical connector.

15. A method for operating the feed assembly of claim 1, the method comprising:
movably positioning the conveyor assembly over a support surface in relation to a manufacturing machine to align the front end of the conveyor belt apparatus with an intake port of the manufacturing machine; and
movably positioning the supply assembly over the support surface in relation to the conveyor assembly to vertically overlap the discharge port of the supply apparatus with the rear conveyor section of the conveyor belt apparatus.

16. The method of claim 15, wherein
the manufacturing machine includes a machine electrical connector electrically coupled to a power supply,
the conveyor assembly includes an electrical distribution assembly, the electrical distribution assembly including a first electrical junction box including a first electrical connector port configured to be electrically coupled to a conveyor driver of the conveyor belt apparatus, and
the method further includes connecting the machine electrical connector to the first electrical connector port to electrically couple the conveyor driver to the power supply through at least the first electrical connector port and the machine electrical connector.

17. The method of claim 16, wherein
the electrical distribution assembly further includes a second electrical junction box including a second electrical connector port,
the first electrical connector port includes electrical connectors configured to be electrically coupled to separate, respective ones of the conveyor driver and the second electrical connector port, such that the conveyor driver and the second electrical connector port are electrically coupled in parallel with the first electrical connector port,
the supply assembly includes a supply electrical connector coupled with a supply driver of the supply apparatus, the supply electrical connector connected with the second electrical connector port of the second electrical junction box, and
the method further includes connecting the supply electrical connector with the second electrical connector port of the second electrical junction box to electrically couple the supply assembly to the first electrical connector port of the first electrical junction box.

18. The method of claim 15, further comprising:
operating the supply apparatus and the conveyor belt apparatus to cause material to be discharged from the supply apparatus onto the rear conveyor section of the conveyor belt apparatus and to be moved from the rear conveyor section to the front end of the conveyor belt apparatus and to be further discharged from the conveyor belt apparatus at the front end into the manufacturing machine through the intake port; and
operating the manufacturing machine to process the material to form one or more discrete units of the material.

19. The method of claim 18, wherein
the rear end is at a first level, the front end is at a second level that is above the first level,
the conveyor belt apparatus includes
an inclined conveyor section extending at least partially vertically between the first level and the second level,
a lower conveyor section extending horizontally from a lower end of the inclined conveyor section to the rear end of the conveyor belt apparatus at the first level, and
an upper conveyor section extending horizontally from an upper end of the inclined conveyor section to the front end of the conveyor belt apparatus at the second level,
the conveyor assembly includes a level sensor device configured to generate sensor data indicating a level of material at the lower end of the inclined conveyor section, and
the method further includes independently controlling at least one of the conveyor belt apparatus or the supply apparatus based on processing the sensor data to cause the level of material to be within a particular range of level values.

20. The method of claim 19, wherein the independently controlling includes
processing the sensor data generated by the level sensor device to determine a value of the level of the material,
executing a control loop to generate an output value indicating a target level of the material, based on a process variable that is the determined value of the level of the material and a setpoint that is a stored level setpoint value, and
controlling the at least one of the conveyor belt apparatus or the supply apparatus based on the output value to control the level of the material.
